(19) United States
(12) Patent Application Publication
(10) Pub. No.: US 2025/0059439 A1
(43) Pub. Date: Feb. 20, 2025

(54) SUPRAMOLECULAR ASSEMBLY OF HALIDE PEROVSKITE

(71) Applicant: The Regents of the University of California, Oakland, CA (US)

(72) Inventors: Peidong Yang, Kensington, CA (US); Cheng Zhu, Berkeley, CA (US); Heqing Zhu, Berkeley, CA (US)

(21) Appl. No.: 18/751,011

(22) Filed: Jun. 21, 2024

Related U.S. Application Data
(60) Provisional application No. 63/509,821, filed on Jun. 23, 2023.

(51) Int. Cl. C09K 11/08

(52) U.S. Cl. CPC C09K 11/0833

(57) ABSTRACT

Halide perovskite compounds comprising at least one metal cation, at least one halide anion, and at least one alkali metal-bound crown ether, such as (crown ether@A)₂M(IV)X₆, (crown ether@A)M(II)X₄, or (crown ether@A)M(III)X₅ (A=alkali metal cation, M=metal cation, X=halide anion), such as (18C6@K)₂HfBr₆, (18C6@K)₂ZrCl₄Br₂, (18C6@Ba)MnBr₄, and (18C6@Ba)SbCl₅ are provided. Methods of generating such halide perovskite compounds are also provided. The halide perovskite compounds provided herein can have improved photoluminescence quantum yield (PLQY), improved tunability, improved purity, and/or improved stability relative to available halide perovskite compounds such as alkali metal cation vacancy-ordered perovskites.

### CROSS-REFERENCE TO RELATED APPLICATIONS

This application claims priority to U.S. Provisional Application No. 63/509,821, filed on Jun. 23, 2023, the content of which is incorporated herein by reference in its entirety.

### STATEMENT OF GOVERNMENT SUPPORT

This invention was made with government support under Contract No. DE-AC02-05CH11231 awarded by the U.S. Department of Energy. The government has certain rights in this invention.

### TECHNICAL FIELD

This disclosure relates generally to halide perovskites and assembly thereof.

### BACKGROUND

The halide perovskite has been studied as a semiconductor and an emitter owing to its superior optoelectronic properties: a high optical absorption coefficient, tunable band gap, long free carrier diffusion length, high defect tolerance, and efficient photo-/electro-luminescence. The [MX₆]ⁿ⁻ (M is a metal cation such as Pb²⁺, Sb³⁺, Te⁴⁺, Sn⁴⁺, Pt⁴⁺; X is a halide anion Cl⁻, Br⁻, I⁻) metal halide ionic octahedral units can be the fundamental building blocks and functional units in metal halide perovskites. Metal halide perovskites are the extended assembly of the metal halide ionic octahedral units balanced by counter cations. Halide perovskites with superior emission properties, increased stability, and easier synthesis capability would be of commercial and academic value.

### BRIEF SUMMARY

Provided herein is a systematic supramolecular strategy for the assembly of metal halide perovskites such as [M(IV)X₆]²⁻, [M(II)X₄]²⁻, or [M(III)X₅]²⁻ [M(IV)=tetravalent metal cation, M(II)=divalent metal cation, M(III)=trivalent metal cation, X=halide anion]octahedra or tetrahedra into a solid extended network, and metal halide perovskites produced thereby. Interaction of alkali metal-bound crown ethers (crown ether@A) with halide perovskite octahedra [M(IV)X₆]²⁻, with crown ether=one or more of 18-Crown-6 and 21-Crown-7; A=one or more of Cs⁺, Rb⁺, and K⁺; M=one or more of Te⁴⁺, Sn⁴⁺, Pt⁴⁺, Se⁴⁺, Ir⁴⁺, Zr⁴⁺, Hf⁴⁺, and Ce⁴⁺; and X=one or more of Cl⁻, Br⁻, and I⁻, can result in a unique charge-neutral dumbbell structure, and a rhombohedral crystal structure. Interaction of crown ether@A with halide perovskite tetrahedra [M(II)X₄]², with crown ether=18-Crown-6; A=Ba²⁺; M=one or more of Mn²⁺ and Ni²⁺; and X=one or more of Cl⁻ and Br⁻, I can result in a unit structure and a 1D linear chain structure of a plurality of the unit structure, and a hexagonal crystal structure. Interaction of crown ether@A with halide perovskite octahedra [M(III)X₅]²⁻, with crown ether=18-Crown-6; A=Ba²⁺; M=Sb³⁺; and X=one or more of Cl⁻ and Br, can result in a unit structure and a 1D linear chain structure of a plurality of the unit structure, and a rhombohedral crystal structure. Single crystals with diverse packing geometries and symmetries form as the solid assembly of this new supramolecular building block via a facile anti-solvent crystallization method. The supramolecular assembly route provided herein also introduces a new general strategy for designing halide perovskite structures with potentially new optoelectronic properties.

In one aspect of the present disclosure, a halide perovskite compound according to the formula: (crown ether@A)₂M(IV)X₆ is provided. The M(IV) is at least one tetravalent metal cation, the X is at least one halide anion, and the crown ether@A is at least one alkali metal-bound crown ether formed between an alkali metal cation A and oxygen atoms of a crown ether.

In some embodiments, in the halide perovskite compound provided herein, the M(IV) is one or more of; Te⁴⁺, Sn⁴⁺, Pt²⁺, Se³⁺, Ir⁴⁺, Zr⁴⁺, Hf⁴⁺, and Ce⁴⁺; the X is one or more of Cl⁻, Br⁻, and I⁻; the crown ether is one or more of 18-Crown-6 (18C6) and 21-Crown-7 (21C7); and/or the A is one or more of Cs⁺, Rb⁺, and K⁺.

In some embodiments, the halide perovskite compound is (18C6@K)₂HfBr₆.

In some embodiments, the halide perovskite compound is (18C6@K)₂ZrCl₄Br₂.

In some embodiments, the halide perovskite compound is (18C6@Cs)₂M(IV)Cl₆, wherein the M(IV) is Te⁴⁺, Sn⁴⁺, Pt²⁺, Se³⁺, Ir⁴⁺, Zr⁴⁺, Hf⁴⁺, and/or Ce⁴⁺.

In some embodiments, the halide perovskite compound is (18C6@Cs)₂TeX₆, wherein the X is Cl⁻, Br⁻, and/or I⁻.

In some embodiments, the halide perovskite compound is (18C6@A)₂TeCl₆, wherein the A is Cs⁺, Rb⁺, and/or K⁺.

In some embodiments, the halide perovskite compound is (Crown ether@Cs)₂TeCl₆, wherein crown ether is 18C6 and/or 21C7.

In some embodiments, the halide perovskite compound is (18C6@K)₂M(IV)Cl₆, wherein the M(IV) is Pt²⁺, Ir⁴⁺, Se³⁺, Sn⁴⁺, and/or Te⁴⁺.

In some embodiments, the halide perovskite compound is (18C6@Cs)₂TeBr₆ or (18C6@Cs)₂TeCl₆.

In some embodiments, the halide perovskite compound comprises (i) a dumbbell-shaped structural unit formed by two [crown ether@A]⁺s and one [M(IV)X₆]²⁻, and/or (ii) a rhombohedral crystal structure of a plurality of the dumbbell-shaped structural units. The [crown ether@A]⁺ is a free charged form of the crown ether@A, and the [M(IV)X₆]²⁻ is a free charged form of the M(IV)X₆.

In some embodiments, the halide perovskite compound comprises greater photoluminescence quantum yield (PLQY) as compared to a control compound A₂M(IV)X₆ without the crown ether and comprising the same A, M(IV), and X as the halide perovskite compound. In some embodiments, the PLQY of the halide perovskite compound is greater than 90% under excitation at 275 nm, measured at 445 nm, or greater than 80% under excitation at 295 nm, measured at 530 nm.

In some embodiments, the halide perovskite compound provided herein comprises increased air stability as compared to a control compound A₂M(IV)X₆ without the crown ether and comprising the same A, M, and X as the halide perovskite compound. In some embodiments, the air stability of the halide perovskite compound increased by about 1 hour to about 3 days as compared to the control compound.

In one aspect of the present disclosure, a halide perovskite compound according to the formula: (crown ether@A)M(II)X₄ or (crown ether@A)M(III)X₅ is provided. The M(II) is at least one divalent metal cation, the M(III) is at least one trivalent metal cation, the X is at least one halide anion, and the crown ether@A is at least one alkali metal-bound crown ether formed between an alkali metal cation A and oxygen atoms of a crown ether.

In some embodiments, in the halide perovskite compound provided herein, the M(II) is one or more of Mn²⁺ and Ni²⁺; the M(III) is Sb³⁺; the X is one or more of Cl⁻ and Br⁻; the crown ether is 18-Crown-6 (18C6); and/or the A is Ba²⁺.

In some embodiments, the halide perovskite compound is (18C6@Ba)MnBr₄ or (18C6@Ba)SbCl₅.

In some embodiments, the halide perovskite compound comprises at least one of (i) a structural unit formed by one [crown ether@A]²⁺ and one [M(II)X₄]²⁻ or [M(III)X₅]²⁻, (ii) a linear chain structure comprising a plurality of the structural unit, and (iii) a hexagonal or rhombohedral crystal structure comprising the plurality of the structural unit. The [crown ether@A]²⁺ is a free charged form of the crown ether@A, the [M(II)X₄]²⁻ is a free charged form of the M(II)X₄, and the [M(III)X₅]²⁻ is a free charged form of the M(III)X₅.

In some embodiments, the halide perovskite compound comprises greater PLQY as compared to a control compound AM(II)X₄ or AM(III)X₅ without the crown ether and comprising the same A, M(II) or M(III), and X as the halide perovskite compound. In some embodiments, the PLQY of the halide perovskite compound is greater than 80% under excitation at 449 nm, measured at 513 nm.

In some embodiments, the halide perovskite compound provided herein comprises increased air stability as compared to a control compound AM(II)X₄ or AM(III)X₅ without the crown ether and comprising the same A, M, and X as the halide perovskite compound.

In one aspect, the present disclosure provides a color luminescent composition or a semiconductor composition comprising the halide perovskite provided herein.

In one aspect of the present disclosure, a method of generating a halide perovskite compound is provided. The method includes dissolving (i) a metal halide and (ii) an alkali metal halide and a crown ether, or an alkali metal-bound crown ether, in an organic solvent to provide a precursor solution, wherein the metal halide makes contact with at least one of the alkali metal halide, the crown ether, and the alkali metal-bound crown ether in the precursor solution; and contacting the organic solvent with an anti-solvent, wherein the halide perovskite compound crystalizes from the precursor solution.

In some embodiments, the organic solvent comprises N, N-Dimethylformamide (DMF) or acetonitrile (ACN). In some embodiments, the anti-solvent comprises diethyl ether (DEE).

In some embodiments, (i) the metal halide and (ii) the alkali metal and the crown ether, or the alkali metal-bound crown ether, are dissolved in the organic solvent at about 60-100° C., such as at about 80° C.

In some the halide perovskite compound generated according to the method provided herein is free of impurities.

Details of one or more embodiments of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 depicts supramolecular assembly strategy from the [M(IV)X₆]²⁻ octahedron to (18C6@A)₂M(IV)X₆. The dissolved alkali metal cation (A⁺) and [M(IV)X₆]²⁻ octahedron self-assemble into a dumbbell-shaped structural unit with crown ethers like 18-Crown-6 (18C6). The solution-dispersed (18C6@A)₂M(IV)X₆ dumbbell structural units can further assemble into a rhombohedral-packing single crystal. The dark-field optical microscopy image shows single crystals of (18C6@Cs)₂Te(IV)Cl₆.

FIGS. 2A-2D depict evidence of the formation of the (18C6@A)₂M(IV)X₆ dumbbell structural unit in solution. The composition of (18C6@Cs)₂TeBr₆ is applied as an illustrating example for the dumbbell structural unit, and ACN (ACN-d₃ for NMR) is used as the solvent. FIG. 2A depicts ¹H NMR spectra for (18C6@Cs)₂TeBr₆ solution and the control groups are (18C6@Cs)Br and 18C6 dissolved in solution. FIG. 2B depicts ⁷⁹Br NMR spectra for (18C6@Cs)₂TeBr₆ solution and the control groups are Cs₂TeBr₆ and CsBr dissolved in solution. FIG. 2C depicts ¹³³Cs NMR spectra for (18C6@Cs)₂TeBr₆ solution and the control groups are (18C6@Cs)Br, Cs₂TeBr₆, and CsBr dissolved in solution. FIG. 2D depicts UV-vis spectral comparison of (18C6@Cs)₂TeBr₆ solution and Cs₂TeBr₆ dissolved in ACN solution.

FIGS. 3A-3D depict synthetic tunability of the crown ether supramolecular approach. The four arrows represent the four dimensionalities in tuning the dumbbell structural unit from the initial (18C6@Cs)₂TeCl₆ structural unit. FIG. 3A depicts that seven tetravalent octahedral cations can be applied, including transition metal cations such as Zr⁴⁺, Ir⁴⁺, and Pt⁴⁺, basic metal cations such as Sn⁴⁺, metalloid cations such as Te⁴⁺, nonmetal cations such as Se⁴⁺, and lanthanide cations such as Ce⁴⁺. FIG. 3B depicts tuning the halide anion from Cl⁻ to Br⁻ to I⁻ and the optical images are the powders of (18C6@Cs)₂TeX₆ (X=Cl⁻, Br⁻, I⁻) under ambient light. FIG. 3C depicts modifying the alkali metal cation coupled with 18C6 from Cs⁺ to Rb⁺ to K⁺ and the optical images are the powders of (18C6@A)₂TeCl₆ dispersed in an anti-solvent under 365 nm UV lamp excitation. FIG. 3D depicts varying the size of the crown ether from 18C6 to 21C7.

FIGS. 4A-4F depict systematic structural analysis of the family of (18C6@A)₂M(IV)X₆ crystals. FIG. 4A depicts comparison of PXRD patterns by tuning the octahedron center element (M) in (18C6@A)₂M(IV)Cl₆ (for M=Ce and Zr and A=Cs; for M=Pt, Ir, Se, Sn, and Te and A=K). FIG. 4C depicts comparison of PXRD patterns by changing the halide atom (X) in (18C6@Cs)₂TeX₆. FIG. 4E depicts comparison of PXRD patterns by varying the alkali metal atom (A) in (18C6@A)₂TeCl₆. FIGS. 4B, 4D, and 4F depict analysis of the geometric parameters of the dumbbell structural units: FIG. 4B depicts M—Cl bond length comparison of the structures with different octahedron center elements. FIG. 4D depicts that the M—X bond length increases with larger X. FIG. 4F depicts that the height of the cone increases with larger A, while the diameter of the cone is insensitive to the change of A.

FIGS. 5A-5D depict optoelectronic tunability of the crown ether supramolecular approach. FIG. 5A depicts normalized UV-vis absorption spectra of (18C6@A)₂M(IV)Cl₆ (M=Sn⁴⁺, Te⁴⁺, Ce⁴⁺, and Ir⁴⁺) crystals. FIG. 5B depicts normalized UV-vis absorption spectra of (18C6@Cs)₂TeX₆ (X=Cl⁻, Br⁻, and I⁻) crystals. FIG. 5C depicts normalized UV-vis absorption spectra of [TeBr₆]²⁻ octahedra under four different packing geometries. FIG. 5D depicts normalized PL spectra of (18C6@A)₂TeCl₆ (A=Cs⁺, Rb⁺, and K⁺) crystals.

FIG. 6 depicts photographs of the (18C6@Cs)₂TeBr₆ single crystals grown from the anti-solvent crystallization method.

FIGS. 7A-7F depict crystal structure of one typical example: (18C6@Cs)₂TeCl₆. FIG. 7A is the top view and FIG. 7B is the side view of the atomic structure of the dumbbell (18C6@Cs)₂TeCl₆ structural unit. FIG. 7C is the oblique view and FIG. 7D is the top view of (18C6@Cs)₂TeCl₆ single crystal that is in rhombohedral R-3 space group. FIG. 7E is a dark field optical image and FIG. 7F is a scanning electron microscope image of (18C6@Cs)₂TeCl₆ single crystal.

FIG. 8 depicts a structure consists of two cones and one octahedron that simplifies the dumbbell structural unit.

FIG. 9 depicts powder XRD of (18C6@Rb)₂TeI₆ and (18C6@Cs)₂TeI₆.

FIG. 10 depicts powder XRD of (18C6@Cs)₂SnBr₆, (18C6@Rb)₂SnBr₆, and (18C6@K)₂SnBr₆.

FIG. 11 depicts thermogravimetric analysis (TGA) of (18C6@Cs)₂TeCl₆, (18C6@Cs)₂TeBr₆, and (18C6@Cs)₂SnCl₆ under N₂ atmosphere.

FIG. 12 depicts thermogravimetric analysis (TGA) of (18C6@Cs)₂TeCl₆, (18C6@Cs)₂TeBr₆, and (18C6@Cs)₂SnCl₆ under N₂ atmosphere.

FIG. 13 depicts Raman spectrum of Cs₂TeCl₆.

FIG. 14 depicts normalized low-frequency Raman spectra of (18C6@A)₂TeCl₆ (A=Cs⁺, Rb⁺, K⁺) crystals.

FIG. 15 depicts Raman spectra of (18C6@A)₂TeBr₆ (A=K⁺, Rb⁺, Cs⁺).

FIG. 16 depicts Raman spectra of (18C6@A)₂SnCl₆ (A=K⁺, Rb⁺, Cs⁺).

FIG. 17 depicts Raman spectra of (18C6@A)₂SnBr₆ (A=K⁺, Rb⁺, Cs⁺).

FIGS. 18A-18C depict single crystal XRD characterization of 21C7 assembled crystals. FIG. 18A depicts the structure of the (21C7@Cs)₂TeBr₆ fundamental building block. FIG. 18B depicts crystal structure of (21C6@Cs)₂TeBr₆ viewed from the a axis. FIG. 18C depicts oblique view of the (21C7@Cs)₂TeBr₆ single crystal structure. 21C7 molecules have been omitted for better demonstration of the packing geometry of the octahedra.

FIG. 19 depicts powder X-ray diffraction pattern of (21C7@Cs)₂TeX₆ (X=Br⁻, I⁻).

FIG. 20 depicts dark field optical microscopy image of (21C7@Cs)₂TeBr₆ single crystal.

FIGS. 21A-21B depicts scanning electron microscopy (SEM) image of the (21C7@Cs)₂TeBr₆ single crystal. FIG. 21A provides a top view and FIG. 21B provides a side view.

FIG. 22 depicts an optical image of (18C6@Cs)₂TeBr₆ and Cs₂TeBr₆ powders. (18C6@Cs)₂TeBr₆ has an orange color, while Cs₂TeBr₆ has a red color.

FIG. 23 depicts normalized UV-vis absorption spectra and photoluminescence spectra of (18C6@A)₂TeCl₆ (A=K⁺, Rb⁺, Cs⁺) crystals.

FIGS. 24A-24G depict two assemblies of the [HfBr₆]²⁻ ionic octahedron. FIG. 24A depicts the rhombohedral unit cell and FIG. 24B depicts the dumbbell-shaped structural unit of (18C6@K)₂HfBr₆.

FIG. 24C depicts the Fm-3m unit cell [from the Open Quantum Materials Database (OQMD) and FIG. 24D depicts the isolated [HfBr₆]²⁻ ionic octahedron building block of K₂HfBr₆. FIG. 24E depicts the PXRD patterns for synthesized (18C6@K)₂HfBr₆ and K₂HfBr₆ powders and the calculated diffraction patterns. K₂HfBr₆ showed quite poor PXRD quality because of its poor stability during measurement. a.u., arbitrary unit. FIG. 24F depicts the structure and corresponding total pDOS of (18C6@K)₂HfBr₆. FIG. 24G depicts the structure and corresponding total pDOS of K₂HfBr₆. When [HfBr₆]²⁻ octahedra were assembled in the supramolecular approach, the dispersion of the bands decreased, and 18C6 contributed to the valence band (VB).

FIGS. 25A-25E depict blue emission with near-unity PLQY (96.2%) from (18C6@K)₂HfBr₆ powders and green emission with a PLQY of 82.7% from (18C6@K)₂ZrCl₄Br₂ powders. FIG. 25A depicts (18C6@K)₂HfBr₆ powders under white lamp and 254-nm UV excitation. FIG. 25B depicts PL and PLE spectra of (18C6@K)₂HfBr₆ powders. FIG. 25C depicts (18C6@K)₂ZrCl₄Br₂ powders under white lamp and 302-nm UV excitation. FIG. 25D depicts PL and PLE spectra of (18C6@K)₂ZrCl4Br2 powders. FIG. 25E depicts the CIE 1931 chromaticity diagram for the emission of (18C6@K)₂HfBr₆ powders and (18C6@K)₂ZrCl₄Br₂ powders. “B” stands for the blue emission of (18C6@K)₂HfBr₆, and “G” stands for the green emission of (18C6@K)₂ZrCl₄Br₂. The coordinates for the emission colors of (18C6@K)₂HfBr₆ and (18C6@K)₂ZrCl₄Br₂ were (0.17438, 0.16922) and (0.30597, 0.41533), respectively.

FIGS. 26A-26D depict photophysical analysis of (18C6@K)₂HfBr₆ and (18C6@K)₂ZrCl₄Br₂. FIG. 26A depicts PL spectra of (18C6@K)₂HfBr₆ powders at 4, 50, 100, 150, 210, and 293 K. FIG. 26B depicts FWHM of the PL spectra of (18C6@K)₂HfBr₆ powders at different temperatures, with the orange and teal solid lines denoting the least-square fit to Eq. 1 at low (4 to 190 K) and high (190 to 293 K) temperature ranges, respectively. FIG. 26C depicts PLE spectroscopy of (18C6@K)₂HfBr₆ powders. FIG. 26D depicts normalized PL decay curves of (18C6@K)₂ZrCl₄Br₂ and (18C6@K)₂HfBr₆ single crystals.

FIGS. 27A-27G depict solution processability and display application of highly emissive blue and green semiconductor inks. FIG. 27A depicts schematic illustrating the thin-film fabrication method and the display application. The inks were formed by mixing (18C6@K)₂HfBr₆ or (18C6@K)₂ZrCl₄Br₂ powders and PS in DCM. Thin films were obtained by drop casting, and they demonstrated programmable display capability. DMD, digital micromirror device. FIG. 27B depicts (18C6@K)₂HfBr₆/PS-DCM ink under white light and 254-nm UV lamp excitation. FIG. 27C depicts (18C6@K)₂ZrCl₄Br₂/PS-DCM ink under white light and 302-nm lamp excitation. FIG. 27D depicts (18C6@K)₂HfBr₆/PS composite thin film under white light and 254-nm UV excitation. FIG. 27E depicts (18C6@K)₂ZrCl₄Br₂/PS composite thin film under white light and 302-nm UV excitation. The scale bars for FIGS. 27B and 27E are 1 cm. The PLQYs of all samples are shown in the photos. FIG. 27F depicts image of the “Cal” logo blue emission on the (18C6@K)₂HfBr₆/PS composite thin film. FIG. 27G depicts snapshots of a video showing the alphabet, A to Z, with 0.1 s per letter on the (18C6@K)₂HfBr₆/PS composite thin film. The scale bars for FIGS. 27F and 27G are 3 mm and 4 mm, respectively.

FIGS. 28A-28G depict implementation of the blue-green dual-color 3D printing. FIG. 28A depicts schematic illustrating the multimaterial 3D printing process. FIG. 28B depicts two 3D-printed light-emitting Eiffel Towers under white light excitation. FIG. 28C depicts two 3D-printed light-emitting Eiffel Towers under 254-nm UV excitation. FIG. 28D depicts a dual-color-emitting Eiffel Tower under 254-nm UV excitation. FIGS. 28E-28H depict conformal and twisted octet trusses with varying hierarchical structures and geometric shapes, including cuboctahedron, tetrakaidecahedron, and Menger sponge structures, with the blue and green emitters or their combinations, respectively. These printed architectures were photoexcited at 254 nm. The scale bars for FIGS. 28B-28G are 5 mm. The scale bar for the zoom-in image of FIG. 28E is 0.6 mm. The scale bar for FIG. 28H is 4 mm.

FIG. 29 depicts Raman spectroscopy of the K₂HfBr₆ powders measured in inert atmosphere. The asymmetric bending mode (T_{2g}) and symmetric stretching mode (A_{1g}) of the Oh-symmetric vibrating [HfBr₆]²⁻ are identified. The baseline appears to be noisy due to the low Raman intensity of the powders sample and the signal loss coming from the cover glass on the inert-atmosphere sample holder.

FIGS. 30A-30B depict crystal structure of (18C6@K)₂ZrBr₆ determined by single crystal x-ray diffraction. FIG. 30A depict the unit cell viewed along the c axis direction. FIG. 30B depict the unit cell viewed along the direction perpendicular to the c axis.

FIG. 31 depicts Normalized PXRD patterns of (18C6@K)₂ZrBr₆ and K₂ZrBr₆ powders.

FIG. 32A depicts band structure and corresponding total partial density of states (pDOS) of (18C6@K)₂ZrBr₆. FIG. 32B depicts band structure and corresponding pDOS of K₂ZrBr₆.

FIGS. 33A-33F depict PLQY measurement of (18C6@K)₂ZrBr₆ powders at 275-nm excitation. The black line is the measurement of the sample, and the red line is the measurement of the blank sample holder. FIGS. 33A-33C depict three measurements from sample batch 1. FIGS. 33D-33F depict three measurements from sample batch 2.

FIGS. 34A and 34B depict PLQY measurement of K₂HfBr₆ powders at 275-nm excitation. In FIG. 34A, the black line is the measurement of the sample, and the red line is the measurement of the blank sample holder. FIG. 34B depicts a zoom-in spectra of FIG. 34A to better show the shape of the sample spectrum.

FIG. 35 depicts PL spectrum of K₂HfBr₆ powders at 275-nm excitation. The spectrum appears to be noisy due to the poor stability of K₂HfBr₆ powders in the air, and the therefore high measuring speed.

FIG. 36 depicts the CIE 1931 chromaticity diagram for the emissions of K₂HfBr₆ powders and (18C6@K)₂HfBr₆ powders. The coordinates for the emission color of K₂HfBr₆ were (0.21603, 0.24368), and the coordinates for the emission color of (18C6@K)₂HfBr₆ were (0.17438, 0.16922).

FIG. 37 depicts PL spectrum of (18C6@K)₂ZrBr₆ powders at 290-nm excitation.

FIG. 38 depicts PL spectrum of K₂ZrBr₆ powders at 290-nm excitation.

FIGS. 39A-39B depict PLQY measurement of (18C6@K)₂ZrBr₆ powders at 290-nm excitation.

In FIG. 39A, the black line is the measurement of the sample, and the red line is the measurement of the blank sample holder. FIG. 39B depicts zoom-in spectra of FIG. 39A to better show the shape of the sample spectrum.

FIGS. 40A-40B depict PLQY measurement of K₂ZrBr₆ powders at 290-nm excitation. In FIG. 40A, the black line is the measurement of the sample, and the red line is the measurement of the blank sample holder. FIG. 40B depicts zoom-in spectra of FIG. 40A to better show the shape of the sample spectrum.

FIG. 41 depicts the CIE 1931 chromaticity diagram for the emissions of (18C6@K)₂ZrBr₆ powders and (18C6@K)₂ZrCl₄Br₂ powders. The coordinates for the emission color of (18C6@K)₂ZrBr₆ powders were (0.37601, 0.45927), and the coordinates for the emission color of (18C6@K)₂ZrCl₄Br₂ powders were (0.30597, 0.41533).

FIG. 42 depicts Normalized PL spectra of different C1/Br ratio (18C6@K)₂ZrClₓBr₆₋ₓ powders.

FIG. 43 depicts the CIE 1931 chromaticity diagram for the emissions of powders of (A) (18C6@K)₂ZrBr₆, (B) (18C6@K)₂ZrCl₃Br₃, (C) (18C6@K)₂ZrCl₄Br₂, and (D) (18C6@K)₂ZrCl_{4.5}Br_{1.5}. The CIE coordinates were (0.37601, 0.45927), (0.29979, 0.40829), (0.30597, 0.41533), and (0.32101, 42682), respectively.

FIGS. 44A-44D depict PLQY measurement of (18C6@K)₂ZrCl₄Br₂ powders at 295-nm excitation. The black line is the measurement of the sample, and the red line is the measurement of the blank sample holder. FIGS. 44A and 44B depict two measurements from sample batch 1. FIGS. 44C and 44D depict two measurements from sample batch 2.

FIG. 45A depicts PLQY measurements of (18C6@K)₂ZrCl₃Br₃ powder at 295-nm excitation. FIG. 45B depicts PLQY measurements of (18C6@K)₂ZrCl4.5Br_{1.5} powder at 295-nm excitation. The black line is the measurement of the sample, and the red line is the measurement of the blank sample holder.

FIGS. 46A and 46B depict crystal structure of (18C6@K)₂ZrCl₄Br₂ determined by single crystal x-ray diffraction. FIG. 46A depicts the unit cell viewed along the c axis direction. FIG. 46B depicts the unit cell viewed along the direction perpendicular to the c axis. The molar ratio of Cl/Br was determined to be 4.3:1.7 according to the electron density calculation.

FIG. 47 depicts SEM-EDX results of a (18C6@K)₂ZrCl₄Br₂ single crystal, including SEM image, EDX elemental mapping, EDX spectrum and the corresponding atomic percentages. The EDX spectrum shows nonoverlapping characteristic x-ray signals for K Lα₁ (0.260 keV), K Kα₁ (3.314 keV), Zr Lα₁ (2.042 keV), Cl Kα₁ (2.622 keV), Br Lα_{1,2} (1.480 keV). Integration of the K, Zr, Cl, and Br emission lines confirmed the atomic ratio of K/Zr/Cl/Br to be approximately 2:1:4:2. The scale bars are 25 μm.

FIG. 48 depicts PXRD of (18C6@K)₂ZrCl₄Br₂ powders.

FIG. 49 depicts PXRD comparison of (18C6@K)₂ZrCl₄Br₂ powders and (18C6@K)₂ZrBr₆ powders at 2Theta values between 7 to 15 degrees. Both the (101) and (110) diffraction peaks of (18C6@K)₂ZrCl₄Br₂ were shifted to larger degree values.

FIG. 50 depicts Gaussian peak fitting of the PL spectrum of (18C6@K)₂HfBr₆ powders measured at 4 K. The shoulder peak at ˜2.3 eV came from the ˜0.6 atomic % Zr impurity in Hf.

FIG. 51 depicts Raman spectroscopy of (18C6@K)₂HfBr₆ powders. Three distinct Raman-active modes including the low-frequency asymmetric bending mode T_{2g}, the asymmetric stretching mode E_{g}, the high-frequency symmetric stretching mode A_{1g} corresponding to the Oh-symmetric vibrating [HfBr₆]²⁻.

FIG. 52 depicts PLE spectroscopy of (18C6@K)₂ZrBr₆ powders.

FIGS. 53A-53D depict photodegradation responses of (18C6@K)₂HfBr₆ and (18C6@K)₂ZrCl₄Br₂ powders. The powders were dispersed in toluene-d₈, placed in an argon-filled UV cuvette, and subjected to irradiation with a xenon lamp at 62 mW/cm² and 35° C. FIG. 53A depicts PL spectra of the (18C6@K)₂HfBr₆ sample measured at five different times during the continuous irradiation. FIG. 53B depicts the PL intensity decay of the (18C6@K)₂HfBr₆ sample over irradiation time. FIG. 53C depicts PL spectra of the (18C6@K)₂ZrCl₄Br₂ sample measured at six different times during the continuous irradiation. FIG. 53D depicts the PL intensity decay of the (18C6@K)₂ZrCl₄Br₂ sample over irradiation time.

FIG. 54 depicts PL spectra comparison of (18C6@K)₂HfBr₆/PS composite film, (18C6@K)₂HfBr₆ in DCM ink, and (18C6@K)₂HfBr₆ powders.

FIGS. 55A-55B depict PLQY measurement of (18C6@K)₂HfBr₆/PS in DCM ink at 275-nm excitation. In FIG. 55A, the black line is the measurement of the sample, and the red line is the measurement of the PS in DCM control ink. FIG. 55B depicts zoom-in spectra of FIG. 55A to better show the shape of the sample spectrum.

FIG. 56A depicts UV-vis absorption spectra of DCM solvent. FIG. 56B depicts UV-vis absorption spectra of PS thin film.

FIGS. 57A-57B depict PLQY measurement of (18C6@K)₂ZrCl₄Br₂/PS in DCM ink at 295-nm excitation. In FIG. 57A, the black line is the measurement of the sample, and the red line is the measurement of the PS in DCM control ink. FIG. 57B depicts zoom-in spectra of (A) to better show the shape of the sample spectrum.

FIG. 58 depicts PXRD comparison of (18C6@K)₂HfBr₆/PS composite film, PS film, and (18C6@K)₂HfBr₆ powders.

FIG. 59 depicts PXRD of (18C6@K)₂ZrCl₄Br₂/PS composite film.

FIGS. 60A-60F depicts SEM imaging of the powders and thin films. FIGS. 60A and 60B depict (18C6@K)₂HfBr₆ powders. FIGS. 60C and 60D depict top views of the surface of the pure PS film. FIGS. 60E and 60F depict top views of the surface of the (18C6@K)₂HfBr₆/PS composite film. The scale bars are 20 μm for FIGS. 60A, 60C, and 60E, and 5 μm for FIGS. 60B, 60D, and 60F.

FIGS. 61A-61D depict SEM imaging of the thin film cross sections. FIGS. 61A and 61B depict (18C6@K)₂HfBr₆/PS composite film. FIGS. 61C and 61D depict pure PS film. The scale bars are 50 μm for FIGS. 61A and 61C, and 5 μm for FIGS. 61B and 61D.

FIG. 62 depicts PL spectra comparison of (18C6@K)₂ZrCl₄Br₂/PS composite film, (18C6@K)₂ZrCl₄Br₂ in DCM ink, and (18C6@K)₂ZrCl₄Br₂ powders.

FIGS. 63A and 63B depict PLQY measurement of (18C6@K)₂HfBr₆/PS composite film at 275-nm excitation. In FIG. 63A, the black line is the measurement of the sample, and the red line is the measurement of the PS control. FIG. 63B depicts zoom-in spectra of FIG. 63A to better show the shape of the sample spectrum.

FIGS. 64A and 64B depict PLQY measurement of (18C6@K)₂ZrCl₄Br₂/PS composite film at 295-nm excitation. In FIG. 64A, the black line is the measurement of the sample, and the red line is the measurement of the PS control. FIG. 64B depicts zoom-in spectra of FIG. 64A to better show the shape of the sample spectrum.

FIGS. 65A-65D depict blue- and green-emitting films after one-month storage in the air. FIG. 65A depicts (18C6@K)₂HfBr₆/PS composite film under white lamp. FIG. 65B depicts (18C6@K)₂HfBr₆/PS composite film under 254-nm UV lamp. FIG. 65C depicts (18C6@K)₂ZrCl₄Br₂/PS composite film under white lamp. FIG. 65D depicts (18C6@K)₂ZrCl₄Br₂/PS composite film under 302-nm UV lamp.

FIG. 66A depicts UV-vis absorption spectrum of solid PEGDA resin. FIG. 66B depicts PL measurement of solid PEGDA resin. FIG. 66C depicts PL measurement of (18C6@K)₂HfBr₆/PEGDA composite film. FIG. 66D depicts PL measurement of (18C6@K)₂ZrCl₄Br₂/PEGDA composite film.

FIG. 67 depicts the CIE 1931 chromaticity diagram for the emissions of (18C6@K)₂HfBr₆ powders and (18C6@K)₂HfBr₆/PEGDA composite film. The coordinates for the emission color of (18C6@K)₂HfBr₆ powders were (0.17438, 0.16922), and the coordinates for (18C6@K)₂HfBr₆/PEGDA composite film were (0.20443, 0.23635).

FIG. 68 depicts the CIE 1931 chromaticity diagram for the emissions of (18C6@K)₂ZrCl₄Br₂ powders and (18C6@K)₂ZrCl₄Br₂/PEGDA composite. The coordinates for the emission color of (18C6@K)₂ZrCl₄Br₂ powders were (0.30597, 0.41533), and the coordinates for the emission color of (18C6@K)₂ZrCl₄Br₂/PEGDA composite film were (0.28378, 0.37125).

FIG. 69A depicts 3D-printed twisted octet trusses architecture with (18C6@K)₂HfBr₆ and (18C6@K)₂ZrCl₄Br₂ powders embedded under white lamp excitation. FIG. 69B depicts 3D-printed twisted octet trusses architecture with (18C6@K)₂HfBr₆ and (18C6@K)₂ZrCl₄Br₂ powders embedded under 254-nm UV lamp excitation. The scale bars are 5 mm.

FIG. 70A depicts 3D-printed conformal octet trusses architecture with (18C6@K)₂HfBr₆ and (18C6@K)₂ZrCl₄Br₂ powders embedded under white lamp excitation. FIG. 70B depicts 3D-printed conformal octet trusses architecture with (18C6@K)₂HfBr₆ and (18C6@K)₂ZrCl₄Br₂ powders embedded under 254-nm UV lamp excitation. FIG. 70C depicts regional zoom-in image of the structure under 254-nm UV lamp excitation. The scale bars for FIGS. 70A and 70B are 5 mm. The scale bar for FIG. 70C is 2 mm.

FIGS. 71A, 71C, 71E, and 71G depict 3D-printed architectures with (18C6@K)₂HfBr₆ powders embedded as Geometric shapes of cuboctahedron, tetrakaidecahedron, octet truss, and Menger sponge under white lamp, respectively. FIGS. 71B, 71D, 71F, and 7111 depicts the corresponding 3D-printed architectures under 254-nm UV lamp excitation. The scale bars are 2 mm.

FIG. 72A depicts a photo of a group of the 3D-printed architectures under white lamp excitation. FIG. 72B depicts a photo of a group of the 3D-printed architectures under 254-nm UV lamp excitation. The scale bars are 5 mm.

FIG. 73 depicts the quantum dot LED (QLED) display structure diagram. Quantum dots can convert the blue light into red and green light, creating the RGB pixels.

FIGS. 74A-74D depict Crystal structure of the green emitter (18C6@Ba)MnBr₄. FIG. 74A depicts the basic structural unit of (18C6@Ba)MnBr₄. FIG. 74B depicts the 1D linear chain structure formed by connecting the basic structural unit. FIG. 74C depicts the top view and FIG. 74D depicts the side view of the unit cell of the (18C6@Ba)MnBr₄ single crystal.

FIGS. 75A-75C depict photoluminescence properties of (18C6@Ba)MnBr₄. FIG. 75A depicts photoluminescence (PL) and photoluminescence excitation (PLE) spectra of (18C6@Ba)MnBr₄. powders with 365-nm excitation. The PLQY was determined to be 82.1%. The inset image is the green emission of a (18C6@Ba)MnBr₄ crystal under confocal microscope. FIG. 75B depicts the CIE 1931 chromaticity diagram for the emission of (18C6@Ba)MnBr₄ powders. The coordinates for the emission color of was (0.13713, 0.66309). FIG. 75C depicts 2D PLE spectroscopy of (18C6@Ba)MnBr₄ powders.

FIGS. 76A-76F depict the crystal structure and optical properties of (18C6@Ba)SbCl₅. FIG. 76A depicts the (18C6@Ba)SbCl₅ asymmetric unit. FIG. 76B depicts the linear infinite 1D chain of repeating (18C6@Ba)SbCl₅ asymmetric units. FIG. 76C depicts the rhombohedral unit cell of the (18C6@Ba)SbCl₅ single crystal viewed from the perpendicular direction of the c axis. FIG. 76D depicts the rhombohedral unit cell of the (18C6@Ba)SbCl₅ single crystal viewed along the direction of the c axis. FIG. 76E depicts the PL spectrum of (18C6@Ba)SbCl₅ with 375-nm excitation. FIG. 76F depicts confocal microscope images of (18C6@Ba)SbCl₅ under white light and 375-nm excitation. The scale bar is 20 μm.

### DETAILED DESCRIPTION

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise.

The terms “about” or “approximate” and the like are synonymous and are used to indicate that the value modified by the term has an understood range associated with it, where the range can be ±20%, ±15%, ±10%, ±5%, or ±1%. The terms “substantially” and the like are used to indicate that a value is close to a targeted value, where close can mean, for example, the value is within 80% of the targeted value, within 85% of the targeted value, within 90% of the targeted value, within 95% of the targeted value, or within 99% of the targeted value.

As used herein with respect to a parameter, the term “decreased” or “decreasing” or “decrease” or “reduced” or “reducing” or “reduce” or “lower” refers to a detectable (such as at least about 5%, 10%, 15%, 20%, 25%, 30%, 35%, 40%, 45%, 50%, 55%, 60%, 65%, 70%, 75%, 80%, 85%, 90%, 95%, 96%, 97%, 98%, 99%, or 100%) negative change in the parameter from a comparison control, such as an established normal or reference level of the parameter, or an established standard control. Accordingly, the terms “decreased,” “reduced,” and the like encompass both a partial reduction and a complete reduction compared to a control.

As used herein with respect to a parameter, the term “increased” or “increasing” or “increase” or “enhanced” or “enhancing” or “enhance” or “greater” refers to a detectable (such as at least about 5%, 10%, 15%, 20%, 25%, 30%, 35%, 40%, 45%, 50%, 55%, 60%, 65%, 70%, 75%, 80%, 85%, 90%, 95%, 100%, 200%, 300%, 400%, 500%, 600%, 700%, 800%, 900%, or 1000%) positive change in the parameter from a comparison control, such as an established normal or reference level of the parameter, or an established standard control.

### A. Supramolecular Assembly of Halide Perovskites

Emission with high photoluminescence quantum yield (PLQY) is at the forefront of solid-state lighting and color display research. Covalent semiconductors such as GaN require high purity to prevent rapid nonradiative recombination at crystal structure defects and rely on solid-state synthesis at elevated temperatures near 1000° C. As an alternative to covalent semiconductors, ionic halide perovskites have received attention given their high optical absorption coefficient, tunable bandgap, high defect tolerance, and efficient photo- and electroluminescence. For example, the blue and green emissive colloidal CsPbClₓBr₃₋ₓ quantum dots have exhibited PLQY values of ˜80%. In addition, low-dimensional halide perovskites like the n=1 Ruddlesden-Popper phase (C₆H₅CH₂NH₃)₂PbBr₄ show blue emission with a PLQY of 79%. Despite the notable optoelectronic properties of lead-based halide perovskites, the toxicity of lead and the complex colloidal synthesis complicate large scale applications. Moreover, suitable ligands are still needed to prevent aggregation of these low-dimensional nanostructures during use.

The structural diversity and tunable optoelectronic properties of halide perovskites originate from the rich chemistry of metal halide ions, such as metal halide ionic octahedron [MX₆]ⁿ⁻ and metal halide ionic tetrahedron [MX₄]ⁿ⁻, where M is a metal cation such as Te⁴⁺, Sn⁴⁺, Pt²⁺, Se³⁺, Ir⁴⁺, Zr⁴⁺, Hf⁴⁺, Ce⁴⁺, and Mn²⁺, and X is a halide such as Cl⁻, Br⁻, and I⁻. The properties of the extended perovskite solids are dictated by the assembly, connectivity, and interaction of these halide perovskite units within the lattice environment. Hence, the ability to manipulate and control the assembly of the halide perovskite building blocks is paramount for constructing new perovskite materials. Provided herein is a systematic supramolecular strategy for the assembly of a metal halide anionic unit into a solid extended network.

Interaction of alkali metal-bound crown ethers with the metal halide anionic unit such as the [M(IV)X₆]²⁻ octahedron, the [M(II)X₄]²⁻ tetrahedron, or [M(III)X₅]²⁻ octahedron can result in a structurally and optoelectronically tunable dumbbell structural unit or a linear chain in solution. Single crystals with diverse packing geometries and symmetries form as the solid assembly of this new supramolecular building block. The supramolecular assembly route provided herein introduces a new general strategy for designing halide perovskite structures with potentially new optoelectronic properties.

The crown ether-assisted supramolecular approach can stabilize halide perovskite (such as [M(IV)X₆]²⁻, [M(II)X₆]²⁻, and [M(III)X₅]²⁻ (M(IV)=tetravalent metal cation, M(II)=divalent metal cation, M(III)=trivalent metal cation, X=halide anion) emission centers in crystals with superior emission properties. The compounds, compositions, and methods provided herein have at least the following advantages over other materials having these emission centers:
(1) The PLQY of the supramolecular assembled solids can be improved. For example, (18-Crown-6@K)₂HfBr₆ can achieve blue emission with a near-unity PLQY value of 96.22%, while the K₂HfBr₆ has a PLQY of around 40%. (18-Crown-6@K)₂ZrCl₄Br₂ can achieve green emission with a PLQY value of 82.7%, while K₂ZrBr₆ has a PLQY of about 46%.
(2) The emission has great tunability in terms of the emission color. Halide perovskite units with eight different tetravalent metal centers (Te, Sn, Pt, Ir, Zr, Hf, Ce, Se) for octahedra formation or Mn for tetrahedra formation, and all three halides (Cl, Br, I) can be stabilized. [M(II)X₆]²⁻ and [M(III)X₅]²⁻ adds further options for tunability. These options enable emission across the whole visible spectrum.
(3) The synthetic condition is much more cost-effective and mild than the traditional alkali metal cation vacancy-ordered perovskites such as A₂M(IV)X₆, AM(II)X₄, or AM(III)X₅. All the compositions can be fabricated using polar organic solvents at 60-100° C., such as 80° C. In contrast, some metal cation vacancy-ordered perovskites, such as Cs₂ZrBr₆ and Cs₂HfBr₆, require high temperature (˜800° C.) solid-state synthesis.
(4) The purity of the synthetic product is higher than the alkali metal cation vacancy-ordered perovskites. For example, (18-Crown-6@K)₂ZrBr₆, (18-Crown-6@K)₂HfBr₆, and (18-Crown-6@Ba)MnBr₄ are very pure according to powder XRD measurements, whereas the synthesis of Cs₂ZrBr₆, Cs₂HfBr₆, or BaMnBr₄ can result in non-negligible CsBr or BaBr₂ impurities.
(5) The air stability of the supramolecular assembled powders is improved. For example, Zr and Hf containing double perovskites are susceptible to moisture, but when they are assembled by crown ethers, the air stability increased from one hour to a few days.
   (i) Halide Perovskite Compound (Crown Ether@A)₂M(IV)X₆

A halide perovskite compound according to the formula: (crown ether@A)₂M(IV)X₆ has the M(IV), which is at least one tetravalent metal cation; the X, which is at least one halide anion; and the crown ether@A, which is at least one alkali metal-bound crown ether formed between an alkali metal cation A and oxygen atoms of a crown ether, e.g., by electrostatic interaction. The (crown ether@A)₂M(IV)X₆ can form an octahedral unit.

The halide perovskite compound provided herein can be tunable by adjusting components, i.e., crown ether, A, M(IV), and X. For example, the M(IV) can be one or more of; Te⁴⁺, Sn⁴⁺, Pt²⁺, Se³⁺, Ir⁴⁺, Zr⁴⁺, Hf⁴⁺, and Ce⁴⁺; the X can be one or more of Cl⁻, Br⁻, and I⁻; the crown ether can be one or more of 18-Crown-6 (18C6) and 21-Crown-7 (21C7); and/or the A can be one or more of Cs⁺, Rb⁺, and K⁺. For example, halide perovskite compound can be (18-Crown-6@K)₂HfBr₆ or (18C6@K)₂ZrCl₄Br₂. For example, X6 can be any combination of Cl⁻, Br⁻, and I⁻, such as Cl₆, Cl₅Br, Cl₄Br₂, Cl₃Br₃, Cl₂Br₄, ClBr₅, Br₆, Cl₅I, Cl₄I₂, Cl₃I₃, Cl₂I₄, ClI₅, I₆, Br₅I, Br₄I₂, Br₃I₃, Br₂I₄, BrI₅, Cl₄BrI, Cl₃Br₂I, Cl₃BrI₂, Cl₂Br₃I, Cl₂Br₂I₂, Cl₂BrI₃, ClBr₄I, ClBr₃I₂, ClBr₂I₃, and ClBrI₄.

The halide perovskite compound can be (18 C6@Cs)₂M(IV)Cl₆, wherein the M(IV) is Te⁴⁺, Sn⁴⁺, Pt²⁺, Se³⁺, Ir⁴⁺, Zr⁴⁺, Hf⁴⁺, or Ce⁴⁺. The halide perovskite compound can be (18C6@Cs)₂TeX₆, wherein the X is Cl⁻, Br⁻, or I⁻. The halide perovskite compound can be (18C6@A)₂TeCl₆, wherein the A is Cs⁺, Rb⁺, or K⁺. The halide perovskite compound can be (Crown ether@Cs)₂TeCl₆, wherein crown ether is 18C6 or 21C7. The halide perovskite compound can be (18 C6@K)₂M(IV)Cl₆, wherein the M(IV) is Pt²⁺, Ir⁴⁺, Se³⁺, Sn⁴⁺, or Te⁴⁺.

The halide perovskite compound can be (18C6@Cs)₂TeBr₆ or (18C6@Cs)₂TeCl₆.

The halide perovskite compound can form a dumbbell-shaped structural unit formed by two [crown ether@A]⁺s and one [M(IV)X₆]²⁻, and/or a rhombohedral crystal structure of a plurality of the dumbbell-shaped structural units. The [crown ether@A]⁺ is a free charged form of the crown ether@A, and the [M(IV)X₆]²⁻ is a free charged form of the M(IV)X₆. The halide perovskite compound (crown ether@A)₂M(IV)X₆ can be in any form such as in powder, crystal, or solution. The halide perovskite compound (crown ether@A)₂M(IV)X₆ can have higher purity as compared to a control compound (e.g., A₂M(IV)X₆ without the crown ether and comprising the same A, M(IV), and X as the halide perovskite compound (crown ether@A)₂M(IV)X₆). The purity of the halide perovskite compound (crown ether@A)₂M(IV)X₆ can be about 80%, 81%, 82%, 83%, 84%, 85%, 96%, 87%, 88%, 89%, 90%, 91%, 92%, 93%, 94%, 95%, 96%, 97%, 98%, 99%, 99.5%, or greater.

The halide perovskite compound can have greater photoluminescence quantum yield (PLQY) as compared to a control compound A₂M(IV)X₆ without the crown ether and comprising the same A, M(IV), and X as the halide perovskite compound. For example, the PLQY of the halide perovskite compound can be about 80%, 81%, 82%, 83%, 84%, 85%, 96%, 87%, 88%, 89%, 90%, 91%, 92%, 93%, 94%, 95%, 96%, 97%, 98%, 99%, or greater. The PLQY can be measured at various excitation/emission wavelength, including under excitation at 275 nm and measured at 445 nm (blue light emission), or under excitation at 295 nm and measured at 530 nm (green light emission). For example, formula (18C6@K)₂HfBr₆ has near-unity (96.2%) PLQY under excitation at 275 nm and measured at 445 nm. Formula (18C6@K)₂ZrCl₄Br₂ has green emission with 82.7% PLQY under excitation at 295 nm and measured at 530 nm.

The halide perovskite compound provided herein can have increased air stability as compared to a control compound A₂M(IV)X₆ without the crown ether and comprising the same A, M, and X as the halide perovskite compound. In some embodiments, the air stability of the halide perovskite compound increased by about 1 hour to about 3 days as compared to the control compound.

The optoelectronic properties of halide perovskites stem from the [MX₆]ⁿ⁻ (where M is a metal cation and X is a halide anion) fundamental building blocks in the crystal structure, and given the ionic nature and high chemical tunability of halide perovskite structures, different compositions and packing geometries of [MX₆]ⁿ⁻ could be explored for light-emission applications. The vacancy-ordered double perovskite(A₂MX₆ phase) has been proposed to incorporate tetravalent metal cation octahedra, such as [TeX₆]²⁻, [SnX₆]²⁻, and[PtX₆]²⁻. Although the [PbX₆]⁴⁻ octahedra are corner-shared in all three dimensions in the prototypical CsPbX₃ structure, the [MX₆]²⁻ octahedra in the A₂MX₆ phase are isolated because a vacancy occupies every other M site in the crystal structure. A few [MX₆]ⁿ⁻ emitters as well as some non-octahedral emitters with high PLQY (˜95%) have been identified with yellow emission, such as [SnX₆]⁴⁻. However, emission of high PLQY with shorter wavelengths is still very rare. The isolated nature of the octahedra affects the optoelectronic properties in that the strong coupling of the exciton with lattice vibrations greatly lowers the energy level of the exciton and forces it into transient self-trapped exciton (STE) states with a range of self-trapped energy levels. As a result, the A₂MX₆ systems generally have broadband emissions with a large Stokes shift.

Although the A₂MX₆ phase has been studied in various compositions, octahedra with Hf⁴⁺ or Zr⁴⁺ centers, especially [HfBr₆]²⁻ and [ZrBr₆]²⁻ octahedra, have rarely been the subject of research, even though they have interesting optoelectronic properties. Cs₂HfBr₆ crystals have a blue emission with the PL peak at 435 nm, and colloidal Cs₂ZrBr₆ nanocrystals have been demonstrated to have a green emission with a PLQY of 45%. There are several reasons why they are less explored. Theoretical and experimental studies have shown that the Hf⁴⁺ and Zr⁴⁺ metal centers are extremely air- and moisture sensitive in the A₂MX₆ phase. Their synthesis requires the vertical Bridgman-Stockbarger method at ˜1000° C. in sealed quartz ampoules. Finally, it is difficult to prepare high-purity samples that do not contain a secondary impurity, such as CsBr. Thus, a new methodology is needed for the synthesis of more stabilized and purer solid phases containing the [HfBr₆]²⁻ or [ZrBr₆]²⁻ octahedra. The halide perovskite compounds (crown ether@A)₂M(IV)X₆ solves the foregoing problems.

Described herein is the first demonstration of the stabilization of [M(IV)X₆]²⁻ (M=tetravalent metal cation, X=halide anion) octahedra emission centers using a crown ether-assisted supramolecular approach. Compared with other methods to stabilize the [M(IV)X₆]²⁻ octahedra, the described fabrication process is more cost-effective and facile. It is solution processable and easy to scale-up. The technical difficulty of organic solvent selection and anti-solvent selection were overcome to achieve 100% pure solids, including both single crystals and powders. N, N-Dimethylformamide (DMF) or acetonitrile (ACN) is used as the solvent to dissolve the alkali metal halide, tetravalent metal halide, and crown ether precursors. Diethyl ether (DEE) is applied as the anti-solvent to crystallize the solids out of the precursor solutions. The resulting halide perovskite compounds are free of any impurities and provide superior emission properties, with high PLQY. Halide perovskites comprising the formula (crown ether@A)₂M(IV)X₆ are further described in Zhu et al. 2022 J Am Chem Soc 144:12450-12458 and Zhu et al. 2024 Science 383:86-93, the entire content of which references is incorporated by reference herein.

Tables 1-17 below provide example details of the halide perovskite compounds having the formula (crown ether@A)₂M(IV)X₆. Table 18 provides a non-exhaustive list of example compounds of the present disclosure.

TABLE 1
Crystallographic tables for (18C6@K)₂TeCl₆, (18C6@Rb)₂TeCl₆, and
(18C6@Cs)₂TeCl₆, single crystals

| Crystal | (18C6@K)₂TeCl₆ | (18C6@Rb)₂TeCl₆ | (18C6@Cs)₂TeCl₆ |
|---|---|---|---|
| ICSD Number | 2122205 | 2122204 | 2122203 |
| Empirical formula | C₂₄H₄₈Cl₆K₂O₁₂Te | C₂₄H₄₈Cl₆O₁₂Rb₂Te | C₂₄H₄₈C₁₆CS₂O₁₂Te |
| Formula weight | 947.12 | 1039.86 | 1134.74 |
| Temperature/K. | 293(2) | 293(2) | 293(2) |
| Crystal system | trigonal | trigonal | Trigonal |
| Space group | R-3 | R-3 | R-3 |
| a/Å | 13.9266(6) | 13.9737(6) | 13.9417(3) |
| b/Å | 13.9266(6) | 13.9737(6) | 13.9417(3) |
| c/Å | 20.5594(8) | 21.0360(9) | 22.1002(6) |
| α/° | 90 | 90 | 90 |
| β/° | 90 | 90 | 90 |
| y/° | 120 | 120 | 120 |
| Volume/Å³ | 3453.3(3) | 3557.3(3) | 3720.13(19) |
| Z | 3 | 3 | 3 |
| pcalcmg/mm³ | 1.366 | 1.456 | 1.520 |
| μ/mm⁻¹ | 1.218 | 3.046 | 2.410 |
| F(000) | 1440.0 | 1548.0 | 1656.0 |
| Crystal size/mm³ | 0.51 × 0.388 × 0.194 | 0.185 × 0.155 × 0.136 | 0.273 × 0.174 × 0.082 |
| Radiation | Mo Kα (λ = 0.71073) | Mo Kα (λ = 0.71073) | Mo Kα (λ = 0.71073) |
| 2Θ range for data | −5.85 to 58.914° | 7.77 to 58.946° | 5.844 to 52.744 |
| collection | | | |
| Index ranges | −15 ≤ h ≤ 16, −18 ≤ k ≤ | −18 ≤ h ≤ 16,−17 ≤ k ≤ | −17 ≤ h ≤17, −17 ≤ k ≤ |
| | 15, −25 ≤ 1 ≤ 27 | 19, −26 ≤ 1 ≤ 27 | 17, −27 ≤ 1 ≤ 27 |
| Reflections | 8381 | 8997 | 22909 |
| collected | | | |
| Independent | 1857[R(int) = 0.0365] | 1905[R(int) = 0.0329] | 1697 [Rint = 0.0360, |
| reflections | | | Rsigma = 0.0120] |
| Data/restraints/ | 1857/0/69 | 1905/0/69 | 1697/0/69 |
| parameters | | | |
| Goodness-of-fit on | 1.043 | 1.100 | 1.063 |
| F² | | | |
| Final R indexes | R₁ = 0.0297, wR₂ = | R₁ = 0.0450, wR₂ = | R₁ = 0.0232, wR₂ = |
| [I>=20 (I)] | 0.0774 | 0.1206 | 0.0655 |
| Final R indexes | R₁ = 0.0361, wR₂ = | R₁ = 0.0572, wR₂ = | R₁ = 0.0291, wR₂ = |
| [all data] | 0.0804 | 0.1272 | 0.0696 |
| Largest diff. | 1.01/-0.37 | 2.60/-0.85 | 0.66/-0.49 |
| peak/hole / e Å⁻³ | | | |

TABLE 2
Crystallographic tables for (18C6@K)₂TeBr₆, (18C6@Rb)₂TeBr₆, and
(18C6@Cs)₂TeBr₆, single crystals

| Crystal | (18C6@K)₂TeBr₆ | (18C6@Rb)₂TeBr₆ | (18C6@Cs)₂TeBr₆ |
|---|---|---|---|
| ICSD Number | 2122195 | 2122194 | 2122196 |
| Empirical formula | C₂₄H₄₈Br₆K₂O₁₂Te | C₂₄H₄₈Br₆O₁₂Rb₂Te | C₂₄H₄₈Br₆O₁₂Cs₂Te |
| Formula weight | 1213.88 | 1306.62 | 369.44 |
| Temperature/K. | 293(2) | 293(2) | 293(2) |
| Crystal system | trigonal | trigonal | trigonal |
| Space group | R-3 | R-3 | R-3 |
| a/Å | 14.2030(6) | 14.2117(7) | 14.1941(3) |
| b/Å | 14.2030(6) | 14.2117(7) | 14.1941(3) |
| c/Å | 21.3516(10) | 21.6941(12) | 22.5099(5) |
| α/° | 90 | 90 | 90 |
| β/° | 90 | 90 | 90 |
| γ/° | 120 | 120 | 120 |
| Volume/Å³ | 3730.1(4) | 3794.6(4) | 3927.53(19) |
| Z | 3 | 3 | 44 |
| pcalcmg/mm³ | 1.621 | 1.715 | 6.873 |
| μ/mm⁻¹ | 5.626 | 7.278 | 29.335 |
| F(000) | 1764.0 | 1872.0 | 6908.0 |
| Crystal size/mm³ | 0.283 × 0.235 × 0.159 | 0.264 × 0.205 × 0.16 | 0.242 × 0.094 × 0.09 |
| Radiation | Mo Kα (λ = 0.71073) | Mo Kα (λ = 0.71073) | Mo Kα (λ = 0.71073) |
| 2Θ range for data | 6.894 to 58.626° | 6.882 to 58.97° | 6.872 to 59.14° |
| collection | | | |
| Index ranges | −17 ≤ h ≤ 19, | −17 ≤ h ≤ 18, | −19 ≤ h ≤ 19, |
| | −18 ≤ k ≤ 18, | −18 ≤k ≤ 18, | −19 ≤ k ≤ 19, |
| | −26 ≤ 1 ≤ 27 | −29 ≤ 1 ≤ 28 | −27 ≤ 1 ≤ 31 |
| Reflections | 9333 | 9547 | 29928 |
| collected | | | |
| Independent | 2005[R(int) = 0.0416] | 2011[R(int) = 0.0377] | 2260[R(int) = 0.0274] |
| reflections | | | |
| Data/restraints/ | 2005/0/69 | 2011/0/69 | 2260/0/69 |
| parameters | | | |
| Goodness-of-fit | 1.045 | 0.956 | 1.062 |
| on F² | | | |
| Final R indexes | R₁ = 0.0260, wR₂ = | R₁ = 0.0184, wR₂ = | R₁ = 0.0387, wR₂ = |
| [I >= 2σ (I)] | 0.0681 | 0.0425 | 0.1093 |
| Final R indexes | R₁ = 0.0313, wR₂ = | R₁ = 0.0241, wR₂ = | R₁ = 0.0452, wR₂ = |
| [all data] | 0.0693 | 0.0433 | 0.1135 |
| Largest diff. | 0.38/−0.57 | 0.34/−0.34 | 3.79/−0.50 |
| peak/hole/e Å⁻³ | | | |

TABLE 3
Crystallographic tables for (18C6@K)₂SnCl₆, (18C6@Rb)₂SnCl₆, and
(18C6@Cs)₂SnCl₆, single crystals

| Crystal | (18C6@K)₂SnCl₆ | (18C6@Rb)₂SnCl₆ | (18C6@Cs)₂SnCl₆ |
|---|---|---|---|
| ICSD Number | 2122200 | 2122201 | 2122199 |
| Empirical formula | C₂₄H₄₈Cl₆K₂O₁₂Sn | C₂₄H₄₈Cl₆O₁₂Rb₂Sn | C₂₄H₄₈Cl₆Cs₂O₁₂Sn |
| Formula weight | 938.21 | 1030.95 | 1125.83 |
| Temperature/K. | 293(2) | 293(2) | 293(2) |
| Crystal system | trigonal | trigonal | trigonal |
| Space group | R-3 | R-3 | R-3 |
| a/Å | 13.9639(5) | 13.9702(9) | 13.9374(7) |
| b/Å | 13.9639(5) | 13.9702(9) | 13.9374(7) |
| c/Å | 20.2841(8) | 20.8648(16) | 22.0606(12) |
| α/° | 90 | 90 | 90 |
| β/° | 90 | 90 | 90 |
| γ/° | 120 | 120 | 120 |
| Volume/Å³ | 3425.3(3) | 3526.5(5) | 3711.2(4) |
| Z | 3 | 3 | 3 |
| ρcalcmg/mm³ | 1.364 | 1.456 | 1.511 |
| μ/mm⁻¹ | 1.136 | 2.984 | 2.331 |
| F(000) | 1434.0 | 1542.0 | 1650.0 |
| Crystal size/mm³ | 0.24 × 0.22 × 0.18 | 0.168 × 0.106 × 0.097 | 0.15 × 0.14 × 0.1 |
| Radiation | Mo Kα (γ = 0.71073) | Mo Kα (γ = 0.71073) | Mo Kα (γ = 0.71073) |
| 2Θ range for data | 7.846 to 59.214° | 8.27 to 58.87° | 5.846 to 59.226° |
| collection | | | |
| Index ranges | −18 ≤ h ≤ 17, −17 ≤ k ≤ | −16 ≤ h ≤ 18, −19 ≤ k ≤ | −17 ≤ h ≤ 16, −18 ≤ k ≤ |
| | 18, −25 ≤ 1 ≤ 28 | 17, −26 ≤ 1 ≤ 26 | 18, −28 ≤ 1 ≤ 28 |
| Reflections | 8808 | 6255 | 9296 |
| collected | | | |
| Independent | 1822[R(int) = 0.0252] | 1817[R(int) = 0.0324] | 1998[R(int) = 0.0279] |
| reflections | | | |
| Data/restraints/ | 1822/0/69 | 1817/0/69 | 1998/0/69 |
| parameters | | | |
| Goodness-of-fit on | 1.159 | 1.028 | 1.228 |
| F² | | | |
| Final R indexes | R₁ = 0.0246, wR₂ = | R₁ = 0.0269, wR₂ = | R₁ = 0.0380, wR₂ = |
| [I >= 20 (I)] | 0.0728 | 0.0599 | 0.1328 |
| Final R indexes | R₁ = 0.0262, wR₂ = | R₁ = 0.0381, wR₂ = | R₁ = 0.0502, wR₂ = |
| [all data] | 0.0736 | 0.0625 | 0.1480 |
| Largest diff. | 1.14/−0.36 | 0.41/−0.49 | 1.19/−1.05 |
| peak/hole/e Å⁻³ | | | |

TABLE 4
Crystallographic tables for (18C6@K)₂SnBr₆, (18C6@Rb)₂SnBr₆, and
(18C6@Cs)₂SnBr₆, single crystals

| Crystal | (18C6@K)₂SnBr₆ | (18C6@Rb)₂SnBr₆ | (18C6@Cs)₂SnBr₆ |
|---|---|---|---|
| ICSD Number | 2122206 | 2122197 | 2122202 |
| Empirical formula | C₂₄H₄₈K₆O₁₂Sn | C₂₄H₄₈Br₆O₁₂Rb₂Sn | C₂₄H₄₈Br₆Cs₂O₁₂Sn |
| Formula weight | 1204.97 | 1297.71 | 1392.59 |
| Temperature/K. | 293(2) | 293(2) | 293(2) |
| Crystal system | trigonal | trigonal | triclinic |
| Space group | R-3 | R-3 | P-1 |
| a/Å | 14.1856(7) | 14.1962(8) | 8.9775(2) |
| b/Å | 14.1856(7) | 14.1962(8) | 9.0482(2) |
| c/Å | 21.1321(12) | 21.5006(11) | 16.3064(4) |
| α/° | 90 | 90 | 95.516(2) |
| β/° | 90 | 90 | 90.129(2) |
| γ/° | 120 | 120 | 104.150(2) |
| Volume/Å³ | 3682.7(4) | 3768.2(5) | 1277.98(5) |
| Z | 3 | 3 | 1 |
| ρcalcmg/mm³ | 1.630 | 1.716 | 1.809 |
| μ/mm⁻¹ | 5.613 | 7.245 | 6.633 |
| F(000) | 1758.0 | 1866.0 | 658.0 |
| Crystal size/mm³ | 0.45 × 0.32 × 0.16 | 0.16 × 0.15 × 0.12 | 0.27 × 0.18 × 0.16 |
| Radiation | Mo Kα (γ = 0.71073) | Mo Kα (γ = 0.71073) | Mo Kα (γ = 0.71073) |
| 2Θ range for data | 6.908 to 58.982° | 5.66 to 59.164° | 5.516 to 59.12° |
| collection | | | |
| Index ranges | −17 ≤ h ≤ 18, −17 ≤ k ≤ | −18 ≤ h ≤ 16, −19 ≤ k ≤ | −11 ≤ h ≤ 12, −12 ≤ k ≤ |
| | 18, −26 ≤ 1 ≤ 28 | 19, −29 ≤ 1 ≤ 27 | 12, −22 ≤ 1 ≤ 22 |
| Reflections | 9095 | 9515 | 28461 |
| collected | | | |
| Independent | 1973[R(int) = 0.0611] | 2024[R(int) = 0.0313] | 6089[R(int) = 0.0615] |
| reflections | | | |
| Data/restraints/ | 1973/0/70 | 2024/0/69 | 6089/0/205 |
| parameters | | | |
| Goodness-of-fit on | 1.098 | 1.068 | 1.031 |
| F² | | | |
| Final R indexes | R₁ = 0.0252, wR₂ = | R₁ = 0.0255, wR₂ = | R₁ = 0.0305, wR₂ = |
| [I >= 20 (I)] | 0.0706 | 0.0682 | 0.0768 |
| Final R indexes | R₁ = 0.0290, wR₂ = | R₁ = 0.0305, wR₂ = | R₁ = 0.0375, wR₂ = |
| [all data] | 0.0715 | 0.0699 | 0.0788 |
| Largest diff. | 0.53/−0.69 | 0.81/−0.38 | 0.88/−0.52 |
| peak/hole/e Å⁻³ | | | |

TABLE 5
Crystallographic tables for (18C6@K)₂PtCl₆, (18C6@K)₂IrCl₆
single crystals

| Crystal | (18C6@K)₂PtCl₆ | (18C6@K)₂IrCl₆ |
|---|---|---|
| ICSD Number | 2122198 | 2145199 |
| Empirical formula | C₂₄H₄₈Cl₆K₂O₁₂Pt | C₂₄H₄₈Cl₆K₂O₁₂Ir |
| Formula weight | 1014.61 | 1011.72 |
| Temperature/K. | 293(2) | 293(2) |
| Crystal system | trigonal | trigonal |
| Space group | R-3 | R-3 |
| a/Å | 13.9074(6) | 13.8805(2) |
| b/Å | 13.9074(6) | 13.8805 (2) |
| c/Å | 20.0756(10) | 20.2478(3) |
| α/° | 90 | 90 |
| β/° | 90 | 90 |
| γ/° | 120 | 120 |
| Volume/Å³ | 3362.7(3) | 3378.46(11) |
| Z | 3 | 3 |
| ρcalcmg/mm³ | 1.503 | 1.492 |
| μ/mm⁻¹ | 3.717 | 11.053 |
| F(000) | 1518.0 | 1515.0 |
| Crystal size/mm³ | 0.125 × 0.09 × 0.085 | 0.13 × 0.07 × 0.03 |
| Radiation | Mo Kα (λ = 0.71073) | Cu Kα (λ = 1.54184) |
| 2Θ range for data | 7.892 to 58.732° | 12.756 to 157.342° |
| collection | | |
| Index ranges | −18 ≤ h ≤ 17, | −17 ≤ h ≤ 17, |
| | −18 ≤ k ≤ 19, | −17 ≤ k ≤ 17, |
| | −26 ≤ 1 ≤ 23 | −25 ≤ 1 ≤ 25 |
| Reflections | 6641 | 24775 |
| collected | | |
| Independent | 1745[R(int) = 0.0268] | 1615[R(int) = 0.0390] |
| reflections | | |
| Data/restraints/ | 1745/0/69 | 1615/0/69 |
| parameters | | |
| Goodness-of-fit on | 1.103 | 1.106 |
| F² | | |
| Final R indexes | R₁ = 0.0341, | R₁ = 0.0145, |
| [I >= 2σ (I)] | wR₂ = 0.0818 | wR₂ = 0.0346 |
| Final R indexes | R1= 0.0355, | R1=0.0147, |
| [all data] | wR2 = 0.0825 | wR2 = 0.0347 |
| Largest diff. | 6.54/−0.51 | 0.33/−0.29 |
| peak/hole/e Å⁻³ | | |

TABLE 6
Crystallographic tables for (18C6@K)₂SeCl₆ and (18C6@Cs)₂ZeCl₆ single crystals

| Crystal | (18C6@K)₂SeCl₆ | | (18C6@Cs)₂ZrCl₆ | |
|---|---|---|---|---|
| ICSD Number | 2145198 | | 2145197 | |
| Empirical formula | C₂₄H₄₈Cl₆K₂O₁₂Se | | C₂₄H₄₈C₁₆Cs₂O₁₂Zr | |
| Formula weight | 898.48 | | 1098.36 | |
| Temperature/K. | 293(2) | | 293(2) | |
| Crystal system | trigonal | | trigonal | |
| Space group | R-3 | | R-3 | |
| a/Å | 13.8912(4) | | 13.8547(2) | |
| b/Å | 13.8912(4) | | 13.8547(2) | |
| c/Å | 20.3021(6) | | 21.9616(4) | |
| α/º | 90 | | 90 | |
| β/° | 90 | | 90 | |
| γ/º | 120 | | 120 | |
| Volume/Å³ | 3392.7(2) | | 3650.81(12) | |
| Z | 3 | | 3 | |
| pcalcmg/mm³ | 1.319 | | 1.499 | |
| μ/mm⁻¹ | 1.412 | | 16.729 | |
| F(000) | 1386.0 | | 1620.0 | |
| Crystal size/mm³ | 0.267 × 0.18 × 0.142 | | 0.07 × 0.07 × 0.05 | |
| Radiation | Mo Kα (λ = | 0.71073) | Cu Kα (λ = | 1.54184) |
| 2Θ range for data | 6.02 to 59.246° | | 8.398 to 157.208° | |
| collection | | | | |
| Index ranges | −17 ≤ h ≤ 18, | | −17 ≤ h ≤ 17, | |
| | −18 ≤ k ≤ 18, | | −17 ≤ k ≤ 17, | |
| | −27 ≤ l ≤ 27 | | −27 ≤ l ≤ 24 | |
| Reflections collected | 27084 | | 26784 | |
| Independent | 1959[R(int) = | 0.0434] | 1750[R(int) = | 0.0194] |
| reflections | | | | |
| Data/restraints/ | 1959/0/69 | | 1750/0/69 | |
| parameters | | | | |
| Goodness-of-fit on F² | 1.077 | | 1.075 | |
| Final R indexes | R₁ = | 0.0477, | R₁ = | 0.0282, |
| [ I >= 2σ (I)] | wR₂ = | 0.1443 | wR₂ = | 0.0776 |
| Final R indexes | R₁ = | 0.0502, | R₁ = | 0.0297, |
| [all data] | wR₂ = | 0.1457 | wR₂ = | 0.0787 |

| | | |
|---|---|---|
| Largest diff. peak/ | 2.67/−0.43 | 0.68/−0.49 |
| hole/e Å⁻³ | | |

TABLE 7
Crystallographic tables for (18C6@Cs)2TeI6 single crystals

| Crystal | (18C6@Cs)₂TeI₆ | |
|---|---|---|
| ICSD Number | 2122192 | |
| Empirical formula | C₂₇Cs₂I₆NO₁₃Te | |
| Formula weight | 1701.10 | |
| Temperature/K. | 293(2) | |
| Crystal system | monoclinic | |
| Space group | P21/m | |
| a/Å | 9.8064(2) | |
| b/Å | 14.6116(4) | |
| c/Å | 17.8497(4) | |
| α/º | 90 | |
| β/° | 93.572(2) | |
| γ/º | 90 | |
| Volume/Å³ | 2552.66(10) | |
| Z | 2 | |
| pcalcmg/mm³ | 2.213 | |
| μ/mm⁻¹ | 5.661 | |
| F(000) | 1506.0 | |
| Crystal size/mm³ | 0.493 × 0.339 × 0.199 | |
| Radiation | Mo Kα (λ = | 0.71073) |
| 2Θ range for data | 6.374 to 58.762 | |
| collection | | |
| Index ranges | −12 ≤ h ≤ 13, | |
| | −19 ≤ k ≤ 18, | |
| | −22 ≤ l ≤ 24 | |
| Reflections collected | 37382 | |
| Independent reflections | 6491 [Rint = | 0.1203, |
| | Rsigma = | 0.0514] |
| Data/restraints/parameters | 6491/0/248 | |
| Goodness-of-fit on F² | 1.098 | |
| Final R indexes | R₁ = | 0.0661, |
| [ I >= 2σ (I)] | wR₂ = | 0.1956 |
| Final R indexes | R₁ = | 0.0726, |
| [all data] | wR₂ = | 0.2010 |

| | |
|---|---|
| Largest diff. peak/ | 1.48/−2.18 |
| hole/e Å⁻³ | |

TABLE 8
Crystallographic tables for (18C6@K)₂TeBr₆ synthesized with ACN or DMF

| Crystal | (18C6@K)₂TeBr₆-DMF | | (18C6@K)₂TeBr₆-ACN | |
|---|---|---|---|---|
| ICSD Number | 2122195 | | 2122193 | |
| Empirical formula | C₂₄H₄₈Br₆K₂O₁₂Te | | C₂₄H₄₈Br₆K₂O₁₂Te | |
| Formula weight | 1213.88 | | 1213.88 | |
| Temperature/K. | 293(2) | | 293(2) | |
| Crystal system | trigonal | | trigonal | |
| Space group | R-3 | | R-3 | |
| a/Å | 14.2030(6) | | 14.1660(6) | |
| b/Å | 14.2030(6) | | 14.1660(6) | |
| c/Å | 21.3516(10) | | 21.1805(11) | |
| α/º | 90 | | 90 | |
| β/° | 90 | | 90 | |
| γ/º | 120 | | 120 | |
| Volume/Å³ | 3730.1(4) | | 3681.0(4) | |
| Z | 3 | | 3 | |
| pcalcmg/mm³ | 1.621 | | 1.643 | |
| μ/mm⁻¹ | 5.626 | | 5.701 | |
| F(000) | 1764.0 | | 1764.0 | |
| Crystal size/mm³ | 0.283 × 0.235 × 0.159 | | 0.28 × 0.26 × 0.09 | |
| Radiation | Mo Kα (λ = | 0.71073) | Mo Kαa (λ = | 0.71073) |
| 2Θ range for data | 6.894 to 58.626° | | 7.678 to 59.044° | |
| collection | | | | |
| Index ranges | −17 ≤ h ≤ 19, | | −19 ≤ h ≤ 18, | |
| | −18 ≤ k ≤ 18, | | −19 ≤ k ≤ 16, | |
| | −26 ≤ l ≤ 27 | | −27 ≤ l ≤ 24 | |
| Reflections collected | 9333 | | 9351 | |
| Independent reflections | 2005[R(int) = | 0.0416] | 1950[R(int) = | 0.0243] |
| Data/restraints/parameters | 2005/0/69 | | 1950/0/70 | |
| Goodness-of-fit on F² | 1.045 | | 1.073 | |
| Final R indexes | R₁ = | 0.0260, | R₁ = | 0.0172, |
| [ I >= 2σ (I)] | wR₂ = | 0.0681 | wR₂ = | 0.0412 |
| Final R indexes | R₁ = | 0.0313, | R₁ = | 0.0210, |
| [all data] | wR₂ = | 0.0693 | wR₂ = | 0.0418 |

| | | |
|---|---|---|
| Largest diff. | 0.38/−0.57 | 0.22/−0.41 |
| peak/hole/e Å⁻³ | | |

TABLE 9
Crystallographic tables for (21C7@Cs)₂TeBr₆, and (21C7@Cs)₂TeI₆ single crystals

| Crystal | (21C7@Cs)₂TeBr₆ | | (21C7@Cs)₂TeI₆ | |
|---|---|---|---|---|
| ICSD Number | 2122191 | | 2122190 | |
| Empirical formula | C₃₁H₄₃Br₆Cs₂NO₁₅Te | | C₃₀H₃₅Cs₂I₆NO₁₅Te | |
| Formula weight | 1542.54 | | 1803.40 | |
| Temperature/K. | 293(2) | | 293(2) | |
| Crystal system | orthorhombic | | orthorhombic | |
| Space group | Cmc21 | | Cmc21 | |
| a/Å | 15.6291(6) | | 15.7635(11) | |
| b/Å | 12.0777(4) | | 12.3817(10) | |
| c/Å | 27.5528(18) | | 28.124(3) | |
| α/º | 90 | | 90 | |
| β/° | 90 | | 90 | |
| γ/º | 90 | | 90 | |
| Volume/Å³ | 5201.0(4) | | 5489.1(8) | |
| Z | 4 | | 4 | |
| pcalcmg/mm³ | 1.970 | | 2.182 | |
| μ/mm⁻¹ | 21.138 | | 5.274 | |
| F(000) | 2912.0 | | 3284.0 | |
| Crystal size/mm³ | 0.091 × 0.051 × 0.05 | | 0.157 x 0.103 × 0.045 | |
| Radiation | Cu Kα (λ = | 1.54184) | Mo Kα (λ = | 0.71073) |
| 2Θ range for data | 9.796 to 158.18 | | 5.926 to 52.74 | |
| collection | | | | |
| Index ranges | −19 ≤ h ≤ 19, | | −19 ≤ h ≤ 17, | |
| | −11 ≤ k ≤ 15, | | −14 ≤ k ≤ 15, | |
| | −34 ≤ l ≤ 34 | | −35 ≤ l ≤ 35 | |
| Reflections collected | 53691 | | 19078 | |
| Independent | 5669 [Rint = | 0.1006, | 5213 [Rint = | 0.0863, |
| reflections | Rsigma = | 0.0378] | Rsigma = | 0.0757] |
| Data/restraints/ | 5669/1/220 | | 5213/1/169 | |
| parameters | | | | |
| Goodness-of-fit on F² | 1.048 | | 1.016 | |
| Final R indexes | R₁ = | 0.0497, | R₁ = | 0.0505, |
| [ I >= 2σ (I)] | wR₂ = | 0.1233 | wR₂ = | 0.0955 |
| Final R indexes | R₁ = | 0.0668, | R₁ = | 0.0873, |
| [all data] | wR₂ = | 0.1320 | wR₂ = | 0.1060 |

| | | |
|---|---|---|
| Largest diff. | 0.56/−0.81 | 0.63/−0.83 |
| peak/hole/e Å⁻³ | | |

TABLE 10
Crystallographic tables for (18C6@K)₂HfBr₆ and (18C6@K)₂ZrBr₆

| Crystal | (18C6@K)₂HfBr₆ | | (18C6@K)₂ZrBr₆ | |
|---|---|---|---|---|
| ICSD Number | 2225998 | | 2225999 | |
| Empirical formula | C₂₄H₄₈Br₆K₂O₁₂Hf | | C₂₄H₄₈Br₆K₂O₁₂Zr | |
| Formula weight | 1264.77 | | 1177.50 | |
| Temperature/K. | 293(2) | | 293(2) | |
| Crystal system | trigonal | | trigonal | |
| Space group | R-3 | | R-3 | |
| a/Å | 14.13320(10) | | 14.13940(10) | |
| b/Å | 14.13320(10) | | 14.13940(10) | |
| c/Å | 21.0819(2) | | 21.0727(2) | |
| α/º | 90 | | 90 | |
| β/° | 90 | | 90 | |
| γ/º | 120 | | 120 | |
| Volume/Å³ | 3635.98(6) | | 3648.49(6) | |
| Z | 3 | | 3 | |
| pcalcmg/mm³ | 1.733 | | 1.608 | |
| μ/mm⁻¹ | 11.670 | | 9.517 | |
| F(000) | 1824.0 | | 1728.0 | |
| Crystal size/mm³ | 0.15 × 0.12 × 0.108 | | 0.09 × 0.07 × 0.06 | |
| Radiation | Cu Kα (λ = | 1.54184 Å) | Cu Kα (λ = | 1.54184 A) |
| 2Θ range for data | 12.526 to 157.206° | | 8.325 to 157.42° | |
| collection | | | | |
| Index ranges | −17 ≤ h ≤ 17, | | −17 ≤ h ≤ 17, | |
| | −17 ≤ k ≤ 17, | | −17 ≤ k ≤ 17, | |
| | −24 ≤ l ≤ 26 | | −25 ≤ l ≤ 26 | |
| Reflections | 26285 | | 26501 | |
| collected | | | | |
| Independent | 1737[R(int) = | 0.0268] | 1753[R(int) = | 0.0387] |
| reflections | | | | |
| Data/restraints/ | 1737/0/70 | | 1753/0/70 | |
| parameters | | | | |
| Goodness-of-fit | 1.103 | | 1.106 | |
| on F² | | | | |
| Final R indexes | R₁ = | 0.0171, | R₁ = | 0.0183, |
| [ I >= 2σ (I)] | wR₂ = | 0.0496 | wR₂ = | 0.0500 |
| Final R indexes | R₁ = | 0.0171 | R₁ = | 0.0183, |
| [all data] | wR₂ = | 0.0496 | wR₂ = | 0.0503 |

| | | |
|---|---|---|
| Largest diff. | 0.34/−0.43 | 0.48/−0.26 |
| peak/hole/e Å⁻³ | | |

TABLE 11
A summary of the PLQY determination results of two different batches
and three measurements per batch of the (18C6@K)₂HfBr₆ powders

| | Measurement 1 | Measurement 2 | Measurement 3 | Average |
|---|---|---|---|---|
| Batch 1 | 97.31% | 97.57% | 100.67% | 98.52% |
| Batch 2 | 93.46% | 94.89% | 93.38% | 93.91% |

TABLE 12
Crystallographic tables for (18C6@K)₂ZrCl₄Br₂

| Crystal | (18C6@K)₂ZrCl₄Br₂ | |
|---|---|---|
| ICSD Number | 2292758 | |
| Empirical formula | C₂₄H₄₈Cl_{4.3}Br_{1.7}K₂O₁₂Zr | |
| Formula weight | 986.47 | |
| Temperature/K. | 293(2) | |
| Crystal system | trigonal | |
| Space group | R-3 | |
| a/Å | 14.0091(6) | |
| b/Å | 14.0091(6) | |
| c/Å | 20.6138(11) | |
| α/º | 90 | |
| β/° | 90 | |
| γ/º | 120 | |
| Volume/Å³ | 3503.6(4) | |
| Z | 3 | |
| pcalcmg/mm³ | 1.403 | |
| μ/mm⁻¹ | 2.159 | |
| F(000) | 1496.0 | |
| Crystal size/mm³ | 0.08 × 0.06 × 0.04 | |
| Radiation | Mo Kα (λ = | 0.71073 Å) |
| 2Θ range for data | 7.002 to 59.562° | |
| collection | | |
| Index ranges | −17 ≤ h ≤ 18, | |
| | −18 ≤ k ≤ 17, | |
| | −27 ≤ l ≤ 22 | |
| Reflections collected | 9250 | |
| Independent reflections | 1973[R(int) = 0.0168] | |
| Data/restraints/parameters | 1973/0/70 | |
| Goodness-of-fit on F² | 1.086 | |
| Final R indexes | R₁ = | 0.0302, |
| [ I >= 2σ (I)] | wR₂ = | 0.1163 |
| Final R indexes | R₁ = | 0.0334, |
| [all data] | wR₂ = | 0.1180 |

| | |
|---|---|
| Largest diff. | 1.71/−0.39 |
| peak/hole/e Å⁻³ | |

TABLE 13
A summary of the PLQY determination results of two different batches
and three measurements per batch of the (18C6@K)₂ZrCLBr₂ powders

| | Measurement 1 | Measurement 2 | Average |
|---|---|---|---|
| Batch 1 | 80.29% | 82.76% | 81.53% |
| Batch 2 | 84.92% | 82.77% | 83.85% |

TABLE 14
IC-AES concentrations of Hf and Zr in HfBr4
precursor and (18C6@K)zHfBr₆ single crystals

| | ICP-AES Concentration (ppm) | | |
|---|---|---|---|
| Sample | | | Atomic Percent |
| Composition | Hf | Zr | of Zr |
| HfBr4 | 92.89 ± 3.36 | 0.226 ± 0.016 | 0.474% |
| (18C6@K)₂HfBr₆ | 124.9 ± 4.69 | 0.405 ± 0.008 | 0.630% |

TABLE 15
FWHM of the PL spectra of (18C6@K)₂HfBr₆
powders from 4 K. to 293 K.

| Temperature (K.) | FWHM (meV) |
|---|---|
| 4 | 482.4 |
| 6 | 481.8 |
| 8 | 482.2 |
| 10 | 494.2 |
| 12 | 496.9 |
| 15 | 485.9 |
| 20 | 476.2 |
| 25 | 480.5 |
| 30 | 474.9 |
| 35 | 484.3 |
| 40 | 488.9 |
| 45 | 490.2 |
| 50 | 483.0 |
| 60 | 492.0 |
| 70 | 499.5 |
| 80 | 513.5 |
| 90 | 526.0 |
| 100 | 538.3 |
| 110 | 554.6 |
| 120 | 560.1 |
| 130 | 571.4 |
| 140 | 580.7 |
| 150 | 588.8 |
| 170 | 602.7 |
| 190 | 623.1 |
| 210 | 630.7 |
| 230 | 632.3 |
| 250 | 643.9 |
| 270 | 654.9 |
| 293 | 666.6 |

TABLE 16
Parameters of the single-exponential decay fit of the
PL decay of a (18C6@K)₂ZrBr₆ single crystal

| Model | ExpDec1 |
|---|---|
| Equation | y = A₁ × e^{(-x/t1)} + y₀ |
| Plot | (18C6@K)2ZrBr6 |
| y₀ | 4.49168 × 10⁻⁵ ± 2.15919 ×10⁻⁵ |
| A₁ | 0.0313 ± 6.16847 × 10⁻⁵ |
| t₁ | 6.79835 ± 0.0262 |
| Reduced Chi-Sqr | 6.36744 × 10⁻⁷ |
| R-Square (COD) | 0.98853 |
| Adj. R-Square | 0.98853 |

TABLE 17
Parameters of the single-exponential decay fit of the
PL decay of a (18C6@K)₂ZrCl₄Br₂ le crystal

| Model | ExpDec1 |
|---|---|
| Equation | y = A₁ × e^{(-x/t1)} + y₀ |
| Plot | (18C6@K)₂ZrCl₄Br₂ |
| y₀ | −0.00492 ± 5.2498 × 10⁻⁵ |
| A₁ | 0.05606 ± 6.35752 × 10⁻⁵ |
| t₁ | 12.08304 ± 0.04017 |
| Reduced Chi-Sqr | 1.0178 × 10⁻⁶ |
| R-Square (COD) | 0.99496 |
| Adj. R-Square | 0.99495 |

TABLE 18
List of examples of (crown ether@A)₂M(IV)X₆

| | | crown ether@A | | | | | |
|---|---|---|---|---|---|---|---|
| | | 18C6Cs | 18C6Rb | 18C6K | 21C7Cs | 21C7Rb | 21C7K |
| M(IV)X₆ | TeCl₆ | (18C6Cs)₂ | (18C6Rb)₂ | (18C6K)₂ | (21C7Cs)₂ | (21C7Rb)₂ | (21C7K)₂ |
| | | TeCl₆ | TeCl₆ | TeCl₆ | TeCl₆ | TeCl₆ | TeCl₆ |
| | TeBr₆ | (18C6Cs)₂ | (18C6Rb)₂ | (18C6K)₂ | (21C7Cs)₂ | (21C7Rb)₂ | (21C7K)₂ |
| | | TeBr₆ | TeBr₆ | TeBr₆ | TeBr₆ | TeBr₆ | TeBr₆ |
| | TeI₆ | (18C6Cs)₂ | (18C6Rb)₂ | (18C6K)₂ | (21C7Cs)₂ | (21C7Rb)₂ | (21C7K)₂ |
| | | TeI₆ | TeI₆ | TeI₆ | TeI₆ | TeI₆ | TeI₆ |
| | SnCl₆ | (18C6Cs)₂ | (18C6Rb)₂ | (18C6K)₂ | (21C7Cs)₂ | (21C7Rb)₂ | (21C7K)₂ |
| | | SnCl₆ | SnCl₆ | SnCl₆ | SnCl₆ | SnCl₆ | SnCl₆ |
| | SnBr₆ | (18C6Cs)₂ | (18C6Rb)₂ | (18C6K)₂ | (21C7Cs)₂ | (21C7Rb)₂ | (21C7K)₂ |
| | | SnBr₆ | SnBr₆ | SnBr₆ | SnBr₆ | SnBr₆ | SnBr₆ |
| | SnI₆ | (18C6Cs)₂ | (18C6Rb)₂ | (18C6K)₂ | (21C7Cs)₂ | (21C7Rb)₂ | (21C7K)₂ |
| | | SnI₆ | SnI₆ | SnI₆ | SnI₆ | SnI₆ | SnI₆ |
| | PtCl₆ | (18C6Cs)₂ | (18C6Rb)₂ | (18C6K)₂ | (21C7Cs)₂ | (21C7Rb)₂ | (21C7K)₂ |
| | | PtCl₆ | PtCl₆ | PtCl₆ | PtCl₆ | PtCl₆ | PtCl₆ |
| | PtBr₆ | (18C6Cs)₂ | (18C6Rb)₂ | (18C6K)₂ | (21C7Cs)₂ | (21C7Rb)₂ | (21C7K)₂ |
| | | PtBr₆ | PtBr₆ | PtBr₆ | PtBr₆ | PtBr₆ | PtBr₆ |
| | PtI₆ | (18C6Cs)₂ | (18C6Rb)₂ | (18C6K)₂ | (21C7Cs)₂ | (21C7Rb)₂ | (21C7K)₂ |
| | | PtI₆ | PtI₆ | PtI₆ | PtI₆ | PtI₆ | PtI₆ |
| | SeCl₆ | (18C6Cs)₂ | (18C6Rb)₂ | (18C6K)₂ | (21C7Cs)₂ | (21C7Rb)₂ | (21C7K)₂ |
| | | SeCl₆ | SeCl₆ | SeCl₆ | SeCl₆ | SeCl₆ | SeCl₆ |
| | SeBr₆ | (18C6Cs)₂ | (18C6Rb)₂ | (18C6K)₂ | (21C7Cs)₂ | (21C7Rb)₂ | (21C7K)₂ |
| | | SeBr₆ | SeBr₆ | SeBr₆ | SeBr₆ | SeBr₆ | SeBr₆ |
| | SeI₆ | (18C6Cs)₂ | (18C6Rb)₂ | (18C6K)₂ | (21C7Cs)₂ | (21C7Rb)₂ | (21C7K)₂ |
| | | SeI₆ | SeI₆ | SeI₆ | SeI₆ | SeI₆ | SeI₆ |
| | IrCl₆ | (18C6Cs)₂ | (18C6Rb)₂ | (18C6K)₂ | (21C7Cs)₂ | (21C7Rb)₂ | (21C7K)₂ |
| | | IrCl₆ | IrCl₆ | IrCl₆ | IrCl₆ | IrCl₆ | IrCl₆ |
| | IrBr₆ | (18C6Cs)₂ | (18C6Rb)₂ | (18C6K)₂ | (21C7Cs)₂ | (21C7Rb)₂ | (21C7K)₂ |
| | | IrBr₆ | IrBr₆ | IrBr₆ | IrBr₆ | IrBr₆ | IrBr₆ |
| | IrI₆ | (18C6Cs)₂ | (18C6Rb)₂ | (18C6K)₂ | (21C7Cs)₂ | (21C7Rb)₂ | (21C7K)₂ |
| | | IrI₆ | IrI₆ | IrI₆ | IrI₆ | IrI₆ | IrI₆ |
| | ZrCl₆ | (18C6Cs)₂ | (18C6Rb)₂ | (18C6K)₂ | (21C7Cs)₂ | (21C7Rb)₂ | (21C7K)₂ |
| | | ZrCl₆ | ZrCl₆ | ZrCl₆ | ZrCl₆ | ZrCl₆ | ZrCl₆ |
| | ZrBr₆ | (18C6Cs)₂ | (18C6Rb)₂ | (18C6K)₂ | (21C7Cs)₂ | (21C7Rb)₂ | (21C7K)₂ |
| | | ZrBr₆ | ZrBr₆ | ZrBr₆ | ZrBr₆ | ZrBr₆ | ZrBr₆ |
| | ZrI₆ | (18C6Cs)₂ | (18C6Rb)₂ | (18C6K)₂ | (21C7Cs)₂ | (21C7Rb)₂ | (21C7K)₂ |
| | | ZrI₆ | ZrI₆ | ZrI₆ | ZrI₆ | ZrI₆ | ZrI₆ |
| | HfCl₆ | (18C6Cs)₂ | (18C6Rb)₂ | (18C6K)₂ | (21C7Cs)₂ | (21C7Rb)₂ | (21C7K)₂ |
| | | HfCl₆ | HfCl₆ | HfCl₆ | HfCl₆ | HfCl₆ | HfCl₆ |
| | HfBr₆ | (18C6Cs)₂ | (18C6Rb)₂ | (18C6K)₂ | (21C7Cs)₂ | (21C7Rb)₂ | (21C7K)₂ |
| | | HfBr₆ | HfBr₆ | HfBr₆ | HfBr₆ | HfBr₆ | HfBr₆ |
| | HfI₆ | (18C6Cs)₂ | (18C6Rb)₂ | (18C6K)₂ | (21C7Cs)₂ | (21C7Rb)₂ | (21C7K)₂ |
| | | HfI₆ | HfI₆ | HfI₆ | HfI₆ | HfI₆ | HfI₆ |
| | CeCl₆ | (18C6Cs)₂ | (18C6Rb)₂ | (18C6K)₂ | (21C7Cs)₂ | (21C7Rb)₂ | (21C7K)₂ |
| | | CeCl₆ | CeCl₆ | CeCl₆ | CeCl₆ | CeCl₆ | CeCl₆ |
| | CeBr₆ | (18C6Cs)₂ | (18C6Rb)₂ | (18C6K)₂ | (21C7Cs)₂ | (21C7Rb)₂ | (21C7K)₂ |
| | | CeBr₆ | CeBr₆ | CeBr₆ | CeBr₆ | CeBr₆ | CeBr₆ |
| | CeI₆ | (18C6Cs)₂ | (18C6Rb)₂ | (18C6K)₂ | (21C7Cs)₂ | (21C7Rb)₂ | (21C7K)₂ |
| | | CeI₆ | CeI₆ | CeI₆ | CeI₆ | CeI₆ | CeI₆ |
| | Cl₅Br | (18C6Cs)₂ | (18C6Rb)₂ | (18C6K)₂ | (21C7Cs)₂ | (21C7Rb)₂ | (21C7K)₂ |
| | | Cl₅Br | Cl₅Br | Cl₅Br | Cl₅Br | Cl₅Br | Cl₅Br |
| | Cl₄Br₂ | (18C6Cs)₂ | (18C6Rb)₂ | (18C6K)₂ | (21C7Cs)₂ | (21C7Rb)₂ | (21C7K)₂ |
| | | Cl₄Br₂ | Cl₄Br₂ | Cl₄Br₂ | Cl₄Br₂ | Cl₄Br₂ | Cl₄Br₂ |
| | Cl₃Br₃ | (18C6Cs)₂ | (18C6Rb)₂ | (18C6K)₂ | (21C7Cs)₂ | (21C7Rb)₂ | (21C7K)₂ |
| | | Cl₃Br₃ | Cl₃Br₃ | Cl₃Br₃ | Cl₃Br₃ | Cl₃Br₃ | Cl₃Br₃ |
| | Cl₂Br₄ | (18C6Cs)₂ | (18C6Rb)₂ | (18C6K)₂ | (21C7Cs)₂ | (21C7Rb)₂ | (21C7K)₂ |
| | | Cl₂Br₄ | Cl₂Br₄ | Cl₂Br₄ | Cl₂Br₄ | Cl₂Br₄ | Cl₂Br₄ |
| | ClBr₅ | (18C6Cs)₂ | (18C6Rb)₂ | (18C6K)₂ | (21C7Cs)₂ | (21C7Rb)₂ | (21C7K)₂ |
| | | ClBr₅ | ClBr₅ | ClBr₅ | ClBr₅ | ClBr₅ | ClBr₅ |
| | Cl₅I | (18C6Cs)₂ | (18C6Rb)₂ | (18C6K)₂ | (21C7Cs)₂ | (21C7Rb)₂ | (21C7K)₂ |
| | | Cl₅I | Cl₅I | Cl₅I | Cl₅I | Cl₅I | Cl₅I |
| | Cl₄I₂ | (18C6Cs)₂ | (18C6Rb)₂ | (18C6K)₂ | (21C7Cs)₂ | (21C7Rb)₂ | (21C7K)₂ |
| | | Cl₄I₂ | Cl₄I₂ | Cl₄I₂ | Cl₄I₂ | Cl₄I₂ | Cl₄I₂ |
| | Cl₃I₃ | (18C6Cs)₂ | (18C6Rb)₂ | (18C6K)₂ | (21C7Cs)₂ | (21C7Rb)₂ | (21C7K)₂ |
| | | Cl₃I₃ | Cl₃I₃ | Cl₃I₃ | Cl₃I₃ | Cl₃I₃ | Cl₃I₃ |
| | Cl₂I₄ | (18C6Cs)₂ | (18C6Rb)₂ | (18C6K)₂ | (21C7Cs)₂ | (21C7Rb)₂ | (21C7K)₂ |
| | | Cl₂I₄ | Cl₂I₄ | Cl₂I₄ | Cl₂I₄ | Cl₂I₄ | Cl₂I₄ |
| | ClI₅ | (18C6Cs)₂ | (18C6Rb)₂ | (18C6K)₂ | (21C7Cs)₂ | (21C7Rb)₂ | (21C7K)₂ |
| | | ClI₅ | ClI₅ | ClI₅ | ClI₅ | ClI₅ | ClI₅ |
| | Br₅I | (18C6Cs)₂ | (18C6Rb)₂ | (18C6K)₂ | (21C7Cs)₂ | (21C7Rb)₂ | (21C7K)₂ |
| | | Br₅I | Br₅I | Br₅I | Br₅I | Br₅I | Br₅I |
| | Br₄I₂ | (18C6Cs)₂ | (18C6Rb)₂ | (18C6K)₂ | (21C7Cs)₂ | (21C7Rb)₂ | (21C7K)₂ |
| | | Br₄I₂ | Br₄I₂ | Br₄I₂ | Br₄I₂ | Br₄I₂ | Br₄I₂ |
| | Br₃I₃ | (18C6Cs)₂ | (18C6Rb)₂ | (18C6K)₂ | (21C7Cs)₂ | (21C7Rb)₂ | (21C7K)₂ |
| | | Br₃I₃ | Br₃I₃ | Br₃I₃ | Br₃I₃ | Br₃I₃ | Br₃I₃ |
| | Br₂I₄ | (18C6Cs)₂ | (18C6Rb)₂ | (18C6K)₂ | (21C7Cs)₂ | (21C7Rb)₂ | (21C7K)₂ |
| | | Br₂I₄ | Br₂I₄ | Br₂I₄ | Br₂I₄ | Br₂I₄ | Br₂I₄ |
| | BrI₅ | (18C6Cs)₂ | (18C6Rb)₂ | (18C6K)₂ | (21C7Cs)₂ | (21C7Rb)₂ | (21C7K)₂ |
| | | BrI₅ | BrI₅ | BrI₅ | BrI₅ | BrI₅ | BrI₅ |
| | Cl₄BrI | (18C6Cs)₂ | (18C6Rb)₂ | (18C6K)₂ | (21C7Cs)₂ | (21C7Rb)₂ | (21C7K)₂ |
| | | Cl₄BrI | Cl₄BrI | Cl₄BrI | Cl₄BrI | Cl₄BrI | Cl₄BrI |
| | Cl₃Br₂I | (18C6Cs)₂ | (18C6Rb)₂ | (18C6K)₂ | (21C7Cs)₂ | (21C7Rb)₂ | (21C7K)₂ |
| | | Cl₃Br₂I | Cl₃Br₂I | Cl₃Br₂I | Cl₃Br₂I | Cl₃Br₂I | Cl₃Br₂I |
| | Cl₃BrI₂ | (18C6Cs)₂ | (18C6Rb)₂ | (18C6K)₂ | (21C7Cs)₂ | (21C7Rb)₂ | (21C7K)₂ |
| | | Cl₃BrI₂ | Cl₃BrI₂ | Cl₃BrI₂ | Cl₃BrI₂ | Cl₃BrI₂ | Cl₃BrI₂ |
| | Cl₂Br₃I | (18C6Cs)₂ | (18C6Rb)₂ | (18C6K)₂ | (21C7Cs)₂ | (21C7Rb)₂ | (21C7K)₂ |
| | | Cl₂Br₃I | Cl₂Br₃I | Cl₂Br₃I | Cl₂Br₃I | Cl₂Br₃I | Cl₂Br₃I |
| | Cl₂Br₂I₂ | (18C6Cs)₂ | (18C6Rb)₂ | (18C6K)₂ | (21C7Cs)₂ | (21C7Rb)₂ | (21C7K)₂ |
| | | Cl₂Br₂I₂ | Cl₂Br₂I₂ | Cl₂Br₂I₂ | Cl₂Br₂I₂ | Cl₂Br₂I₂ | Cl₂Br₂I₂ |
| | Cl₂BrI₃ | (18C6Cs)₂ | (18C6Rb)₂ | (18C6K)₂ | (21C7Cs)₂ | (21C7Rb)₂ | (21C7K)₂ |
| | | Cl₂BrI₃ | Cl₂BrI₃ | Cl₂BrI₃ | Cl₂BrI₃ | Cl₂BrI₃ | Cl₂BrI₃ |
| | ClBr₄I | (18C6Cs)₂ | (18C6Rb)₂ | (18C6K)₂ | (21C7Cs)₂ | (21C7Rb)₂ | (21C7K)₂ |
| | | ClBr₄I | ClBr₄I | ClBr₄I | ClBr₄I | ClBr₄I | ClBr₄I |
| | ClBr₃I₂ | (18C6Cs)₂ | (18C6Rb)₂ | (18C6K)₂ | (21C7Cs)₂ | (21C7Rb)₂ | (21C7K)₂ |
| | | ClBr₃I₂ | ClBr₃I₂ | ClBr₃I₂ | ClBr₃I₂ | ClBr₃I₂ | ClBr₃I₂ |
| | ClBr₂I₃ | (18C6Cs)₂ | (18C6Rb)₂ | (18C6K)₂ | (21C7Cs)₂ | (21C7Rb)₂ | (21C7K)₂ |
| | | ClBr₂I₃ | ClBr₂I₃ | ClBr₂I₃ | ClBr₂I₃ | ClBr₂I₃ | ClBr₂I₃ |
| | ClBrI₄ | (18C6Cs)₂ | (18C6Rb)₂ | (18C6K)₂ | (21C7Cs)₂ | (21C7Rb)₂ | (21C7K)₂ |
| | | ClBrI₄ | ClBrI₄ | ClBrI₄ | ClBrI₄ | ClBrI₄ | ClBrI₄ |

(ii) Halide Perovskite Compound (Crown Ether@A)M(II)X₄ or (Crown Ether@A)M(III)X₅

A halide perovskite compound according to the formula: (crown ether@A)M(II)X₄ has the M, at least one divalent metal cation; the X, at least one halide anion; and the crown ether@A, at least one alkali metal-bound crown ether formed between an alkali metal cation A and oxygen atoms of a crown ether, e.g., by electrostatic interaction. The (crown ether@A)M(II)X₄ can form a tetrahedral unit. A halide perovskite compound according to the formula: (crown ether@A)M(III)X₅ has the M, at least one divalent metal cation; the X, at least one halide anion; and the crown ether@A, at least one alkali metal-bound crown ether formed between an alkali metal cation A and oxygen atoms of a crown ether, e.g., by electrostatic interaction. The (crown ether@A)M(III)X₅ can form an octahedral unit.

The halide perovskite compound provided herein can be tunable by adjusting components, i.e., crown ether, A, M(II), M(III), and X. For example, the M(II) can be one or more of Mn²⁺ and Ni²⁺; the M(III) can be Sb3+; the X can be one or more of Cl− and Br−; the crown ether can be 18-Crown-6 (18C6); and/or the A can be Ba2⁺. For example, X4 can be any combination of Cl− and Br−, such as Cl4, Cl3Br, Cl2Br2, ClBr3, and Br4. For example, X₅ can be any combination of Cl⁻ and Br⁻, such as Cl₅, Cl₄Br, Cl₃Br₂, Cl₂Br₃, ClBr₄, and Br₄. In specific embodiments, the halide perovskite compound is (18C6@Ba)MnBr₄ or (18C6@Ba)SbCl₅.

The metal halide [M(II)X₄]²⁻ or [M(III)X₅]²⁻ can form a 1D linear chain structure with the crown ether@A²⁺. The halide perovskite compound can comprise a structural unit formed by one crown ether@A²⁺ and one [M(II)X₄]²⁻, a linear chain structure comprising a plurality of the structural unit, and/or a hexagonal crystal structure comprising the plurality of the structural unit. For example, in the crystal structure, the [M(II)X₄]²⁻ complexes and the (crown ether@A)⁺ complexes can be alternatingly connected into a linear chain, and the chains then packed into a hexagonal crystal structure. One side of the A²⁺ atom can be coordinated with one X⁻ atom, and the other side can be coordinated with three A²⁺ atoms (FIGS. 74A-74D). This configuration enables the strong structural stability of the [M(II)X₄]²⁻ complexes, and can generate the near perfect tetrahedral shape of the [M(II)X₄]²⁻ complexes. This has great implications on the emission color of the [M(II)X₄]²⁻ complexes.

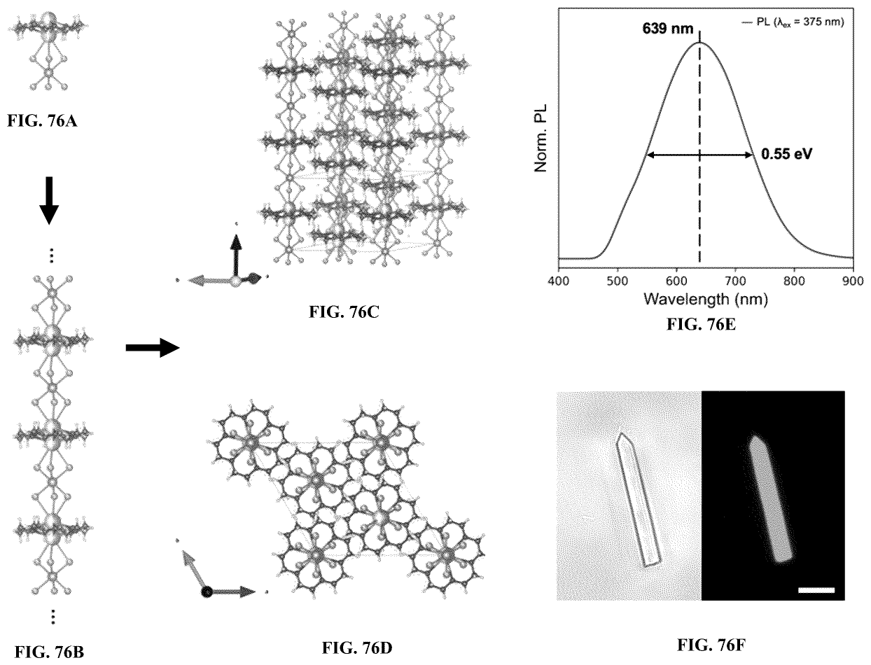

Similarly, the halide perovskite compound can comprise at least one of (i) a structural unit formed by one (crown ether@A)²⁺ and one [M(III)X₅]²⁻, (ii) a linear chain structure comprising a plurality of the structural unit, and (iii) a hexagonal or rhombohedral crystal structure comprising the plurality of the structural unit. For example, upon crystallization, [M(III)X₅]²⁻ complexes can be assembled into a linear chain structure facilitated by (crown ether@A)²⁺ (FIGS. 76A, 76B). The A²⁺ in the crown ether can be disordered. Half of the cation can be located above the crown ether, while the other half below the crown ether, and the crown ether can be the mirror plane for the two parts. The [M(III)X₅]²⁻ complexes can be also disordered, and the 5 X⁻ atoms can occupy 6 octahedral coordination sites of the M(III) atom, each with 5/6 possibility. The alternating linear chains can be then assembled into a rhombohedral crystal structure with R-3 space group. This high symmetry space group guarantees the linearity of the 1D chains (FIGS. 76C, 76D, Table 21).

The halide perovskite compound (crown ether@A)M(II)X₄ or (crown ether@A)M(III)X₅ can be in any form such as in powder, crystal, or solution. The halide perovskite compound (crown ether@A)M(II)X₄ or (crown ether@A)M(III)X₅ can have higher purity as compared to a control compound (e.g., AM(II)X₄ without the crown ether and comprising the same A, M(II), and X as the halide perovskite compound (crown ether@A)M(II)X₄), or AM(III)X₅ without the crown ether and comprising the same A, M(III), and X as the halide perovskite compound (crown ether@A)M(III)X₅). The purity of the halide perovskite compound (crown ether@A)M(II)X₄ can be about 80%, 81%, 82%, 83%, 84%, 85%, 96%, 87%, 88%, 89%, 90%, 91%, 92%, 93%, 94%, 95%, 96%, 97%, 98%, 99%, 99.5%, or greater.

The halide perovskite compound can comprise greater PLQY as compared to a control compound A₂M(II)X₄ or AM(III)X₅ without the crown ether and comprising the same A, M(II) or M(III), and X as the halide perovskite compound. For example, the PLQY of the halide perovskite compound can be about 80%, 81%, 82%, 83%, 84%, 85%, 96%, 87%, 88%, 89%, 90%, 91%, 92%, 93%, 94%, 95%, 96%, 97%, 98%, 99%, or greater. The PLQY can be measured at various excitation/emission wavelength, including under excitation by blue light (e.g., from about 425 nm to about 475 nm) (e.g., at 449 nm), measured at about 495-570 nm (e.g., 513 nm) (green light emission), For example, formula (18C6@Ba)MnBr₄ has the PLQY value of 82.1% and narrow emission peak (full width at half maximum (FWHM)=0.17 eV) under excitation at 449 nm and measured at 513 nm. Formula (18C6@Ba)SbCl₅ has a uniform orange emission under 375-nm excitation.

The halide perovskite compound provided herein can have increased air stability as compared to a control compound AM(II)X₄ or AM(III)X₅ without the crown ether and comprising the same A, M, and X as the halide perovskite compound. In some embodiments, the air stability of the halide perovskite compound is increased by about 1 hour to about 3 days as compared to the control compound.

Table 19 provides a non-exhaustive list of example compounds of the present disclosure.

TABLE 19
List of examples of (crown ether@A)M(II)X₄ or (crown
ether@A)M(III)X₅ thar forms a linear chain structure

| | | M | | |
|---|---|---|---|---|
| | | Mn²⁺ | Ni²⁺ | Sb³⁺ |
| X₄ | Cl₄ | (18C6Ba)MnCl₄ | (18C6Ba)NiCl₄ | |
| | Br₄ | (18C6Ba)MnBr₄ | (18C6Ba)NiBr₄ | |
| | Cl₃Br | (18C6Ba)MnCl₃Br | (18C6Ba)NiCl₃Br | |
| | Cl₂Br₂ | (18C6Ba)MnCl₂Br₂ | (18C6Ba)NiCl₂Br₂ | |
| | ClBr₃ | (18C6Ba)MnClBr3 | (18C6Ba)NiClBr₃ | |
| X₅ | Cl₅ | | | (18C6Ba)Cl₅ |
| | Br₅ | | | (18C6Ba)Br₅ |
| | Cl₄Br | | | (18C6Ba)Cl₄Br |
| | Cl₃Br₂ | | | (18C6Ba)Cl₃Br₂ |
| | Cl₂Br₃ | | | (18C6Ba)Cl₂Br₃ |
| | ClBr₄ | | | (18C6Ba)ClBr₄ |

### B. Generating Halide Perovskite Compound Using Supramolecule Assembly

Methods of generating a halide perovskite compound provided herein include dissolving (i) a metal halide and (ii) an alkali metal halide and a crown ether, or an alkali metal-bound crown ether, in an organic solvent to provide a precursor solution, to contact the metal halide with at least one of the alkali metal halide, the crown ether, and the alkali metal-bound crown ether in the precursor solution; and contacting the organic solvent with an anti-solvent, to crystalize the halide perovskite compound from the precursor solution. The organic solvent can include N, N-Dimethylformamide (DMF) or acetonitrile (ACN). The anti-solvent can include diethyl ether (DEE). The fabrication reaction, i.e., dissolving (i) the metal halide and (ii) the alkali metal and the crown ether, or the alkali metal-bound crown ether in the organic solvent can be conducted at about 60-100° C., such as at about 80° C.

For example, to generate (18C6@A)₂M(IV)X₆ (A=Cs⁺, Rb⁺, K⁺; M(IV)=Te⁴⁺, Sn⁴⁺, Se⁴⁺, Ir⁴⁺, Pt⁴⁺, Zr⁴⁺, Ce⁴⁺; X=Cl⁻, Br⁻, I⁻), Powders of A₂MX₆ and 18C6 are measured into a 20 ml vial based on the 1:2 stoichiometric ratio, and the precursors are dissolved in 10 ml ACN or DMF on a hot plate at 100° C. with vigorous stirring for three hours. The supersaturated solution is filtered into a new 20 ml vial. (18C6@A)₂M(IV)X₆ powders are obtained by adding 10 ml of the supersaturated solution into 20 ml of DEE anti-solvent. The mixtures are centrifuged at 4000 rpm for 5 minutes to separate the powders and the solution. The powders are dried in a vacuum oven at 50° C. overnight. (18C6@A)₂M(IV)X₆ single crystals are grown using an anti-solvent diffusion method. Briefly, 1 ml of the above mentioned supersaturated solution is added into a 4 ml vial, which is placed into a 20 ml vial with 4 ml of DEE. After approximately two days, single crystals are formed on the bottom and the wall of the 4 ml vial. Single crystals are washed 3 times with acetone and stored in an argon glovebox for future use.

For example, to generate (18C6@Ba)M(II)X₄ (M(II)=Mn²⁺, Ni²⁺; X=Cl⁻, Br⁻), a clear precursor solution can be obtained with ACN at 80° C. with the concentration of 10 mM for 18C6, BaX₂ and M(II)X₂. (18C6@Ba)M(II)X₄ powders and single crystals were grown using the similar diethyl ether-assisted anti-solvent crystallization method as described above.

For example, to generate (18C6@Ba)M(III)X₅ (M(III)=Sb³⁺; X=Cl⁻, Br⁻), ACN can be applied as the solvent to dissolve a stoichiometric ratio amount of 18C6, BaX₂, and M(III)X₃ precursors, and DEE can be used as the anti-solvent, using the similar methods as described above.

In some the halide perovskite compound generated according to the method provided herein is free of impurities. “Free of” impurities as used herein refers to the compound or composition containing no impurities, or insignificant or negligible amount of impurities. For example, a compound that is free of impurities can have purity of about 90%, 91%, 92%, 93%, 94%, 95%, 96%, 97%, 98%, 99%, 99.5%, 99.6%, 99.7%, 99.8%, 99.9%, or greater.

The methods provided herein can be more cost effective and facile as compared to other methods to synthesize or stabilize metal halide perovskite. In the methods provided herein, all the compositions can be fabricated using polar organic solvents at about 80° C. The methods provided herein are solution processable and easy to scale up. In contrast, in methods of generating vacancy-ordered perovskites (e.g., A₂M(IV)X₆, AM(II)X₄, AM(III)X₅) some double perovskites, such as Cs2ZrBr6 and Cs2HfBr6, require high temperature (e.g., about 800° C.) solid-state synthesis.

Further, the methods provided herein can achieve 100% pure solids, including both single crystals and powders. The purity of the synthetic product is much higher than the vacancy-ordered perovskites. For example, (18-Crown-6@K)₂ZrBr₆, (18-Crown-6@K)₂HfBr₆, and (18-Crown-6@Ba)MnBr₄ are pure according to powder XRD measurements, whereas the synthesis of Cs₂ZrBr₆, Cs₂HfBr₆, or BaMnBr₄ can result in non-negligible CsBr or BaBr₂ impurities.

The methods provided herein can provide improved stability of the metal halide perovskites. For example, Zr and Hf containing perovskites are susceptible to moisture, but when they are assembled by crown ethers, the air stability increased from one hour to a few days.

Also provided herein are halide perovskite compounds and compositions (e.g., color luminescent compositions, semiconductor compositions) comprising the halide perovskite compounds generated by the methods provided herein.

The metal halide perovskite compounds provided herein, e.g., according to the formula (crown ether@A)₂M(IV)X₆, (crown ether@A)M(II)X₄, or (crown ether@A)M(III)X₅ can be used for a wide range of industrial utility. For example, the metal halide perovskite compounds provided herein can be used for high PLQY and tunable color luminescent materials. Commercial electronic display companies can adopt the material provided herein to create efficient and bright electronic displays, such as television and computer displays. When integrated with a UV light source, the combined system can generate emission of the specific color that has high (e.g., near-unity) PLQY and/or narrow emission peak (i.e., narrow FWHM).

Further, when the high PLQY of the specific emission colors in the powders are preserved in thin films, it enables various optoelectronic device applications. Because the powders are stable in nonpolar organic solvents, they can be evenly dispersed into solution to form inks. The inks could be drop casted under ambient conditions, and, after rapid solvent evaporation, a uniform thin film forms. The emissive powders can also be processed with high-resolution 3D printing technologies after blending them uniformly into a monomer resin. A single 3D-printed structure can also manifest emissions in different colors by alternative resins during the printing procedure. The potential applications of 3D-printed light emitting structures are extensive and constantly evolving, ranging from intricate interior ambient-lighting solutions to seamless integration into wearable devices. Example 2 of the present disclosure provide example uses for the metal halide compounds provided herein.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

### EXAMPLES

### Example 1: Synthesis of (18C6@A)₂M(IV)X₆

### Structural Unit Formation in Solution

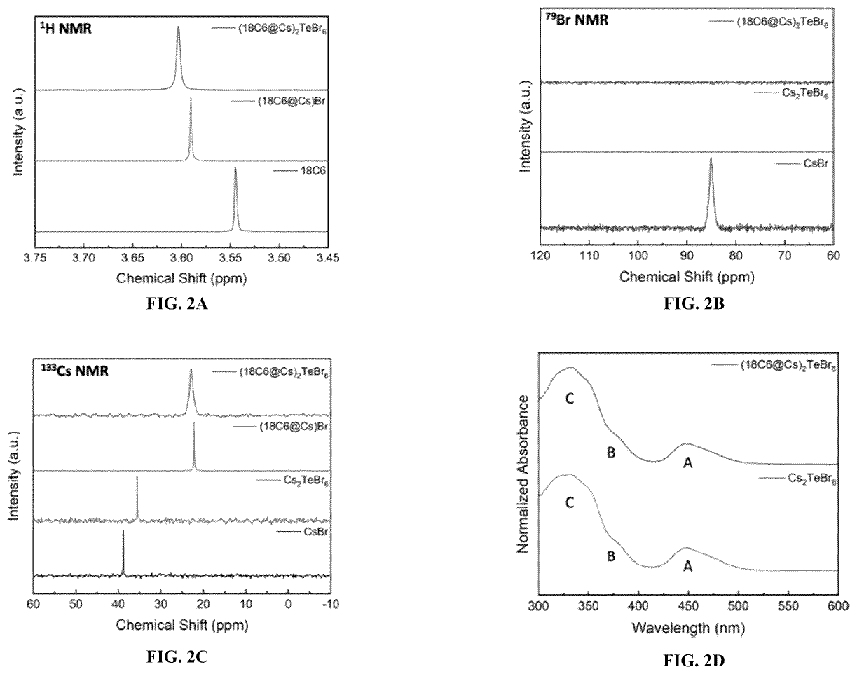

The charge-neutral (18C6@A)₂M(IV)X₆ dumbbell structural units are formed by dissolving 18C6 and A₂M(IV)X₆ in acetonitrile (ACN). This was verified using multiple solution-state characterization techniques, using (18C6@Cs)₂TeBr₆ as an illustrating example. The NMR-active ¹H, ⁷⁹Br, and ¹³³Cs nuclei in the dumbbell structural unit experience different magnetic fields compared to the isolated nuclei (FIG. 2A-2C). The 24 homotopic protons on the 18C6 ring have identical NMR absorptions, at around 3.54 ppm in terms of a chemical shift. Once Cs⁺ is crowned, due to the partial removal of proton-electron density by the cation, the protons will be deshielded, and the chemical shift will increase to 3.59 ppm (FIG. 2A), consistent with reports that (18C6@Cs)⁺ exists in ACN. However, with the addition of [TeBr₆]²⁻ ionic octahedra, the chemical shift is further increased to 3.61 ppm. This increase indicated further withdrawal of electron density from the protons in the presence of [TeBr₆]²⁻, which implied attachment to the (18C6@Cs)+ cations. ⁷⁹Br NMR revealed strong signals of free Br ions of CsBr in ACN, while the spin relaxation of ⁷⁹Br was quenched completely by Te⁴⁺ in Cs₂TeBr₆ (FIG. 2B) under the same measurement conditions most likely due to quadrupolar interaction. (18C6@Cs)₂TeBr₆ in ACN showed the same quenching behavior as the Cs₂TeBr₆; the absence of ⁷⁹Br NMR signals confirmed that Br was coordinated to Te⁴⁺.

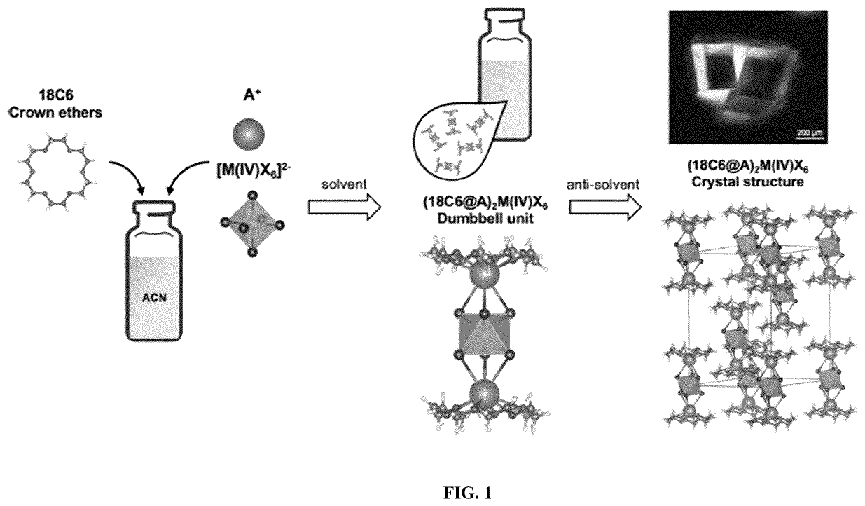

To provide evidence that the dumbbell structural unit exists in ACN, ¹³³Cs NMR (FIG. 2C) was also conducted since Cs is the bridging atom that directly coordinates with both, Br of [TeBr₆]²⁻ and O of 18C6. The free Cs chemical shift of CsBr was located at 38.81 ppm, while it was located at 35.56 ppm for Cs₂TeBr₆ in ACN. The 3.25 ppm difference in these controls indicated that the presence of Te⁴⁺ in the solution caused the peak to shift to lower ppm values. In contrast, a pronounced shielding effect was observed when Cs⁺ was crowned into (18C6@Cs)⁺ in ACN, which suggested a withdrawal of electron density from the crown ether to Cs⁺, consistent with the ¹H NMR results. Adding [TeBr₆]²⁻ into (18C6@Cs)⁺ in ACN changed the Cs chemical shift from 22.22 to 22.97 ppm, which supported the formation of a new species, the dumbbell structural unit, distinct from its individual components. The dramatically broadened signal also supported the formation of a dumbbell as dipole-dipole interactions are introduced in slowly tumbling large-molecular weight species. The UV-vis spectrum of (18C6@Cs)₂TeBr₆ precursors in ACN clearly shows the A, B, and C characteristic absorption bands of [TeBr₆]²⁻ (FIG. 2D), indicating the presence of [TeBr₆]²⁻ in solution. With the comprehensive measurements in ¹H, ⁷⁹Br, and ¹³³Cs NMR and UV-vis spectroscopy, the species were characterized in the solution phase, confirming the integrity of the dumbbell structural unit in solution (FIG. 1).

### Single-Crystal Characterization

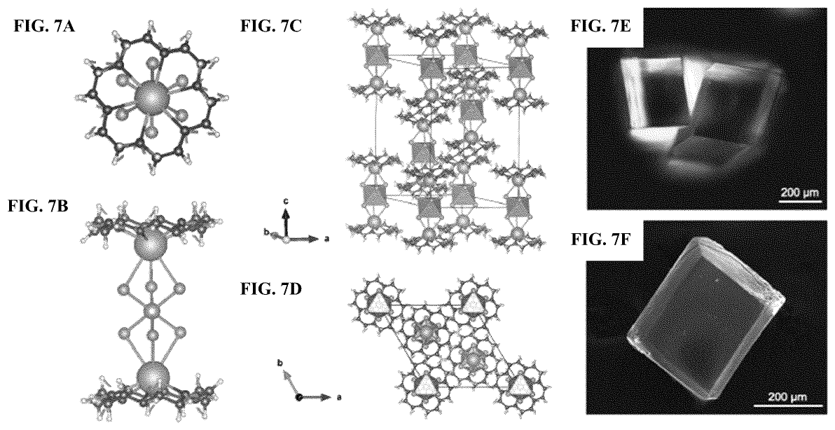

With the suspension of (18C6@A)₂M(IV)X₆ units in ACN solution, the solid-state assembly was achieved, in the form of single crystals, with the introduction of antisolvents like diethyl ether. For example, the (18C6@Cs)₂TeCl₆ single crystals have a parallelepiped shape, consistent with crystallographic symmetry, with a lateral dimension of approximately 300 μm (FIG. 7). The structural details of the crystals were determined from single-crystal X-ray diffraction (SCXRD). (18C6@Cs)₂TeCl₆ crystallized in the R-3 space group with lattice parameters of a=13.9378 Å and c=22.0396 Å (Table 1). The (18C6@Cs)₂TeCl₆ dumbbell structural unit belonged to the S₆ point group, where two Cs⁺ cations and the Te⁴⁺ cation sit on the S₆ axis, and the six-fold symmetry of the 18C6 and the S₆ axis of the Oₕ-symmetric [TeCl₆]²⁻ octahedron were perfectly aligned. In the (18C6@Cs)₂TeCl₆ dumbbell unit, the Te—Cl bond length was determined as 2.546 Å, which was comparable to that in the Cs₂TeCl₆ vacancy-ordered double perovskite (2.570 Å).⁹ The high symmetry of this dumbbell building block offered a unique rhombohedral packing of the octahedra at the macroscopic level. Each [TeCl₆]²⁻ octahedron occupied the b Wyckoff position of space group R-3 and was surrounded by six nearest octahedra at a Te—Te distance of 10.9 Å, which was different from the fee packing in Cs₂TeCl₆ with a Te—Te distance of 7.7 Å.⁹ The voids within the lattice are occupied by disordered solvent molecules. These tunable differences in the metal halide octahedron packing geometry may lead to differences in the overlap of molecular orbital wavefunctions, yielding unique electronic structures and optoelectronic properties that will be discussed later.

### Tunability of the Supramolecular Approach

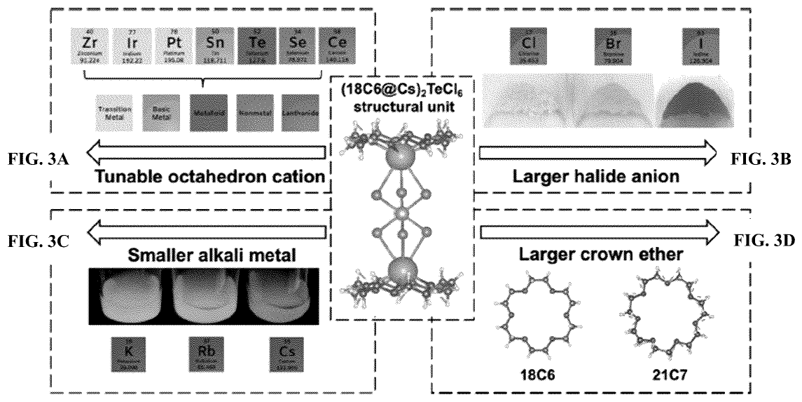

To demonstrate the general applicability of the approach provided herein, various crystals were produced through this supramolecular assembly strategy. In fact, the composition tunability of this new (18C6@A)₂M(IV)X₆ structure is as rich as the tunabilities on A, M, and X sites in A₂M(IV)X₆ double perovskites. There are four compositional components in the (18C6@Cs)₂TeCl₆ dumbbell structural unit which can be tuned by virtue of the precursors: (a) octahedron cations (M), (b) halide anions (X), (c) alkali metal cations (A), and (d) crown ethers (FIG. 3). Apart from [TeX₆]²⁻, various tetravalent center cation octahedra, such as [SnX₆]²⁻, [SeX₆]²⁻, [IrX₆]²⁻, [PtX₆]²⁻, [ZrX₆]²⁻, and [CeX₆]²⁻ can also be assembled into similar dumbbell structural units with S₆ symmetry. For typical 3D connected halide perovskites, such as low-T phase CsPbI₃,³⁶ due to the geometrical constraint imposed by the ionic framework sizes, such as the tolerance factor and proper bonding directions, a mismatched ionic size will lead to the breakdown or instability of the perovskite structure. In contrast, the isolated nature of the dumbbell structural units enables a more flexible control over the structure diversity without losing the prototypical crystal structure. Herein, a variety of unique dumbbell structures were achieved with the unique synthetic approach provided herein by simply changing the precursors. All structural details of the highly tunable (18C6@A)₂M(IV)X₆ dumbbell structural units were obtained by powder XRD (PXRD) and SCXRD (Tables 1-7).

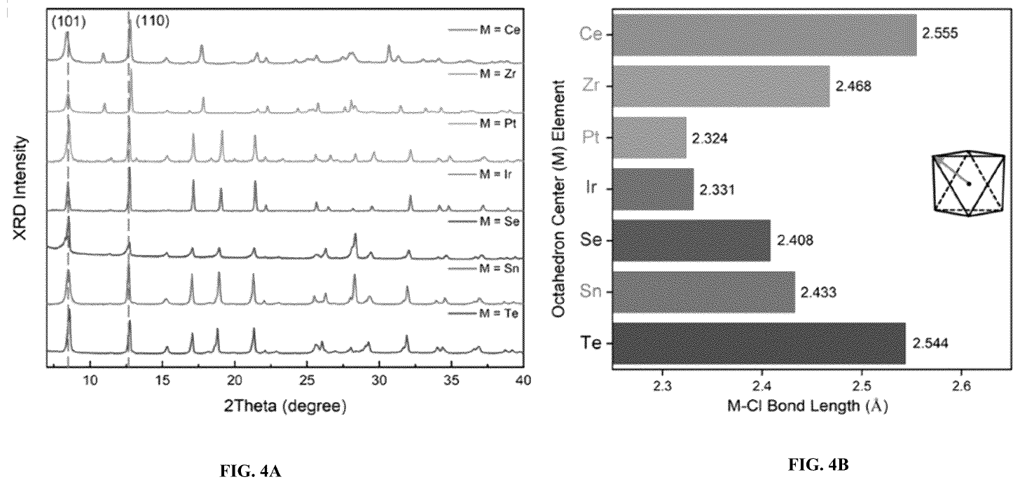

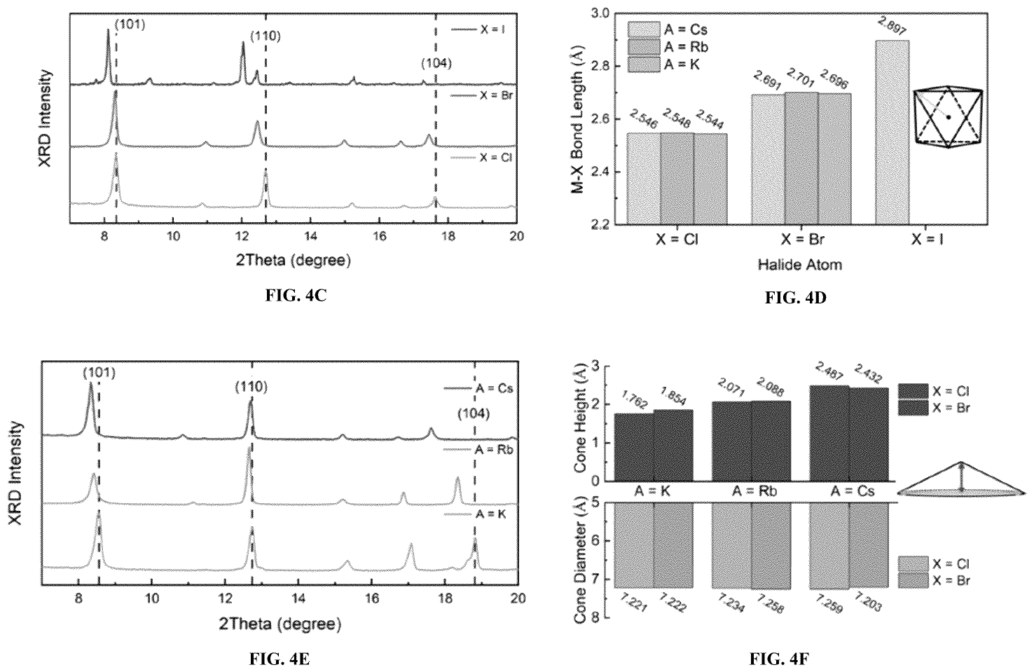

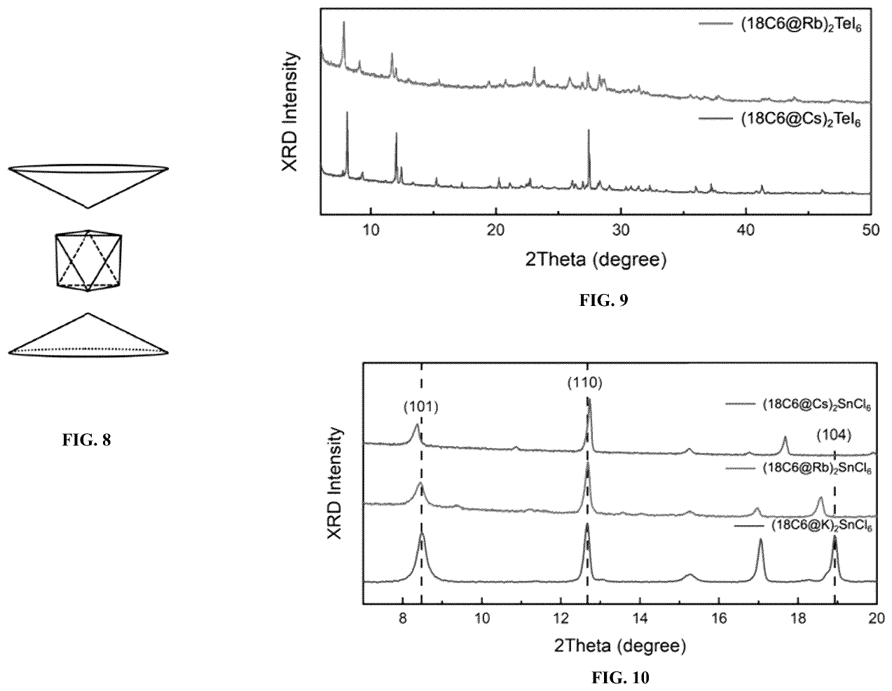

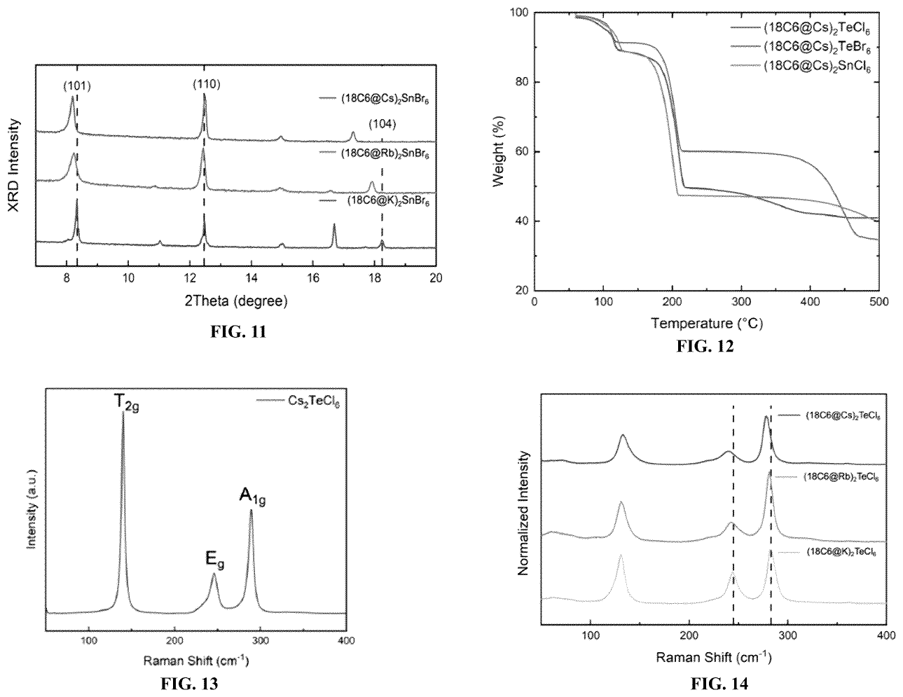

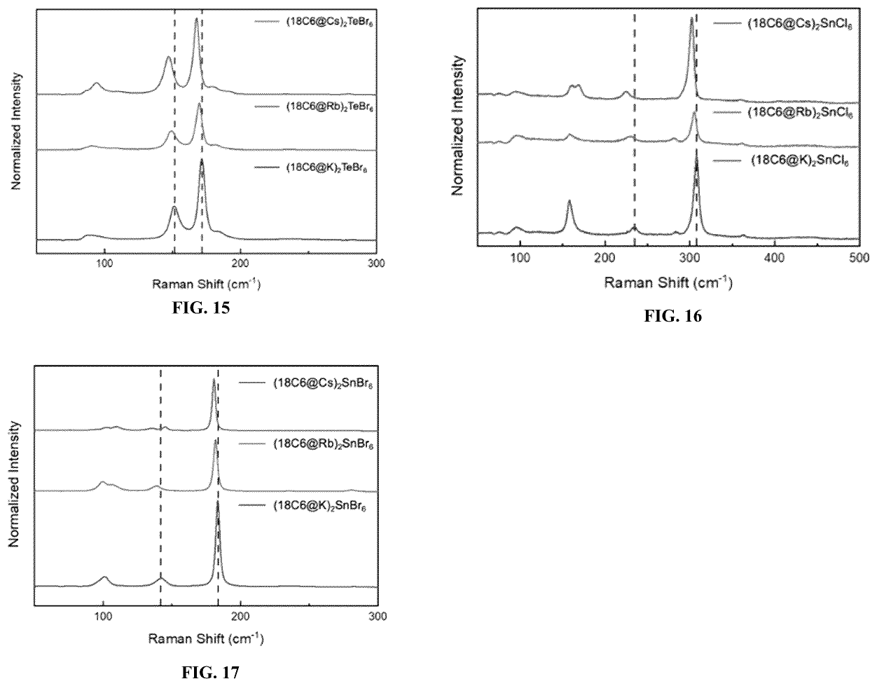

The comparison of PXRD patterns for the seven different octahedron center cations (Te⁴⁺, Sn⁴⁺, Se⁴⁺, Ir⁴⁺, Pt⁴⁺, Zr⁴⁺, and Ce⁴⁺) is shown in FIG. 4A. Despite size differences between the different metal halide octahedral units, represented by the M—Cl bond length (from 2.324 to 2.555 Å) summarized in FIG. 4B, they all had similar hexagonal PXRD patterns, with strong and distinct (101) and (110) diffraction peaks. In order to better evaluate the geometry of the dumbbell structural unit with various compositions, a simplified model made up of two cones and one octahedron was used (FIG. 8). A larger halide anion (from Cl⁻ to Br⁻ to I⁻) leads to a larger octahedron size (FIG. 4D), and the length of the dumbbell structural unit increases in all three dimensions, reflected by the shifting of all diffraction peaks to lower 2θ values (FIG. 4C). Although the bromide version remained in the R-3 space group (Table 2), the iodide version deviated from the hexagonal symmetry and crystallized in the monoclinic crystal system with the space group of P21/m (Table 7 and FIG. 9) due to the larger size of the iodide anion. On the contrary, it was found that the MX bonds were not influenced by the alkali metal cations, and the R-3 space group can be preserved. FIG. 4F shows that the Te—Cl bond lengths were 2.546 Å, 2.548 Å, and 2.544 Å for the Cs-, Rb-, and K-based assemblies, respectively. However, when using a smaller alkali cation, the height of the cone decreased (from ˜2.4 Å to ˜1.8 Å when changing from Cs⁺ to K⁺), while the diameter of the cone remained nearly unchanged. This height decrease was consistent with a shift in the diffraction peaks related to the c lattice parameter [such as (101) and (104) planes] to larger 2θ values. In contrast, the diffraction of facets parallel to the c axis, such as the (110) plane, has almost no shift (FIGS. 4E, 10, 11). The single crystals of (18C6@K)₂TeBr₆ synthesized from ACN and DMF were compared (Table 8); both crystals are in the R-3 space group and only show slight differences in lattice parameters, which are attributed to the occupation of disordered larger DMF molecules compared to ACN molecules in the voids within the lattice. Thermogravimetric analysis on (18C6@Cs)₂TeCl₆ shows that the total relative mass changes from 98.5% [M_{w}=1248.95 g/mol for (18C6@Cs)₂TeCl6·2DMF] to 88.6% [M_{w}=1134.76 g/mol for (18C6@Cs)₂TeCl₆] from 80 to 120° C. and further reduced to 48.9% (M_{w}=606.13 g/mol for Cs₂TeCl₆) from 160 to 220° C. (FIG. 12). The same decomposition process is also verified for (18C6@Cs)₂SnCl₆ and (18C6@Cs)₂TeBr₆. Thermal analysis studies reveal the fact that for this family of new materials, the solvent molecules (such as DMF) occupying the lattice voids are evaporated from 80 to 120° C., and 18C6 starts to detach at roughly 160° C. and completely decomposes into the corresponding all-inorganic Cs₂MX₆ powders after 220° C. It also proves the existence of solvent molecules in the lattice voids as expected from the single-crystal structure studies. To further confirm the intact Oₕ symmetry of the metal halide octahedral building blocks, Raman spectroscopy was used to study the vibrational modes of the dumbbell structural unit. Previous Raman studies of the Cs₂TeCl₆ crystal system determined that the vibrational units in the single crystals were the isolated [TeCl₆]²⁻ octahedra with Oh point group symmetry (FIG. 13). All three characteristic Raman peaks were still observed in the (18C6@A)₂TeCl₆ single crystals (FIG. 14), confirming the Oₕ symmetry of the [TeCl₆]²⁻ unit in the dumbbell building block. Similar Oh-symmetry Raman peaks were also observed in assembled crystals with other octahedra, such as [TeBr₆]²⁻, [SnCl₆]²⁻, and [SnBr₆]²⁻ (FIGS. 15-17).

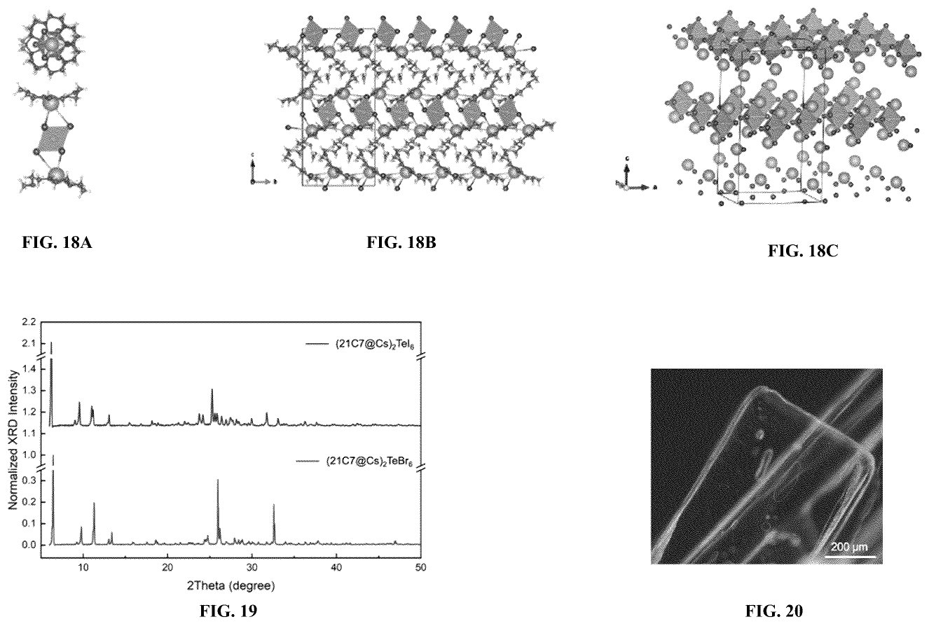

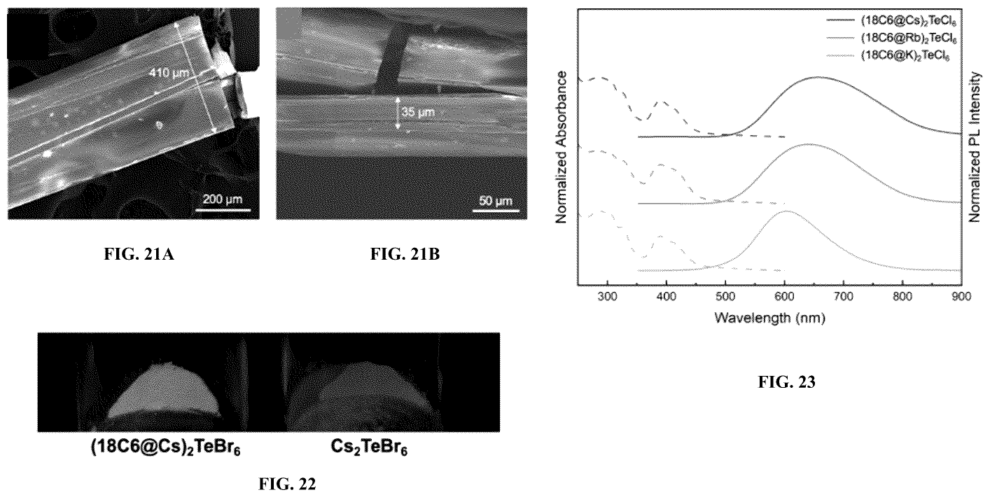

The compatibility between the point groups of 18C6 and the metal halide octahedral units resulted in the rhombohedral R-3 space group of the assembled single crystals. By breaking the six-fold symmetry of the crown ether, the supramolecular approach can realize more packing geometries for these metal halide octahedral units. For example, the larger 21-Crown-7 (21C7) had to distort itself to coordinate with the center Cs⁺ cation (FIG. 18A). Such distortion of the dumbbell building block dramatically altered the packing geometry of these building blocks (FIG. 18B, 18C). Single crystals of (21C7@Cs)₂TeBr₆ and (21C7@Cs)₂TeI₆ crystallized in an orthorhombic structure with space group Cmc21 (Table 9). The [TeBr₆]²⁻ units in the (21C7@Cs)₂TeBr₆ dumbbell unit were still nearly perfect, but this distorted dumbbell structure was found to be horizontally packed into a two-dimensional (2D) array form. In each [TeBr₆]²⁻ octahedral plane, one octahedron had four nearest neighbors (the Te—Te distance is 9.9 Å), with no solvent molecules or crown ether complexes in between. The interlayer spacing of the 2D octahedral sheets was about 13.7 Å. Consistent with a 2D structure, the (002) diffraction peak was much stronger than the other diffraction peaks (FIG. 19). The single crystal had a planar shape with a width of over 400 μm and a thickness of only 35 μm (FIGS. 20, 21). Therefore, the use of 21C7 introduced another new type of metal halide octahedral unit packing in the supramolecular assemblies provided herein.

### Optoelectronic Properties of the Supramolecular Assemblies

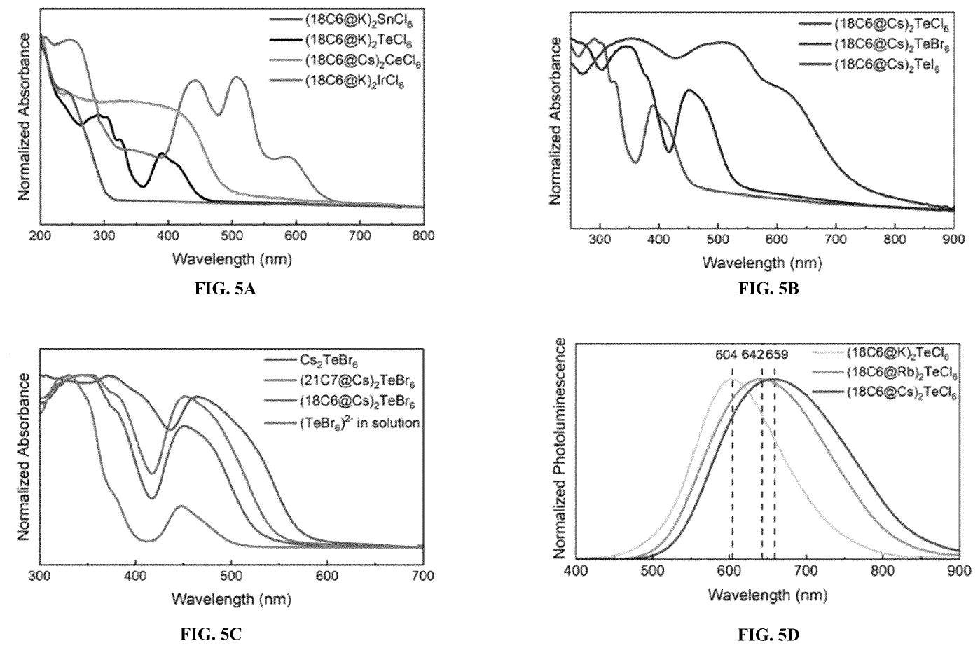

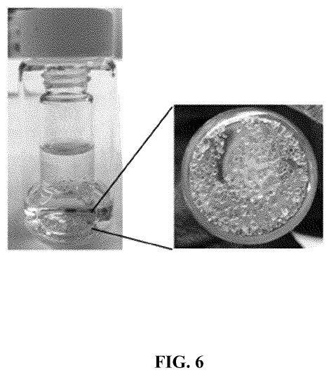

The demonstrated synthetic flexibility and systematic control of the crystal structures assembled from the dumbbell structural unit have deep implications for their electronic properties. The electronic structure of the structural unit is primarily determined by the metal halide octahedral units.¹⁴ For instance, by tuning the center metal cation of the [M(IV)Cl₆]²⁻ (M=Sn⁴⁺, Te⁴⁺, Ce⁴⁺, and Ir⁴⁺) ionic octahedron, the optical absorption onset of the supramolecular-assembled crystals varied from 660 nm for [IrCl₆]²⁻ to 500 nm for [CeCl₆]²⁻, to 460 nm for [TeCl₆]²⁻, and to 310 nm for [SnCl₆]²⁻ (FIG. 5A). The differences in absorption features for these four ionic octahedra are due to their different electronic configurations. Te⁴⁺ is a cation with ns2 electronic configuration; the absorbance of [TeCl₆]²⁻ octahedra was dominated by the molecular 5s to 5s5p transitions, represented as the A, B, and C bands. Recent studies suggested that a sharp absorption band in the UV range for [SnCl₆]²⁻ can be assigned to a ligand-to-metal charge transfer (LMCT) transition. The absorption band was also assigned to the LMCT transition for [CeCl₆]²⁻. For Ir, the subshells of the 5d orbitals of Ir⁴⁺ in [IrCl₆]²⁻ contributed to the weak optical transition bands, and intense bands were due to metal-ligand interactions. Changing the halide anions also contributed to different optical absorptions. (18C6@Cs)₂TeX₆ (X=Cl⁻, Br⁻, I⁻) structural units have vastly different optical absorption features due to the shift of the atomic orbital energy levels of halide anions (FIG. 5B).

The optoelectronic tunability of the dumbbell unit can be achieved not only by incorporating various [M(IV)X₆]²⁻ ionic octahedra but also by changing the octahedral packing geometries and the surrounding coordination environment of the same metal halide octahedra. The electronic interaction of these octahedral units has deep implications for the electronic structure of the crystal. According to the tight-binding model, the superposition of wavefuinctions for isolated atoms will be greater when atoms are brought closer together in a solid, so the electronic bands will be more dispersive, and the band gap will decrease.⁴¹ In the current materials system, the individual octahedron can be viewed as a super ion/atom with specific molecular orbital levels. When the octahedra of these dumbbell units are closer to each other, their orbital wavefunctions will overlap to a greater extent. This was confirmed by the experimental observation provided herein. The UV-vis absorption spectra of four different packing geometries of the [TeBr₆]²⁻ octahedra are shown in FIG. 5C. As the [TeBr₆]²⁻ octahedra were packed closer in a crystal by using different crown ether complexes, the A-band absorption onset red-shifted from 500 to 590 nm, causing the crystal to change color from orange [(18C6@Cs)₂TeBr₆ and (21C7@Cs)₂TeBr₆] to red [Cs₂TeBr₆] (FIG. 22).

The supramolecular-assembled crystals have not only tunable optical absorption but also strong photoluminescence (PL) with a highly tunable emission color. For instance, under 250 nm excitation, (18C6@Cs)₂ZrCl₆ displays an intense blue emission at 459 nm, with a full width at half-maximum (FWHM) of 0.90 eV. The PL quantum yield of (18C6@Cs)₂ZrCl₆ is 12.57%, which is calculated from integrating sphere measurements. Apart from high emission intensities, the supramolecular approach can also enable the fine-tuning of the emission color. The strong coupling of the exciton with lattice vibrations will greatly lower the energy level of the exciton, forcing it into transient self-trapped exciton (STE) states with a range of self-trapped energy levels. The [TeCl₆]²⁻ octahedron was selected to study the STE emission of the dumbbell structural units. The PL spectra (FIGS. 5 and 23) of the (18C6@A)₂TeCl₆ (A=K⁺, Rb⁺, and Cs⁺) crystals had emission peak wavelengths at 604, 642, and 659 nm, respectively. They all featured a large Stokes shift of 1.13, 1.26, and 1.31 eV, respectively, and a very large broadband emission. The PL FWHM was 0.44, 0.54, and 0.55 eV, respectively. The Stokes shift was larger than that of the Cs₂TeCl₆ crystal, with a value of 1.04 eV,⁹ which indicated a greater exciton-phonon coupling effect. Furthermore, the Stokes shift increased with increasing alkali metal cation size. This phenomenon was likely due to the difference in the alkali metal halide bond strength. A weaker or softer alkali metal halide bond will force the excitonic state into deeper self-trapped levels. The PL studies demonstrate that the supramolecular assembly approach can be used to design emissive and tunable emitters.

### SUMMARY

In conclusion, a general synthetic strategy for a library of new supramolecular building blocks (crown-ether@A)₂M(IV)X₆, constructed from ionic halide perovskite octahedral units and crown ethers was demonstrated. The great tunability of (crown-ether@A)₂M(IV)X₆ can be explored along (1) changing the octahedron cation, (2) tuning the halide anion, (3) modifying the alkali metal cation coupled with the crown ether, and (4) varying the size of the crown ether. Based on the structural diversity of the supramolecular assembly approach, one-dimensional and 2D electronic dimensionality solid assembly with connected [MX₆]ⁿ⁻ octahedra is tested. Also, with all these synthetic possibilities, a more in-depth study of the optoelectronic properties of the ionic octahedral building blocks can be conducted. This new assembly strategy of the supramolecular building blocks could bring a new general method for halide perovskite material discovery.

### Materials and Methods

Materials. 18-Crown-6 (18C6, 99%, Sigma Aldrich), 21-Crown-7 (21C7, 97%, Alfa Chemistry), CsCl (99.999%, Sigma Aldrich), CsBr (99.999%, Sigma Aldrich), CsI (99.999%, Sigma Aldrich), RbCl (99.95%, Sigma Aldrich), RbBr (99.6%, Sigma Aldrich), RbI (99.9%, Sigma Aldrich), KCl (99%, Sigma Aldrich), KBr (99%, Sigma Aldrich), KI (99%, Sigma Aldrich), TeCl₄ (99.9%, Alfa Aesar), TeBr₄ (99.9%, Alfa Aesar), TeI₄ (99%, Alfa Aesar), SnCl₄ (99.9%, Alfa Aesar), SnBr₄ (99.9%, Alfa Aesar), K₂PtCl₆ (99.99%, Sigma Aldrich), K₂IrCl₆ (99.99%, Sigma Aldrich), SeCl₄ (35.0-36.5% Se basis, Sigma Aldrich), ZrCl₄ (99.99%, Sigma Aldrich), (NH₄)₂Ce(NO₃)₆ (99.99%, Sigma Aldrich), hydrochloric acid (HCl, 37%, Sigma Aldrich), hydrobromic acid (HBr, 48%, Sigma Aldrich), hydroiodic acid (HI, 57%, Sigma Aldrich), N,N-dimethylformamide (DMF, Fisher Scientific), acetone (Sigma Aldrich), acetonitrile (ACN, Sigma Aldrich), acetonitrile-d₃ (ACN-d₃, ≥99.8 atom % D, Sigma Aldrich) and diethyl ether (DEE, Sigma Aldrich) were used as received without further purification or modification.

Synthesis of A₂MX₆ (A=Cs⁺, Rb⁺, K⁺; M=Te⁴⁺, Sn⁴⁺, Zr⁴⁺; X=Cl⁻, Br⁻, I⁻) Powders. Precursor powders AX and MX4 were measured into a 20 ml vial based on the 2:1 stoichiometric ratio, and the precursors were dissolved in 5 ml of HX acid. Precipitates were filtered immediately and washed with HX acid. Precipitates were dried in a vacuum oven at 60° C. overnight.

Synthesis of K₂SeCl₆ Powders. Precursor powders KCl and SeCl₄ were measured into a 20 ml vial based on the 2:1 stoichiometric ratio, and the precursors were dissolved in 5 ml of DMF on a hot plate at 100° C. for three hours in an argon glovebox. The supersaturated solution was filtered into a new 20 ml vial and 10 ml of DEE was added into the solution as anti-solvent. Precipitates were filtered, washed with acetone and dried in the vacuum oven at 60° C. overnight.

Synthesis of Cs₂CeCl₆ Powders. Cs₂CeCl₆ powders were synthesized using the same procedure as literature¹. Precursor powders of CsCl and (NH₄)₂Ce(NO₃)₆ based on the 2:1 stoichiometric ratio were dissolved in 4 ml of HCl at 4° C. The precipitate was filtered immediately and washed with 1 ml of cooled HCl. The precipitate was dried in vacuum oven at room temperature overnight.

Synthesis of (18C6@A)₂M(IV)X₆ (A=Cs⁺, Rb⁺, K⁺; M=Te⁴⁺, Sn⁴⁺, Se⁴⁺, Ir⁴⁺, Pt⁴⁺, Zr⁴⁺, Ce⁴⁺; X=Cl⁻, Br⁻, I⁻). Powders of A₂MX₆ and 18C6 were measured into a 20 ml vial based on the 1:2 stoichiometric ratio, and the precursors were dissolved in 10 ml of ACN or DMF on a hot plate at 100° C. with vigorous stirring for three hours. The supersaturated solution was filtered into a new 20 ml vial. (18C6@A)₂M(IV)X₆ powders were obtained by adding 10 ml of the supersaturated solution into 20 ml of DEE anti-solvent in a 50 ml centrifuge tube. The mixtures were centrifuged at 4000 rpm for 5 minutes to separate the powders and the solution. The powders were dried in a vacuum oven at 50° C. overnight. Se⁴⁺ and Zr⁴⁺ versions were hydroscopic, and an argon glovebox was used to avoid air exposure during the whole process. using the solution-based anti-solvent vapor method. (18C6@A)₂M(IV)X₆ single crystals were grown using an anti-solvent diffusion method. 1 ml of the abovementioned supersaturated solution was added into a 4 ml vial, which was placed into a 20 ml vial with 4 ml of DEE. After approximately two days, single crystals were formed on the bottom and the wall of the 4 ml vial. Single crystals were washed 3 times with acetone and stored in an argon glovebox for future use.

Synthesis of (21C7@Cs)₂TeX₆ (X=Br⁻, I⁻). (21C7@Cs)₂TeX₆ (X=Br⁻, I⁻) powders and single crystals were synthesized using methods similar as the (18C6@A)₂M(IV)X₆ but replacing 18C6 with 21C7.

Single-Crystal X-ray Diffraction (SCXRD). The SCXRD data were collected at the Small Molecule X-ray Crystallography Facility (CheXray) in College of Chemistry, UC Berkeley. SCXRD were measured with a Rigaku XtaLAB P200 instrument equipped with a MicroMax-007 HF microfocus rotating anode and a Pilatus 200K hybrid pixel array detector using monochromated Mo Kα radiation (λ=0.71073 Å). All crystal datasets were collected at room temperature (298 K). CrysAlisPrO² was used for data collection and data processing, including a multi-scan absorption correction applied using the SCALE3 ABSPACK scaling algorithm within CrysAlisPro. Using Olex2³, the structures were solved with the SHELXT⁴ structure solution program using Intrinsic Phasing and refined with the SHELXL⁵ refinement package using Least Squares minmization. Due to the occupation of disordered two solvent molecules in the crystal voids, solvent masks were used during the refinement. All reflections where [error/esd]>5 were omitted, as the existence of disordered molecules will result in high error/esd values in low d-spacing diffractions.

Ambient Condition Powder X-ray Diffraction. Powder X-ray diffraction (PXRD) data of (18C6@A)2MX6 (A=Cs⁺, Rb⁺, K⁺; M=Te⁴⁺, Sn⁴⁺, Ir⁴⁺, Pt⁴⁺, Zr⁴⁺, Ce⁴⁺; X=Cl⁻, Br⁻, I⁻) and (21C7@Cs)2TeX6 (X=Br⁻, I⁻) were collected using a Bruker D8 laboratory diffractometer with a Cu Kα radiation source in ambient condition. Data was collected from 2 θ=7°-50°. The single crystals were ground into powders and transferred onto glass for measurements.

Inert Atmosphere Powder X-ray Diffraction. PXRD of (18C6@K)₂SeCl₆ was collected using a Rigaku Miniflex 6G Benchtop Powder XRD with a Cu K αα radiation source and an inert atmosphere sample holder. The powder samples were loaded onto the sample holder inside an argon glovebox.

Optical Microscope Imaging. An unpolarized, white-light optical microscope was used to visualize single crystals under either a 20× or a 50λ microscope objective. The single crystals were observed under dark-field imaging. The single crystals were dispersed onto glass for measurement.

Scanning Electron Microscopy (SEM). A field-emission SEM (FEI Quanta 3D FEG SEM/FIB) was used to visualize single crystal morphologies at the QB3-Berkeley Biomolecular Nanotechnology Center (BNC).

Nuclear Magnetic Resonance Spectroscopy. All the NMR experiments were conducted in UC Berkeley's NMR facility in the College of Chemistry (CoC-NMR). The ¹H and ⁷⁹Br solution NMR were performed by Bruker AV600 and ¹³³Cs solution NMR was performed by Bruker AV500. Acetonitrile-d3 was used as solvent for all the measurements.

Raman Spectroscopy. The Raman spectra of Cs₂TeCl₆, (18C6@A)₂TeBr₆, (18C6@A)₂SnCl₆, and (18C6@A)₂SnBr₆ (A=K⁺, Rb⁺, Cs⁺) samples were measured by a confocal Raman microscope system (Horiba LabRAM HR800 Evolution). The single crystals were dispersed onto glass microscope slides for measurement. A continuous-wave (cw) 633 nm laser was focused onto a crystal facet at a constant power density set by neutral density filters. The Raman signal from the sample was collected using a microscope objective in a backscattering geometry (100×, NA 0.6). High-resolution Raman spectra were measured with a charge-coupled device (CCD) detector equipped with a diffraction grating of 1800 gr/mm and a long pass filter (80 cm⁻¹) to remove the Rayleigh scattering line from the signal.

Ultralow-Frequency (ULF) Raman Spectroscopy. The Raman spectra of the (18C6@A)₂TeCl₆ (A=K⁺, Rb⁺, Cs⁺) samples were measured by a confocal Raman microscope system (Horiba LabRAM HR Evolution) at the Stanford Nano Shared Facilities (SNSF). The powders were dispersed onto glass microscope slides for measurement. A continuous-wave 633 nm laser was focused onto the powder, thin film, or coating surfaces at a constant power density set by neutral density filters. The Raman signal from the sample was collected using a microscope objective in a back-scattering geometry (100×, NA 0.6). High-resolution Raman spectra were measured with an Andor Newton DU970P BVF EMCCD detector equipped with a diffraction grating of 1800 gr/mm and an ULF filter package (10 cm⁻¹) to remove the Rayleigh scattering line from the signal.

Photoluminescence (PL) Spectroscopy. Photoluminescence measurements were collected with a home-built PL microscope system. The single crystals were dispersed onto glass for measurement. A continuous-wave solid-state 375 nm laser (Coherent OBIS 375LX) was focused obliquely onto the sample with a constant power density in visible wavelength measurements and infrared wavelength measurements, which was set by neutral density filters. The PL signal from the sample was collected using a microscope objective (50×) coupled to a long-pass filter (390 nm) in visible wavelength measurements and to a long-pass filter (800 nm) in infrared wavelength measurements to remove the laser line from the signal. Visible wavelength PL spectra were collected under a 1 s exposure time with a Si CCD detector cooled to −120° C. via liquid nitrogen and equipped with a diffraction grating of 150 gr/mm. The PL imaging was taken under bright-field conditions.

Photoluminescence Quantum Yield (PLQY). The PLQY was calculated from integrating sphere measurements in an Edinburgh Instruments FS5 spectrofluorometer with 250 nm excitation. The single crystals were grinded into powders, and a thin layer of powders was placed in the polytetrafluoroethylene (PTFE) sample holder for measurement. A 150 W continuous-wave (CW) ozone-free Xenon (Xe) arc lamp was focused onto the sample. The spectra were collected under a 0.3 s exposure time with a UV enhanced Si photodiode array equipped with a diffraction grating of 1200 gr/mm.

UV-Visible Absorption Spectroscopy. The absorption spectra of the samples were measured by a UV-visible spectrophotometer (Shimadzu UV-2600). Data was collected in absorption mode over a wavelength range of 200 nm and 900 nm with a medium scanning rate. The powder samples were widely dispersed on quartz glass. The solution samples were placed into a quartz cell with a 0.1 mm path length.

Thermogravimetric Analysis. The measurement was performed by TA Instrument Q500 with a nitrogen atmosphere. The samples were loaded on a platinum pan. The experiment procedure was 1) equilibrate at 60° C. for 20 minutes and 2) ramp to 500° C. with a heating rate of 5° C./min.

### Example 2: Supramolecular Assembly of Blue and Green Halide Perovskites with Near-Unity Photoluminescence

As shown in Example 1, in a general crown ether-assisted supramolecular assembly approach for tetravalent metal octahedra provided herein, two crown ether@alkali metal complexes can sandwich a tetravalent metal octahedron into a (crown ether@A)₂MX₆ dumbbell structural unit. The composition of the dumbbell structural unit is highly tunable, with crown ether=18-crown-6 (18C6) or 21-crown-7 (21C7); A=Cs⁺, Rb⁺, or K⁺; M=Te⁴⁺, Sn⁴⁺, Se⁴⁺, Ir⁴⁺, Pt⁴⁺, Zr⁴⁺, Hf⁴⁺, or Ce⁴⁺; and X=Cl⁻, Br⁻, or I⁻. In Example 2, this general supramolecular assembly approach was extended to [HfBr₆]²⁻ octahedra to achieve a structure with formula (18C6@K)₂HfBr₆ that features blue emission with near-unity (96.2%) PLQY. The synthetic route was optimized by replacing the challenging high-temperature solid-state synthesis with a low-temperature organic solution-based synthesis. Moreover, an efficient green emission was also achieved by tuning the composition of the (crown ether@A)₂MX₆ dumbbell structural unit. (18C6@K)₂ZrCl₄Br₂ demonstrated green emission with 82.7% PLQY. By studying the photophysics of the supramolecular assembled samples, the emission was attributed to STE states, and a very strong electron-phonon coupling constant (represented by the Huang-Rhys parameter) of >90 for (18C6@K)₂HfBr₆ was observed. The supramolecular assembled samples had longer PL lifetimes (in the microsecond timescale) compared with those of other halide perovskite systems that reflected a low rate of nonradiative recombination.

The structural integrity and impressive optical properties of the supramolecular assembled solid powders were further maintained by generating a powder suspension in nonpolar organic solvents, such as dichloromethane (DCM), to create an ink system. Polystyrene (PS) polymer was dissolved into the ink to further increase the solution processability. These inks were used to fabricate thin films through fast solvent evaporation. In combination with a digitally controlled excitation source, the (18C6@K)₂HfBr₆/PS composite thin film could be used as a display with bright color contrast and fast response time. A solution-processable ink also allowed three-dimensional (3D) printing of the powders into various blue-, green-, and dual-color-emitting structures.

### Crown Ether-Assisted Supramolecular Assembly

A supramolecular synthetic route was explored in which 18C6 greatly increased the solubility of the KBr and HfBr4 precursors in polar organic solvents for low-temperature solution based synthesis. A clear precursor solution was obtained with acetonitrile (ACN) at 80° C. with the concentration of 4 mM for 18C6 and KBr and 2 mM for HfBr₄. Example 1 indicated that a (18C6@K)₂HfBr₆ dumbbell structural unit was formed in ACN. (18C6@K)₂HfBr₆ powders and single crystals were grown using the antisolvent crystallization method (39). K₂HfBr₆ powders were also synthesized by using a modified solid-state synthesis method. The purity was increased and the synthesis temperature was decreased to 200° C. by combining mechanical forces with heat to facilitate solid-state diffusion. Details of the synthesis for (18C6@K)₂HfBr₆ and K₂HfBr₆ are described in the Materials and Methods section.

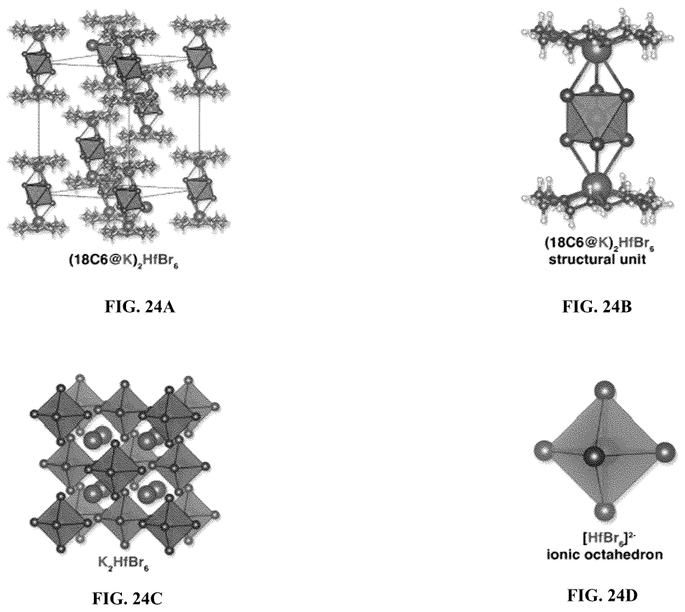

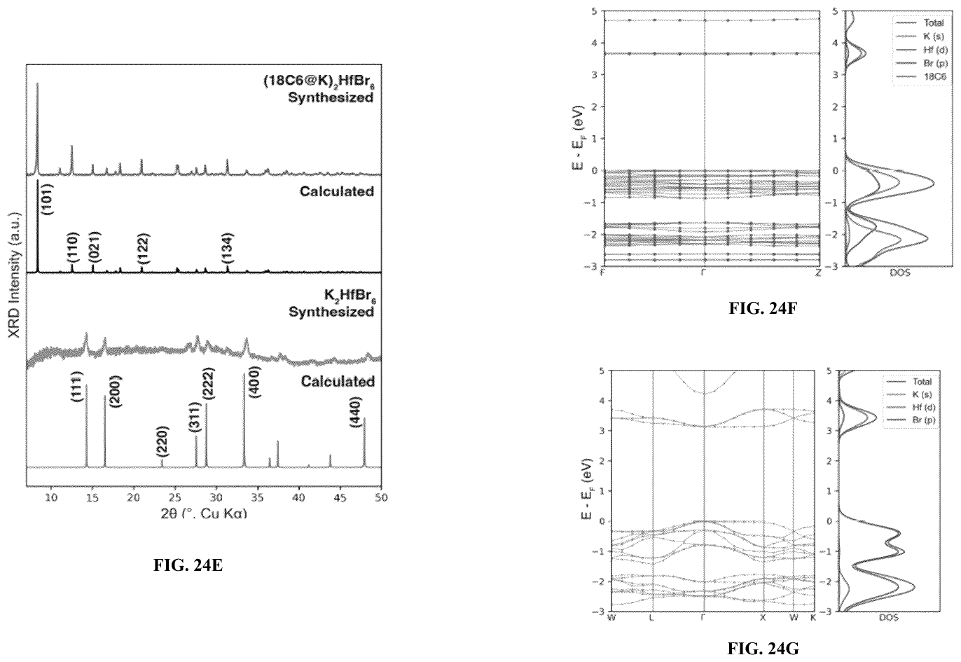

The crystal structure of (18C6@K)₂HfBr₆ was determined from single-crystal x-ray diffraction (SCXRD). (18C6@K)₂HfBr₆ crystallized in the R-3 space group with lattice parameters of a=14.1332 Å and c=21.0189 Å (FIG. 24 and table 10). The (18C6@K)₂HfBr₆ dumbbell structural unit belongs to the S6 point group, where two K⁺ cations and the Hf⁴⁺ cation sit on the S₆ axis. The sixfold symmetry axis of the 18C6 and the S₆ axis of the Oₕ-symmetric [HfBr₆]²⁻ octahedron were aligned (FIG. 24B). The K₂HfBr₆ crystals were face-centered cubic (fcc) (FIG. 24C), in which the [HfBr₆]²⁻ ionic octahedra were charge balanced by the surrounding K⁺ cations (FIG. 24D).

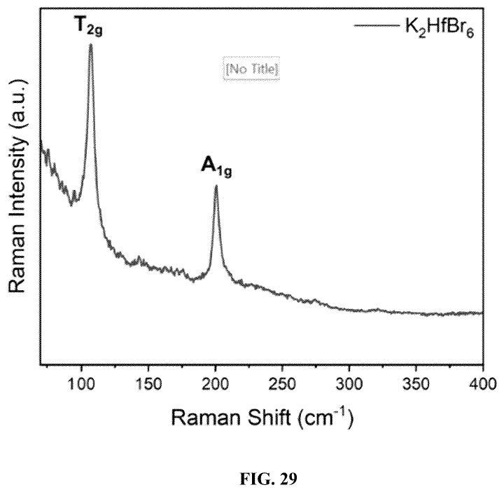

The purity of the (18C6@K)₂HfBr₆ and K₂HfBr₆ powders was investigated with powder x-ray diffraction (PXRD) (FIG. 24E). The PXRD pattern of the (18C6@K)₂HfBr₆ powders matched with the calculated pattern generated from the single-crystal structure with no visible diffraction peaks from impurities. The quality of the PXRD pattern for the K₂HfBr₆ powders was much lower because of their extreme air sensitivity. The measurement had to be collected in 5 min with an inert atmosphere sample holder to prevent the degradation of the powders and measurement of the degradation product. Although the quality of the K2HfBr₆ PXRD pattern was not ideal, the most dominant peaks of the fcc K₂HfBr₆ phase were still identifiable. Moreover, no HfBr4 or KBr diffraction peaks were present (FIG. 24E), which showed that all of the precursor materials transformed into the K₂HfBr₆ phase. A Raman spectrum of K₂HfBr₆ further confirmed the presence of the [HfBr₆]²⁻ octahedra in the crystal structure (FIG. 29).

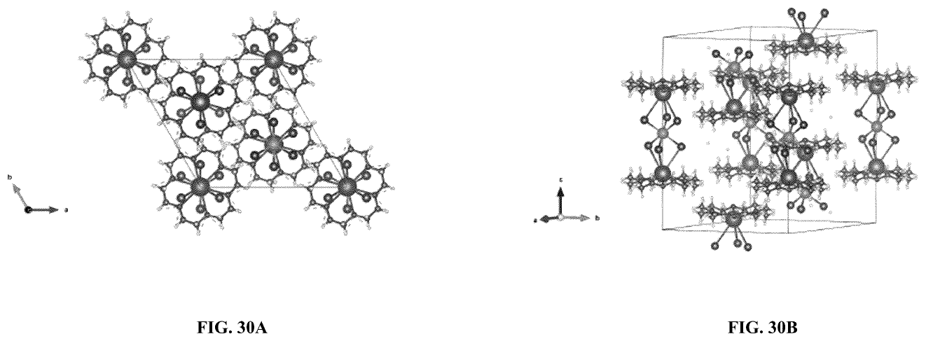

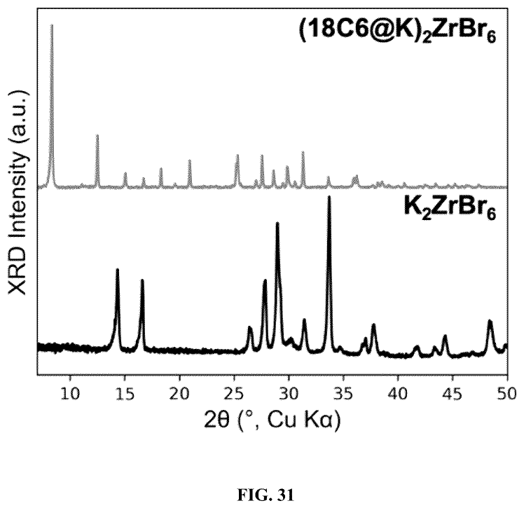

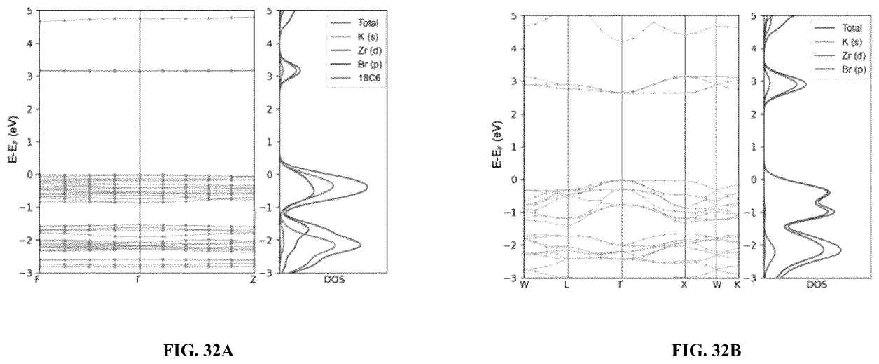

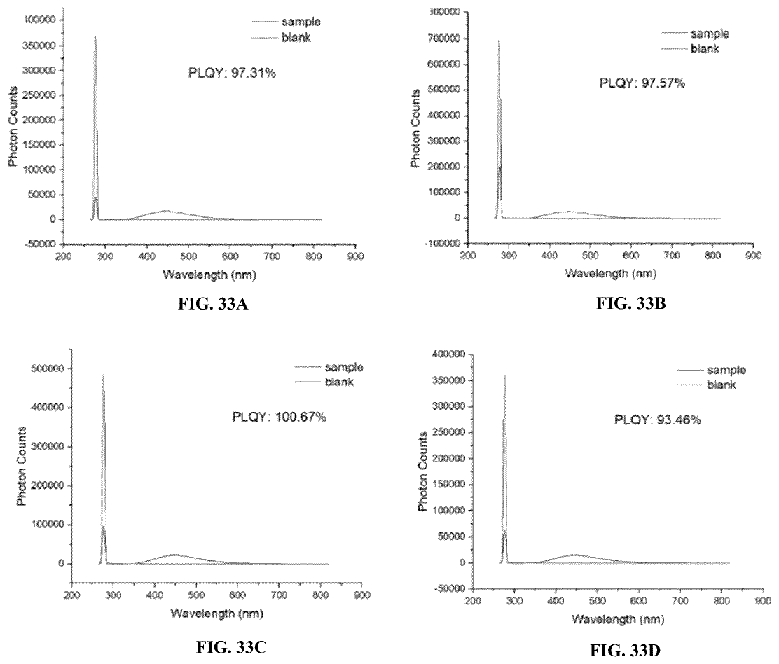

The crown ether-assisted supramolecular approach was generalized to produce other emissive centers. For example, (18C6@K)₂ZrBr₆ single crystals and powders were successfully synthesized by the same method, and the same crystal structure as (18C6@K)₂HfBr₆ was obtained (FIG. 30 and table 10). FIG. 31 shows that phase-pure (18C6@K)₂ZrBr₆ powders could be obtained with the established solution-based synthesis. K₂ZrBr₆ powders were also synthesized with the same solid-state method as K₂HfBr₆. The (18C6@K)₂HfBr₆ and (18C6@K)₂ZrBr₆ dumbbell building blocks were also the electronic units of the new crystal. To elucidate the effect of 18C6 on the electronic structures of the assembled [HfBr₆]²⁻ octahedra, density functional theory (DFT) calculations were performed on (18C6@K)₂HfBr₆ (FIG. 24F) and K2HfBr₆ (FIG. 24G) to determine their electronic band structures and partial electronic density of states (pDOS). The electronic bands of (18C6@K)₂HfBr₆ were less dispersive compared with K2HfBr₆ because the [HfBr₆]²⁻ octahedra were more separated in (18C6@K)₂HfBr₆. The conduction band (CB) of (18C6@K)₂HfBr₆ was composed of Hf 5d and Br 4p orbitals, as was the CB of K₂HfBr₆. However, the valence band (VB) compositions were quite different in these two materials. The VB of K₂HfBr₆ was mainly composed of the Br 4p orbital, but 18C6 contributed to the VB of (18C6@K)₂HfBr₆. Thus, the 18C6 molecules were electronically coupled to the [HfBr₆]²⁻ octahedra, which indicates that the entire (18C6@K)₂HfBr₆ dumbbell building block became a new electronic unit. DFT calculations of (18C6@K)₂ZrBr₆ showed that the contribution from 18C6 to the VB and the band structures were more discrete than those in K₂ZrBr₆ (FIG. 32).

### Optical Characterization of the Blue and Green Emitters

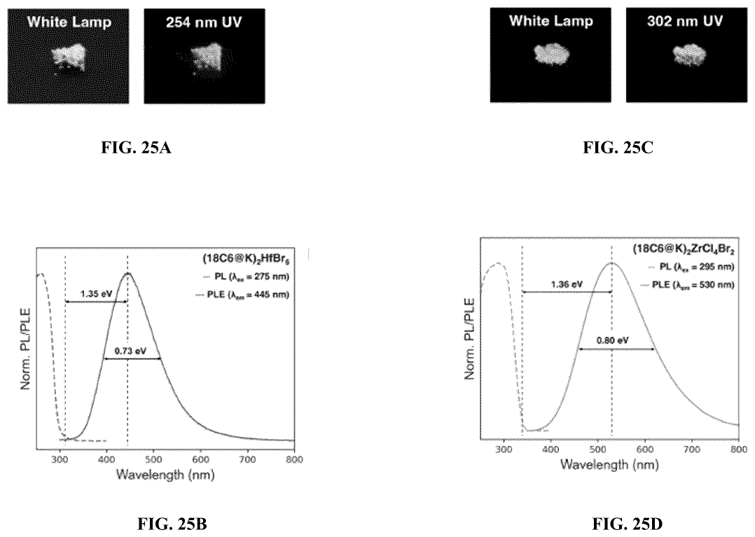

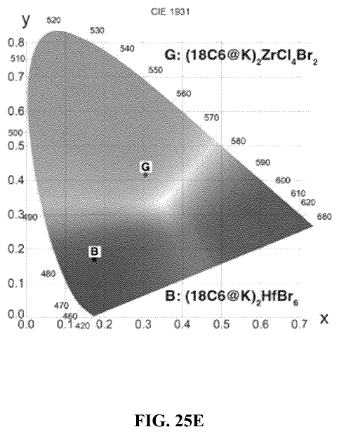

Compared with K₂HfBr₆, (18C6@K)₂HfBr₆ had greatly enhanced emission intensity. FIG. 25A shows the extremely bright blue emission of (18C6@K)₂HfBr₆ powders under 254-nm ultraviolet (UV) excitation. The photoluminescence (PL) spectrum of (18C6@K)₂HfBr₆ powders was measured at 275-nm excitation (FIG. 25B). The powders had a blue emission centered at 445 nm (2.79 eV), and the full width at half maximum (FWHM) was 0.73 eV. Photoluminescence excitation (PLE) spectra revealed a large Stokes shift (1.35 eV).

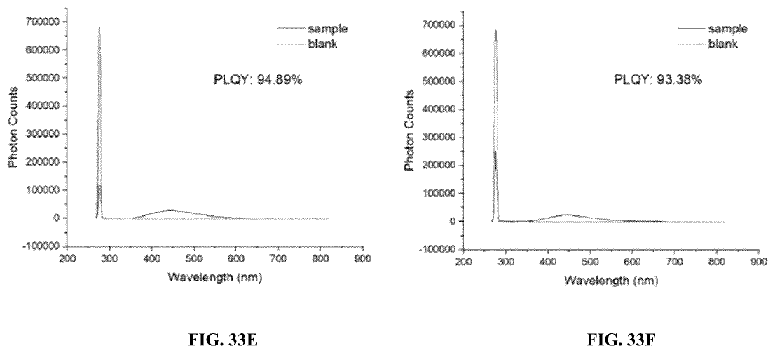

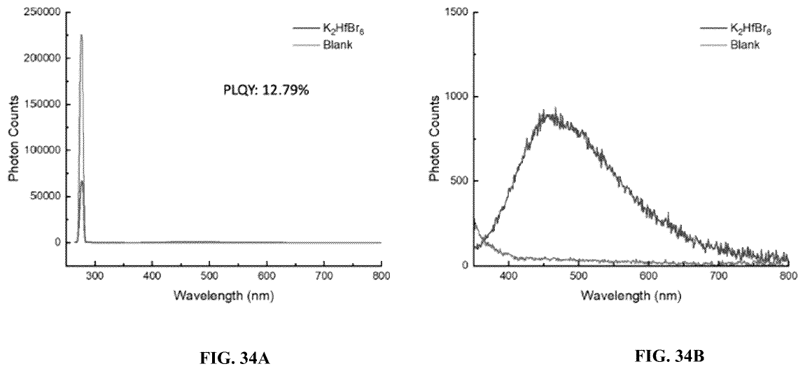

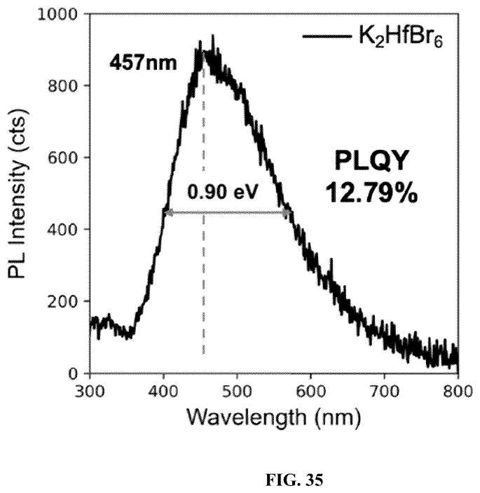

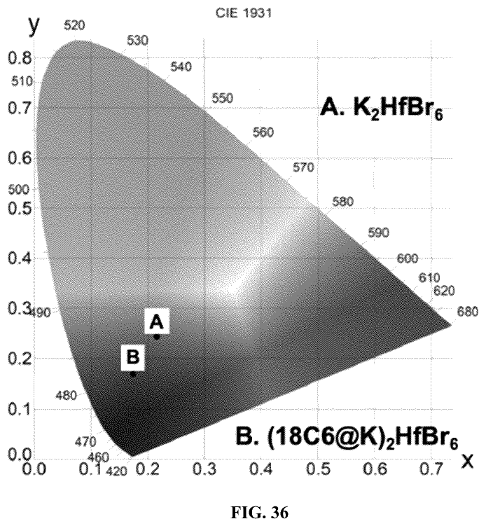

The emission intensity of the (18C6@K)₂HfBr₆ powders was quantified with PLQY measurement, and a near-unity value of 96.2±1.2% was obtained for the (18C6@K)₂HfBr₆ powders over six measurements from two batches of samples (FIG. 33). The specific value for each measurement is shown in table S2. By contrast, the PLQY of K₂HfBr₆ powders was 12.8% (FIG. 34). K₂HfBr₆ also had an even larger Stokes shift (1.42 eV) and broader emission, with a peak emission wavelength of 457 nm and a FWHM of 0.90 eV (FIG. 35). The color purity of the emission from the [HfBr₆]²⁻ octahedra was also enhanced by the supramolecular approach. FIG. 36 shows the emission color of (18C6@K)₂HfBr₆ and K₂HfBr₆ powders on the CIE 1931 chromaticity diagram. (18C6@K)₂HfBr₆ had a much purer blue emission color compared with K₂HfBr₆.

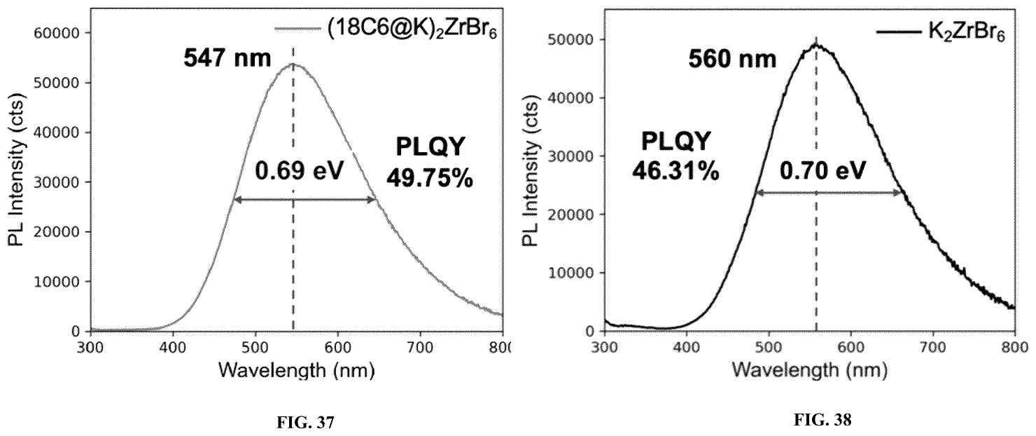

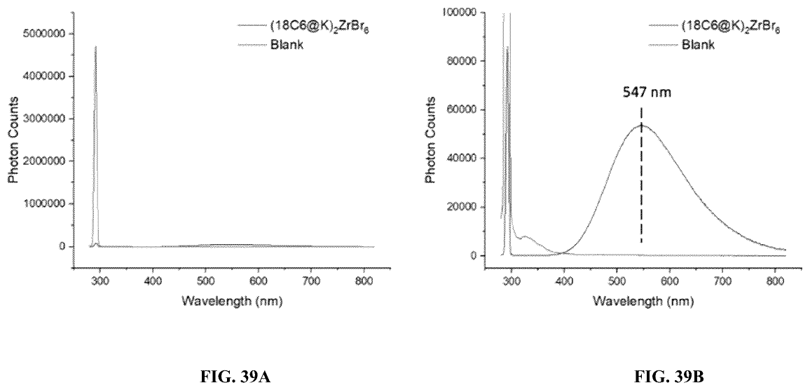

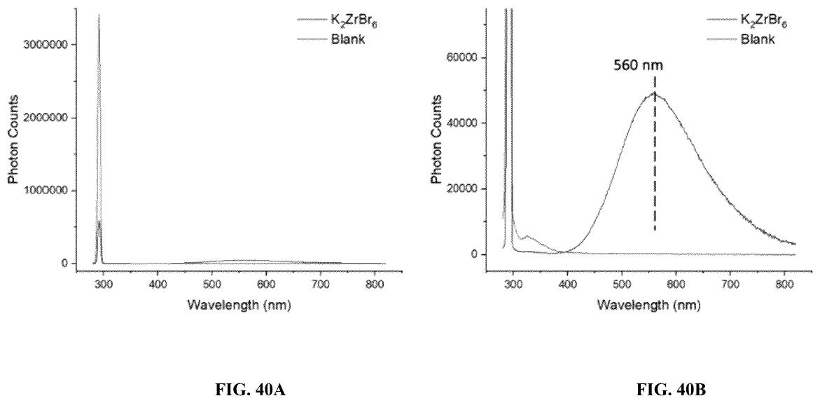

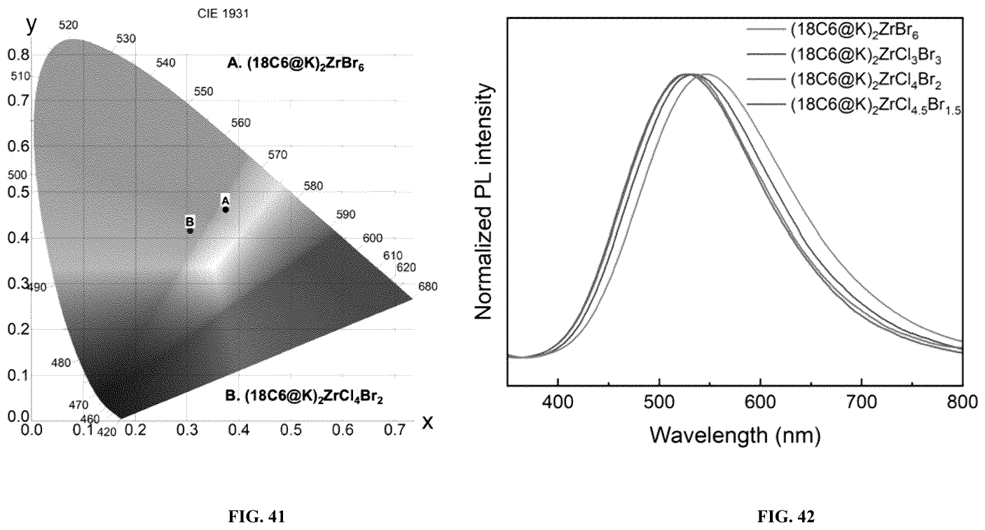

The [ZrBr₆]²⁻ units enabled high-PLQY green emissions. Upon 290-nm excitation, (18C6@K)₂ZrBr₆ had a PL peak at 547 nm, and the FWHM of the PL was 0.69 eV (FIG. 37). For the same excitation wavelength, the PL peak of K₂ZrBr₆ was at 560 nm, and the FWHM of the PL was 0.70 eV (FIG. 38). The PLQY of (18C6@K)₂ZrBr₆ was 49.8% (FIG. 39), which was slightly greater than the PLQY of K₂ZrBr₆ (46.3%) (FIG. 40). Although the peak position of the PL spectrum was in the green region, simply analyzing the peak emission wavelength was insufficient given the broadness of the STE-based emission because this crystal actually produced a yellow-green emission color (FIG. 41).

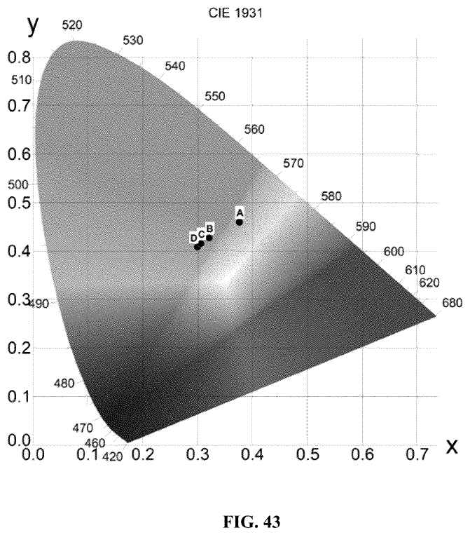

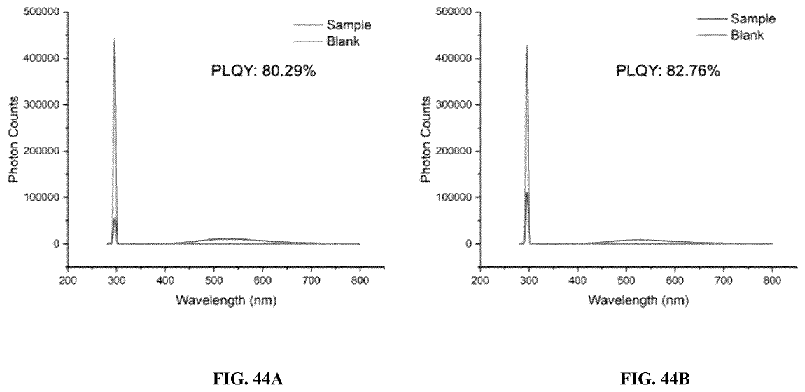

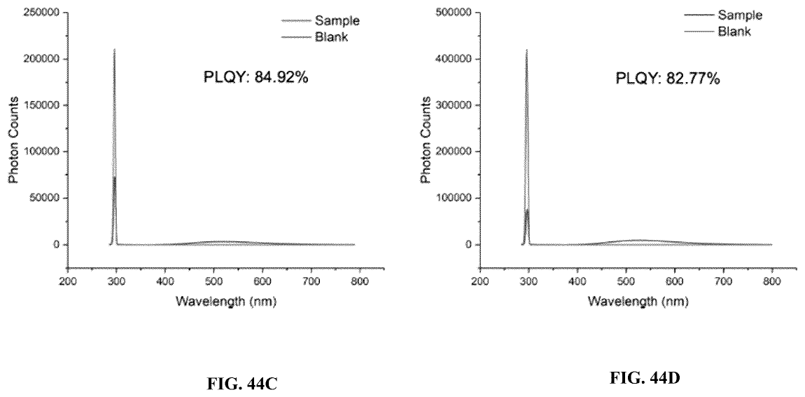

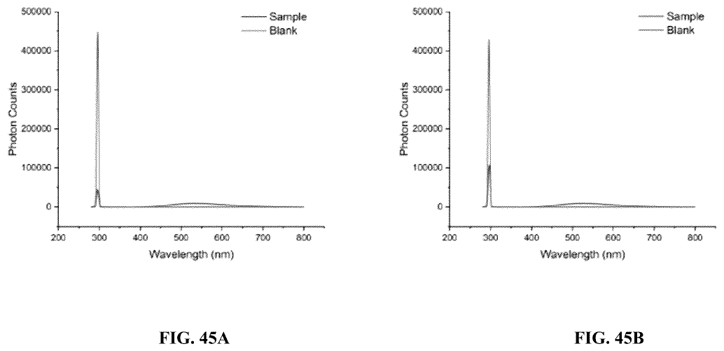

Given the great chemical tunability of the dumbbell structural unit, an alloying approach at the halide site was proposed to achieve a purer green emission with near-unity PLQY. For CsPbX₃ (where X=Cl⁻, Br⁻, or I⁻) nanocrystals, the emission color can be easily controlled by tuning the halide composition; introducing Cl⁻ in the halide site may generate a shorter wavelength emission color. By carefully tuning the KCl/KBr and ZrCl₄/ZrBr₄ precursor ratio in the synthesis, the Cl⁻/Br⁻ ratio in the obtained (18C6@K)₂ZrX₆ dumbbell structural unit can be precisely controlled. As expected, a larger Cl⁻/Br⁻ ratio created a more blue-shifted PL (FIGS. 42 and 43). For example, (18C6@K)₂ZrCl₃Br₃ and (18C6@K)₂ZrCl₄Br₂ had green emission with PL peaks at 534 and 530 nm, respectively. Increasing the Cl⁻ content to a composition of (18C6@K)₂ZrCl_{4.5}Br_{1.5} changed the PL color to a cyan (bluish green) color. The established halide site alloying approach not only generated a purer green emission color but also boosted the PLQY of the emission to near-unity. For the Cl⁻/Br⁻ ratio from 1:1 to 2:1 to 3:1, the PLQYs were 69.1, 82.7, and 87.0%, respectively (FIGS. 44 and 45).

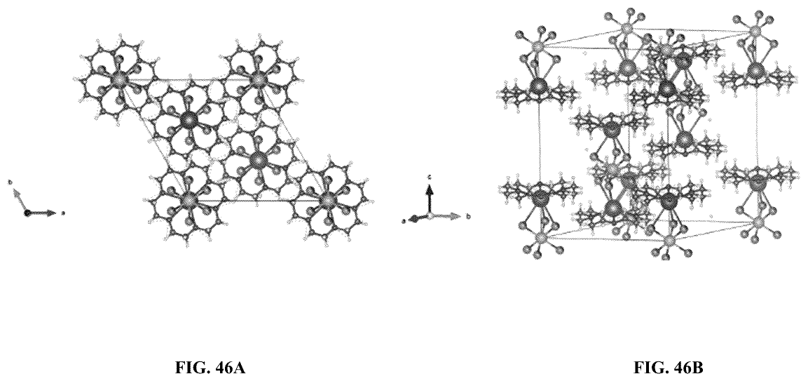

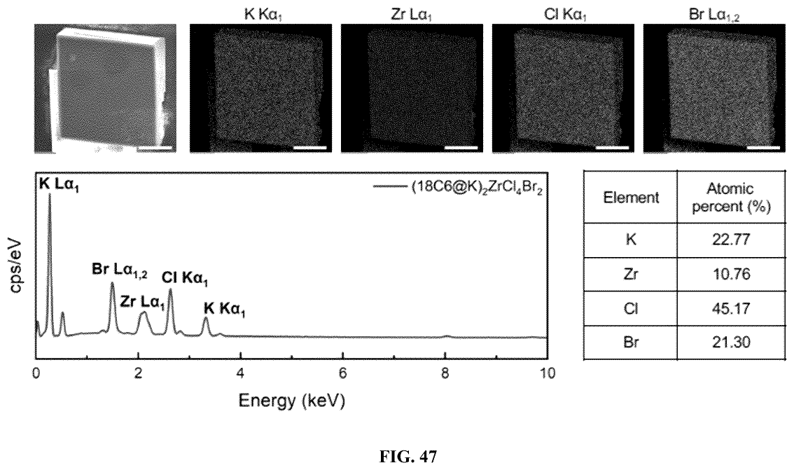

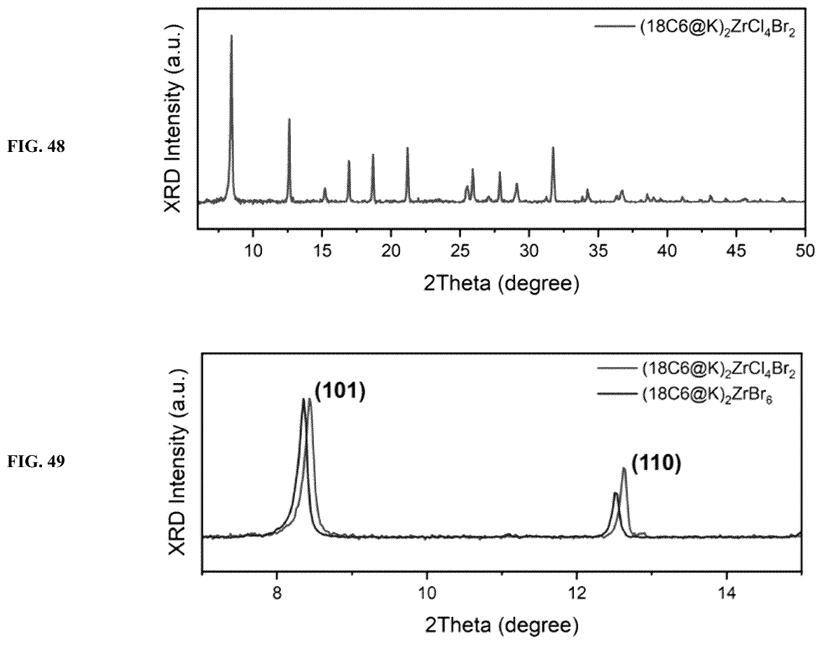

Because the 2:1 Cl⁻/Br⁻ ratio composition had both pure-green emission color and high PLQY, (18C6@K)₂ZrCl₄Br₂ was selected for detailed studies of green emission. (18C6@K)₂ZrCl₄Br₂ single crystals were synthesized by controlling the Cl⁻/Br⁻ precursor ratio to be 2:1. The formula of (18C6@K)₂ZrCl₄Br₂ was determined by SCXRD (Cl⁻:Br⁻=4.3:1.7) (FIG. 46 and table 12) and energy-dispersive x-ray spectroscopy (EDX) elemental mapping (Cl⁻:Br⁻=4.1:1.9) (FIG. 47). The Cl and Br atoms were perfectly miscible in the crystal structure. PXRD of the (18C6@K)₂ZrCl₄Br₂ powders (FIG. 48) also indicated that this composition was a phase-pure system. The (101) and (110) diffraction peaks of (18C6@K)₂ZrCl₄Br₂ were slightly shifted to larger 2 θ values compared with the corresponding PXRD peaks of (18C6@K)₂ZrBr₆, which suggests smaller lattice constants (FIG. 49).

FIG. 25C shows the bright green emission of (18C6@K)₂ZrCl₄Br₂ powders under 302-nm UV lamp excitation. The PL spectrum of (18C6@K)₂ZrCl₄Br₂ powders was measured at 295-nm excitation (FIG. 25D). The green emission had a similar Stokes shift (1.36 eV versus 1.35 eV) and FWHM (0.80 eV versus 0.73 eV) compared to the blue emission of the (18C6@K)₂HfBr₆ powders, which suggests similar emission properties of the Hf and Zr metal centers in the supramolecular assembly materials system. The PLQY of the emission from (18C6@K)₂ZrCl₄Br₂ powders was 82.7±0.9%, which was determined through the measurement of four samples from two batches (table S4). Therefore, highly emissive powders with blue and green emission colors were achieved based on the supramolecular assembly approach. The blue and green colors of the emissions from (18C6@K)₂HfBr₆ and (18C6@K)₂ZrCl₄Br₂, respectively, are summarized in the CIE 1931 diagram (FIG. 25E).

Next, a comprehensive photophysics analysis was conducted to confirm and gain deeper insights into the STE emission mechanism that underlies these blue and green emissions. The distinctive features of STE emissions, including their large Stokes shift and broadband nature, are primarily attributed to the electron phonon coupling effect. To unravel the STE emission mechanism, low temperature PL measurements was conducted to examine the electron-phonon coupling in (18C6@K)₂HfBr₆. With increasing temperatures, the PL peak gradually broadened, and the peak was slightly red-shifted, indicating greater phonon participation at higher temperatures (FIG. 36A). A small shoulder peak at ˜550 nm was present that was especially distinct at lower temperatures, which is attributed to the Zr impurity in the HfBr4 precursor (35). Inductively coupled atomic emission spectroscopy revealed an ˜0.5 atomic % (at %) ZrBr₄ impurity in the as obtained HfBr₄ precursor, and that there was an ˜0.6 at % Zr⁴⁺ impurity in the synthesized (18C6@K)₂HfBr₆ single crystals (table S5).

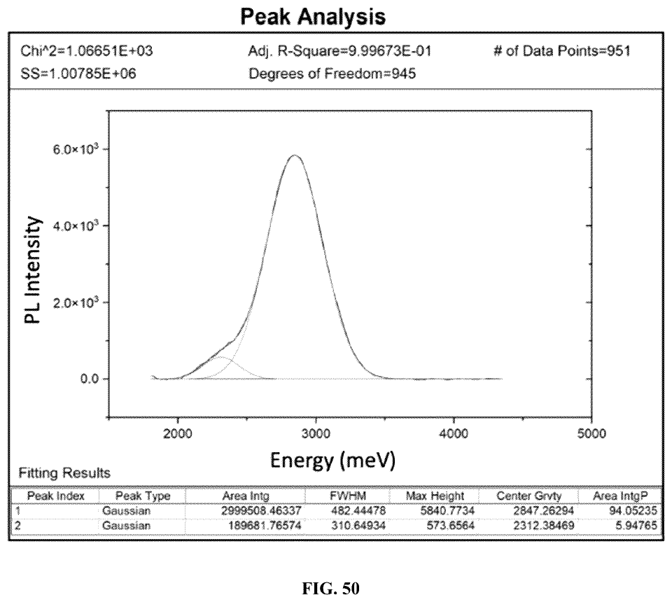

To deconvolve the emission from (18C6@K)₂ZrBr₆ impurities, a two-peak Gaussian fitting was applied to the PL spectrum at each temperature. FIG. 50 shows an example at 4 K. The FWHMs of the (18C6@K)₂HfBr₆ peaks were obtained from the Gaussian fittings and are summarized in table S6. The temperature dependence of the FWHM of the emission peak was modeled using the theory of Toyozawa, which applies a configuration coordinate model to explain the broadening of the emission originating from electron-phonon coupling. The FWHM depends on the Boltzmann constant kB, the effective phonon energy Eₚₕ, the temperature T, and the Huang-Rhys electron phonon coupling parameter S

$$FWHM = 2.36 \sqrt{S} {E}_{ph} \sqrt{coth \frac{{E}_{p h}}{2 {K}_{B} T}} \qquad ( Equation 1 )$$

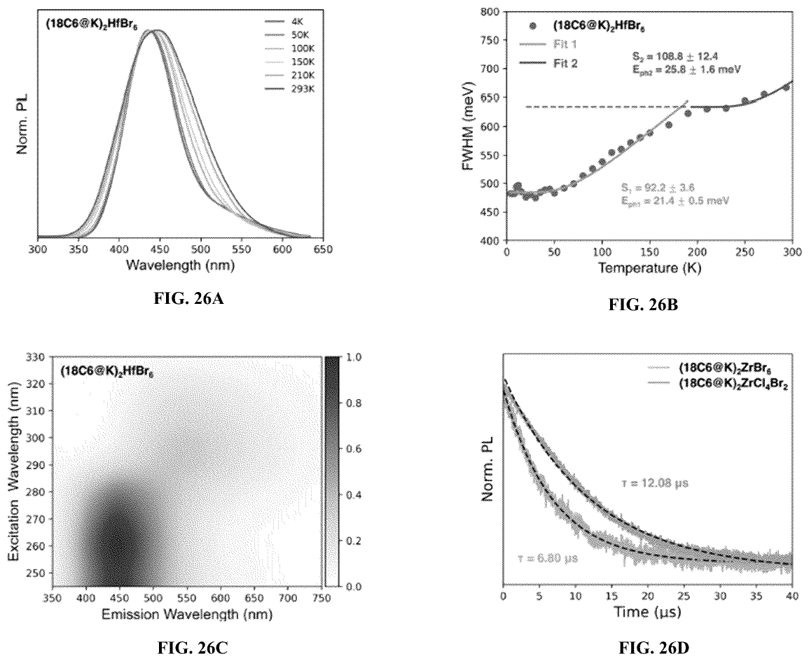

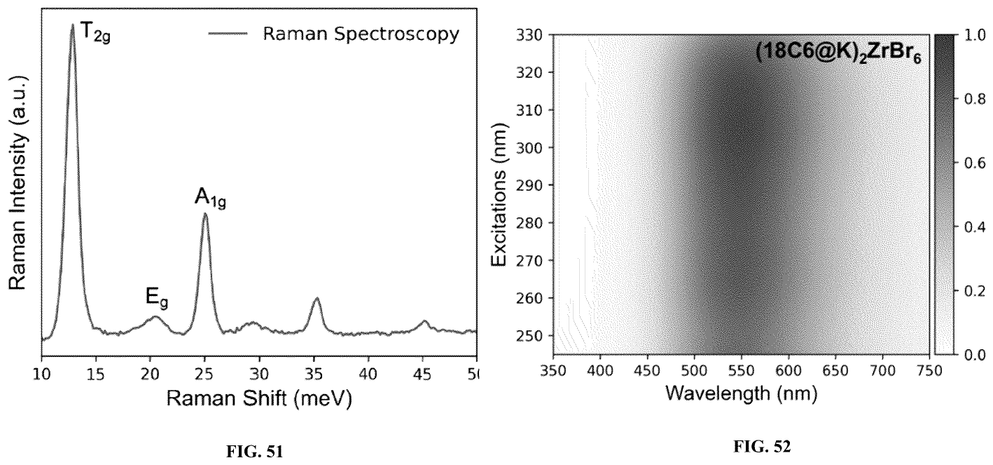

The relation between FWHM and temperature is shown in FIG. 26B. Analyzing the data according to Eq. 1 yielded a coupling factor S₁=92.2±3.6 and an effective phonon energy Eₚₕ₁=21.4±0.5 meV. This phonon mode corresponded to the asymmetric stretching mode (E_{g}) of the [HfBr₆]²⁻ octahedra, which was observed at 20.4 meV (164.5 cm⁻¹) in the Raman spectrum (FIG. 51). However, this phonon mode was only responsible for STE formation up to 190 K. For temperatures >190 K, a higher energy phonon mode dominated STE formation.

Shifting the zero temperature of Eq. 1 by 190 K, a second fit could be obtained with a coupling factor S2=108.8±12.4 and an effective phonon energy Eph2=25.8±1.6 meV. This phonon mode corresponded to the symmetric stretching mode (A_{1g}) of the [HfBr₆]²⁻ octahedra at 25.1 meV (202.5 cm⁻¹). The large Huang-Rhys factor S in both scenarios indicated a very strong electron-phonon coupling in this material. For example, S for CsPbX₃ (where X=Br⁻ or I⁻) is <1, and the S for double perovskite Cs₂AgBiBr₆ is only ˜12 (48). STE behavior is closely related to the octahedra packing dimensionality. Through the supramolecular approach provided herein, the [HfBr₆]²⁻ octahedra were more isolated by the bulky (18C6@K)⁺ complexes, which led to stronger self-trapping with larger S values.

Excitation wavelength-dependent PL mapping of (18C6@K)₂HfBr₆ (FIG. 26C) showed that for excitation wavelengths <285 nm, a broad PL peak at 445 nm emerged. The PL peak position and shape were independent of the excitation wavelength <285 nm. Thus, for above and gap excitation, the emission originated from the relaxation of the same excited state. However, for excitation wavelengths >285 nm, a much weaker PL peak at ˜550 nm replaced the previous PL peak that arose from the ˜0.6 at % (18C6@K)₂ZrBr₆ impurity, and 2D PLE mapping of (18C6@K)₂ZrBr₆ showed a single PL peak at ˜550 nm from 245-nm to 330-nm excitation (FIG. 52).

Time-resolved PL (TRPL) studies on the supramolecular assembled single crystals revealed that the PL decay of the (18C6@K)₂ZrBr₆ could be mostly described by a monoexponential decay profile on the microsecond timescale, with a PL lifetime of 6.80 ms (FIG. 26D and Table 16). By contrast, Cs₂ZrBr₆ bulk crystal featured a triple-exponential PL decay, yielding decay time constants of 40 ns (8.9%), 0.99 ms (24%), and 4.6 ms (68%). Additionally, Cs₂ZrBr₆ nanocrystals showed a double-exponential PL decay with time constants at 0.78 and 4.5 ms. The PLQY was related to both the radiative and nonradiative decay rates [PLQY=k_{rad}/(k_{rad}+k_{nonrad})], so a more sluggish radiative decay did not necessarily correlate to a lower PLQY. Notably, the PLQY of (18C6@K)₂ZrBr₆ powders (49.8%) was greater than that of K₂ZrBr₆ powders (46.3%, from measurement provided herein) and Cs₂ZrBr₆ nanocrystals [˜44%]. This observation suggested that the nonradiative decay rate of the supramolecular sample was slower than that of the vacancy-ordered double perovskite phases and may indicate a lower defect density in the assembled crystals provided herein. The PL decay of the (18C6@K)₂ZrCl₄Br₂ single crystal could also be fit with a single exponential function with an even longer PL lifetime (12.08 ms) (FIG. 26D and Table 17). Cs₂ZrCl₆ had a slightly longer PL lifetime (7.5 ms) compared with that of Cs₂ZrBr₆. This result suggested that the supramolecular material system had a longer PL lifetime and slower nonradiative decay rate.

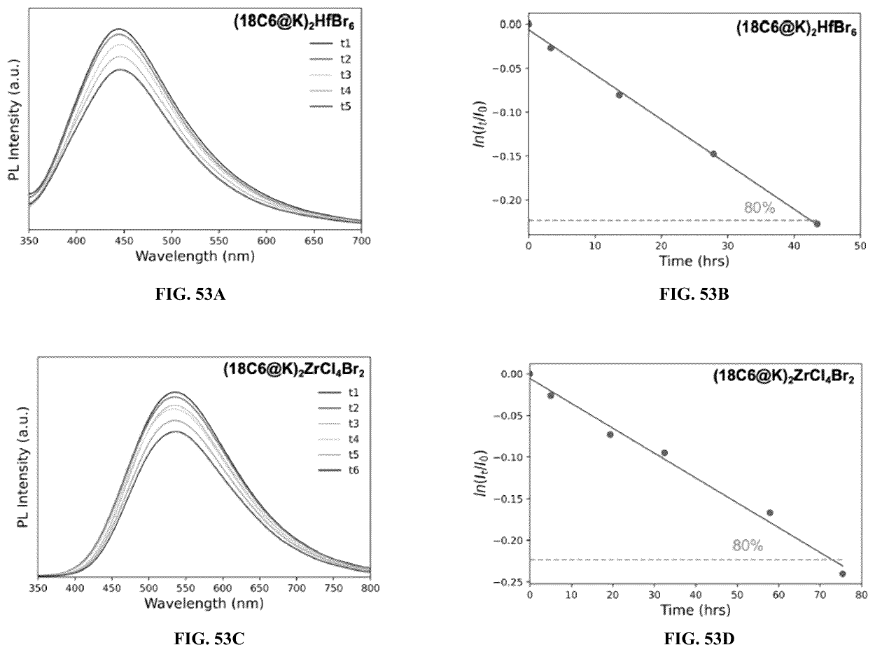

The photostability of these highly emissive blue and green emitters was evaluated. Notably, previous research in the organic light emitting diode (OLED) community has used a xenon lamp to simulate solar irradiation, dissolving Ir complexes in deuterated toluene for reference measurements of green and blue emission (51, 52). To ensure a fair comparison, identical irradiation energy density (62 mW/cm²) and temperature (35° C.) were applied, and deuterated toluene was used to disperse the (18C6@K)₂HfBr₆ and (18C6@K)₂ZrCl4Br2 powders. FIG. 53 shows the PL intensity decay of the (18C6@K)₂HfBr₆ and (18C6@K)₂ZrCl₄Br₂ samples under continuous irradiation. Both decay trends could be accurately described by the integrated rate law for the first-order reaction [1n(Iₜ/I₀)=−kt]. The rate constants of photodegradation were estimated to be 5.1×10⁻³ h⁻¹ and 3.0×10⁻³ h⁻¹ for (18C6@K)₂HfBr₆ and (18C6@K)₂ZrCl₄Br₂, respectively. Notably, even under stringent irradiation conditions, the PL intensities of (18C6@K)₂HfBr₆ and (18C6@K)₂ZrCl₄Br₂ decreased to 80% after 43 and 73 hours, respectively. These findings underscore the superior photostability of the supramolecular assembled samples compared with most Ir complexes, rivaling the best reported green-emitting fac-[Ir(ppy)₃] reference (k=2.6×10⁻³ h⁻¹) (51, 52). Previous studies on the photodegradation of the Ir complexes, such as Ir(ppy)₃ and Ir(piq)₃, have identified singlet oxygen attack and interaction of the excited-state molecule with its local environment as primary degradation pathways.

### Blue-Green Dual-Color Display and 3D Printing

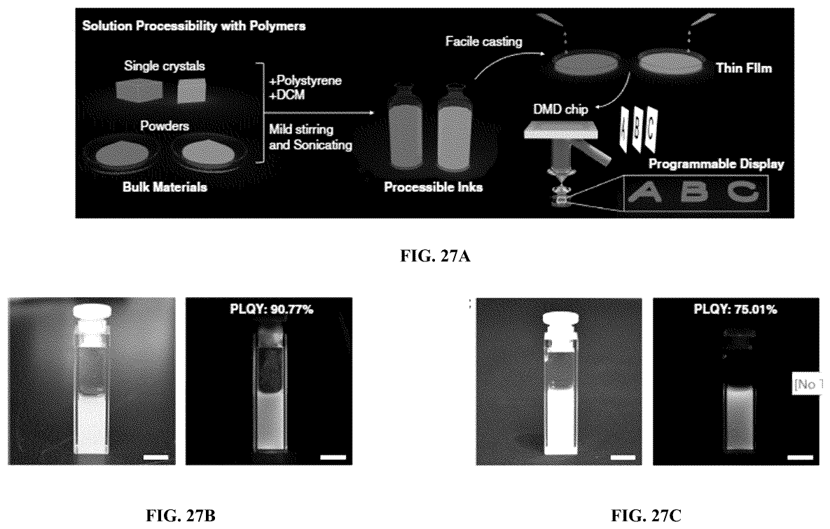

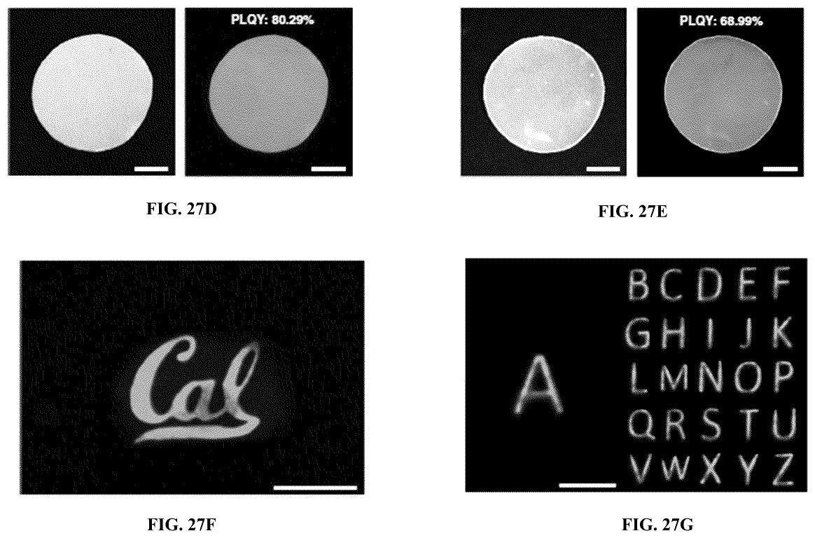

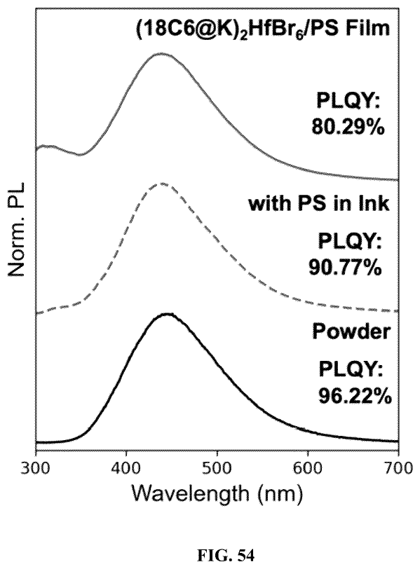

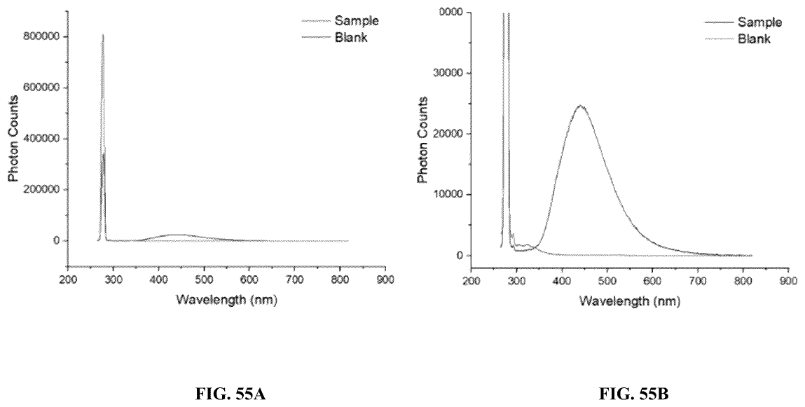

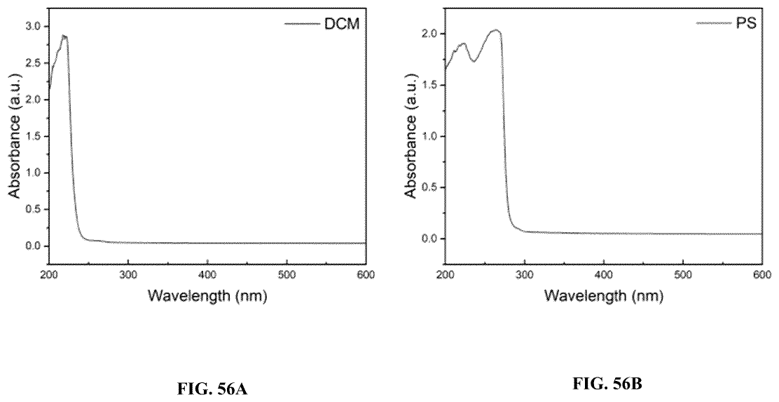

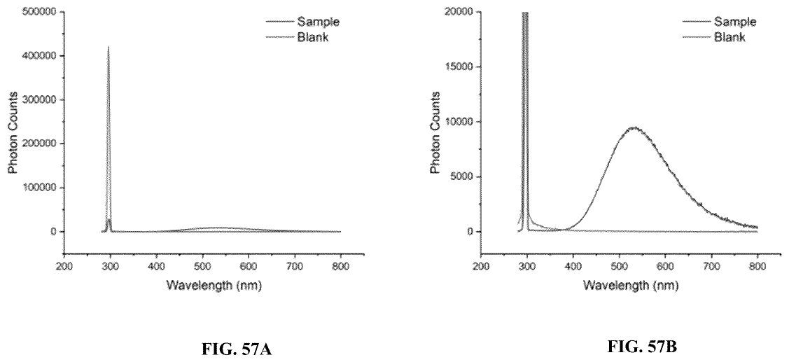

The high PLQY of the blue and green emission colors in the powders were preserved in thin films, which would enable various optoelectronic device applications (54-56). Because the powders were stable in nonpolar organic solvents, they could be evenly dispersed into solution to form inks. DCM was used because its low boiling point (39.6° C.) leads to high volatility for drying films, and PS was added to create inks suitable for drop casting or spin coating by increasing the viscosity (FIG. 27A). The image of (18C6@K)₂HfBr₆/PS ink under a white lamp (FIG. 27B) shows that a uniform white suspension was achieved that exhibited a bright blue emission under 254-nm excitation. The emission was solely from the (18C6@K)₂HfBr₆ powders in the ink because the shape of the PL spectrum was the same as the PL shape of the powders (FIG. 54). The solution PLQY was 90.8% (FIGS. 27B and 55), which was only 5.5% less than the powder PLQY. This reduction was expected because DCM and PS do not absorb strongly in the blue color wavelength region (FIG. 56), and the suspended powders in the ink could cause losses through scattering. The (18C6@K)₂ZrCl₄Br₂/PS ink also preserved the green emission of the (18C6@K)₂ZrCl₄Br₂ powders with a solution PLQY of 75.0% (FIGS. 27C and 57).

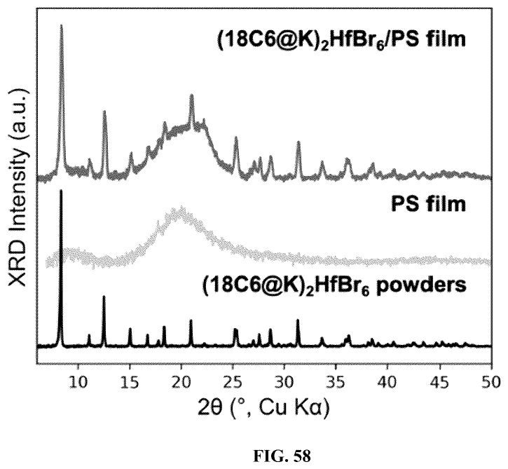

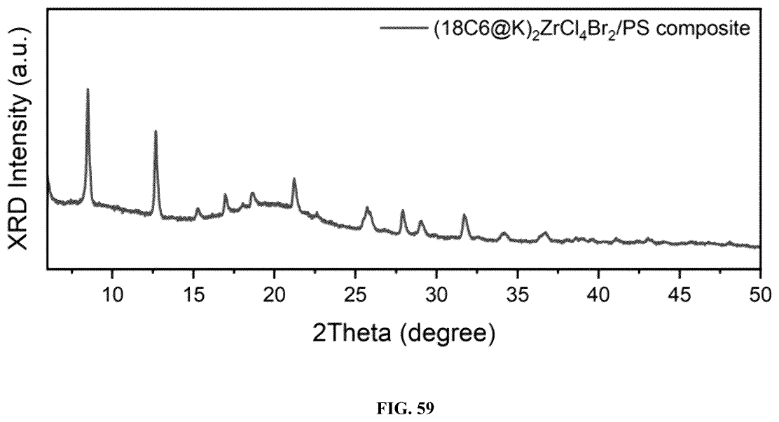

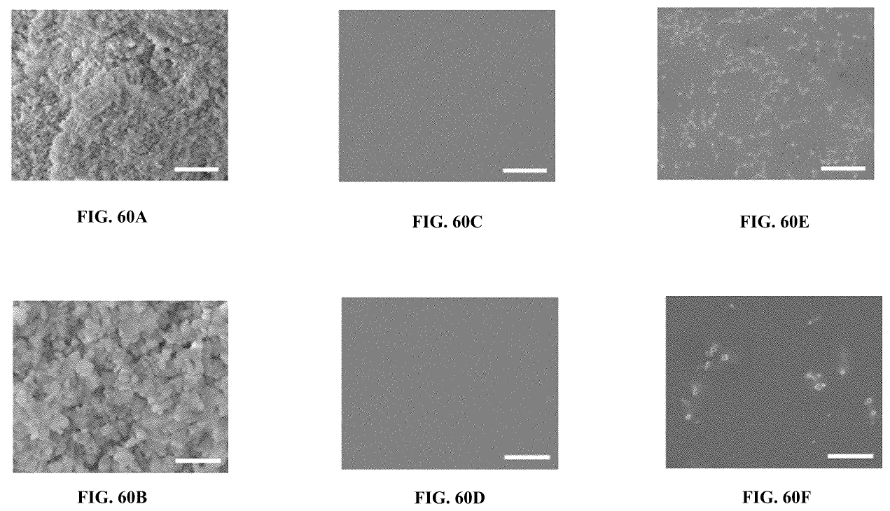

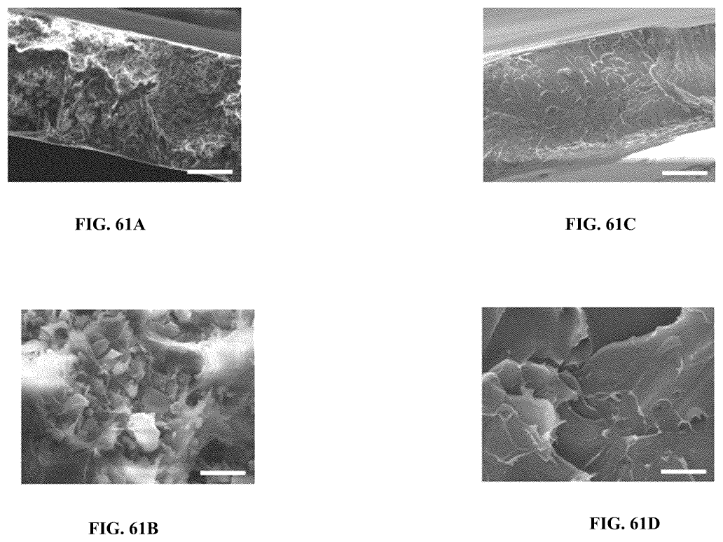

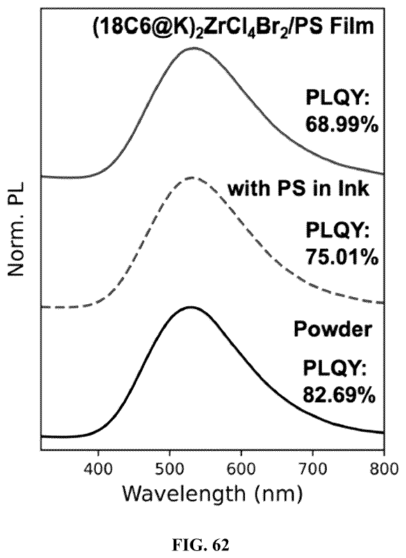

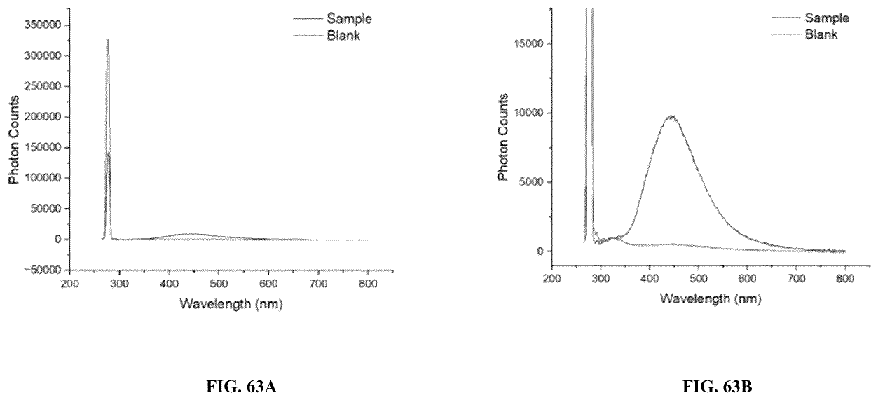

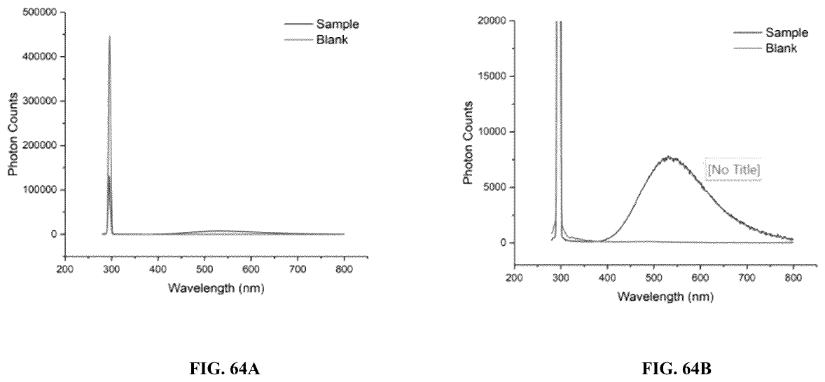

The inks could be drop casted under ambient conditions, and, after rapid solvent evaporation, a uniform thin film forms (FIGS. 27A, 27D, and 27E). PXRD patterns of the (18C6@K)₂HfBr₆/PS composite (FIG. 58) and the (18C6@K)₂ZrCl₄Br₂/PS composite (FIG. 59) showed that the structural integrity of the powders was preserved in the PS matrix. Scanning electron microscopy (SEM) imaging of the (18C6@K)₂HfBr₆ powders and the (18C6@K)₂HfBr₆/PS composite thin-film surface (FIG. 60) indicated that the submicrometer-sized powders were uniformly dispersed. Cross sectional SEM imaging of the thin film (FIGS. 61A-61D) proved the presence and uniformity of the powders across the thin film. Under UV irradiation, (18C6@K)₂HfBr₆/PS and (18C6@K)₂ZrCl₄Br₂/PS composite thin films showed bright blue and green emissions, respectively (FIGS. 27D and 27E). The shapes of the PL spectra of the thin films were the same as those for the powders (FIGS. 53 and 62), and the PLQYs were 80.3% (FIG. 63) and 69.0% (FIG. 64) for blue- and green emitting composites, respectively.

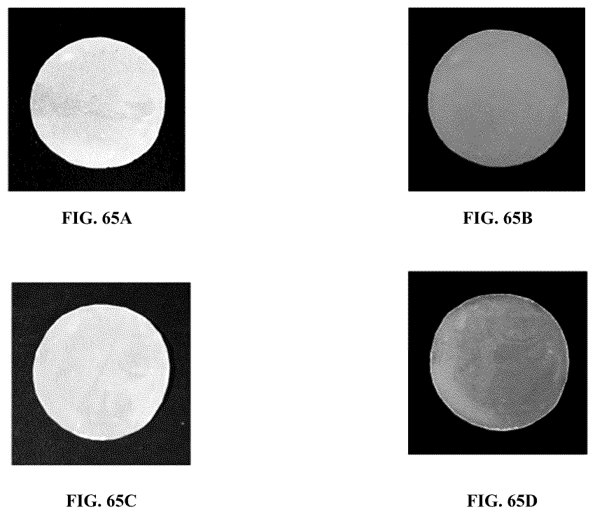

The stability of the air-sensitive Hf and Zr octahedral clusters was further enhanced in the PS polymer composite. Both Cs₂HfBr₆ and Cs₂ZrBr₆ double-perovskite structures are predicted to be thermodynamically unstable in the presence of water and oxygen, and K₂HfBr₆ and K₂ZrBr₆ powders turn from a white to a brownish color after a few minutes of air exposure and became non-emissive. By contrast, the (18C6@K)₂HfBr₆/PS and (18C6@K)₂ZrCl₄Br₂/PS composites maintained their blue and green emission colors, respectively, after 1 month of storage in the air (FIG. 65). The air-stable PS polymers along with the hydrophobic crown ethers could greatly protect the air-sensitive Hf and Zr metal emission centers.

Display applications of the powder-PS composite thin films were explored. A digital mirror device with a pixel resolution of 2560 by 1440 sequentially patterned 250-nm UV light through projection optics onto the (18C6@K)₂HfBr₆/PS composite thin film with a spot size of 6.9 by 3.9 mm at a frame rate of 60 Hz (schematic of the process is illustrated in FIG. 27A). An emissive blue “Cal” logo was illuminated on the thin film with dimensions 3.8 mm in height and 4.7 mm in width (FIG. 27F). The logo exhibited high luminosity characterized by sharply defined edges. To further demonstrate dynamically changing display luminescence, the alphabet sequence (from A to Z) was illuminated onto the thin film with a fast flipping rate (0.1 s per letter). A video of 2.6 s was recorded. Although the duration of each letter was very short, the blue emission with the shape of the letters was sharp and bright, as illustrated in the snapshot photos (FIG. 27G). The size of the letters was only 3.1 mm in width and 3.9 mm in length, but every feature of the letters was clearly visible with similar emission intensity owing to the high uniformity of the thin film. Furthermore, the response time of the display should be fast because the PL decay rate of the (18C6@K)₂HfBr₆ powders was ˜3 orders of magnitude faster than the frame rate of the digital mirror device. The letters switch extremely fast, with no blurring, ghosting, or trailing effects.

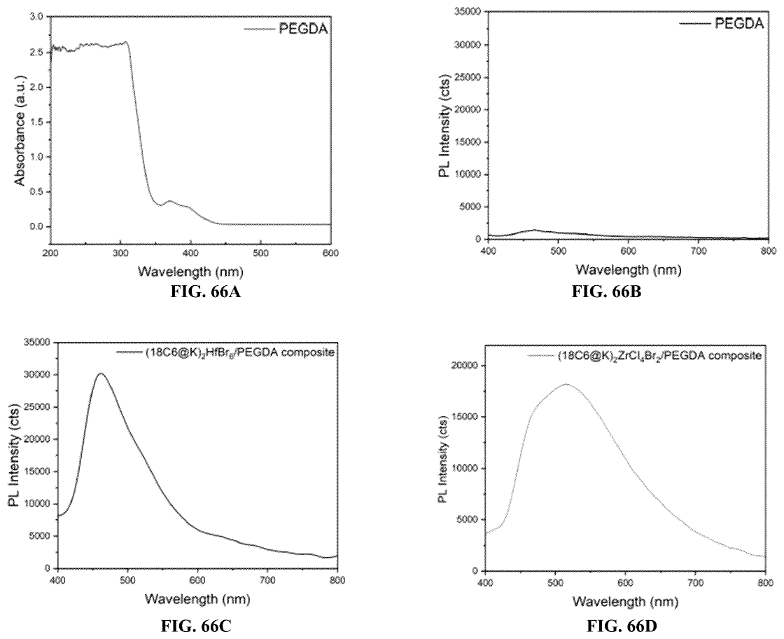

These emissive powders could also be processed with high-resolution 3D printing technologies after blending them uniformly into a monomer resin. Conventional resins for 3D printing typically use dyes as the photoabsorber to control the depth of UV penetration and, consequently, the printing resolution. However, dyes absorb light and color the final printed parts. To avoid interference with the blue and green emitters provided herein, a photoabsorber free resin mainly composed of photomonomer poly(ethylene glycol) diacrylate (PEGDA) was used but with a high content of photoinhibitor to control the printing resolution. The polymerized PEGDA resin exhibited minimal absorption within the visible spectrum, featuring a modest absorption peak from 355 to 425 nm (FIG. 66A). Also, under 250-nm UV excitation, the resin exhibited substantially low emission intensity (FIG. 66B). Hence, the emission colors in the blue and green range of the emitters provided herein remained largely unaffected.

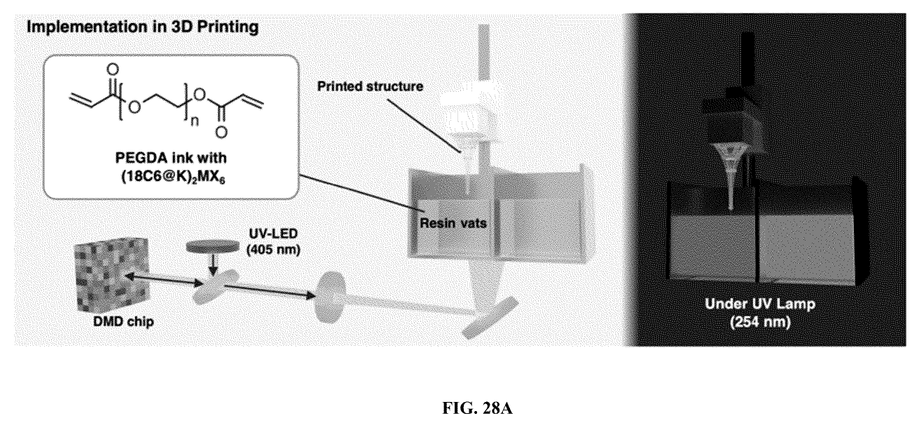

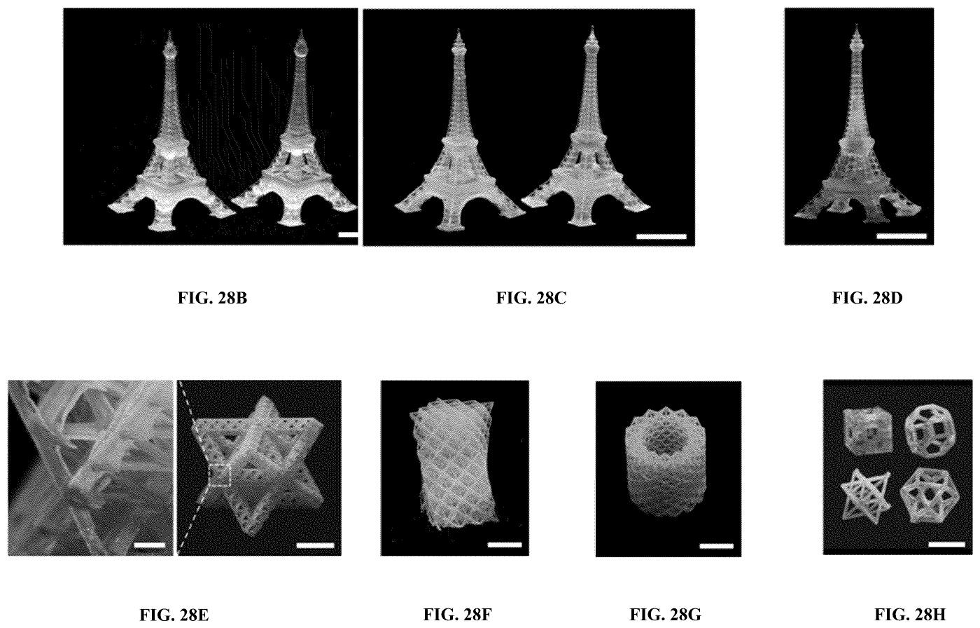

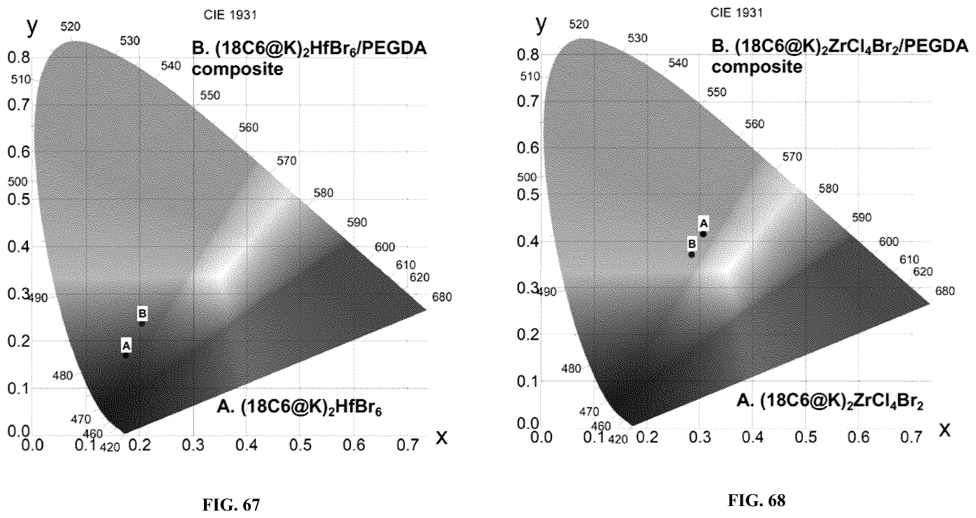

Upon stirring and sonication, the powders were uniformly dispersed into the PEGDA resin. Multimaterial digital light-printing method was used to achieve a 3D assembly of the blue and green emitters into complex macro and microarchitectures. Under 405-nm structured UV light illumination, the resin rapidly converted into solid 3D structures (FIG. 28A). The PL spectra from the (18C6@K)₂HfBr₆/PEGDA and the (18C6@K)₂ZrCl₄Br₂/PEGDA composites were similar to those of the powders (FIGS. 66C, 66D, 67, and 68). The printed architectural models of the Eiffel Tower (FIG. 28B), after excitation at 254 nm, showed their respective blue and green colors (FIG. 28C). The dimensions of the two Eiffel Towers were within a few centimeters, with high-resolution spatial features (FIG. 28A). The submicrometer scale of these powders and a printing layer thickness of 40 mm enabled even distribution throughout each layer and ensured a homogeneous emission color profile across the entire architectural construct.

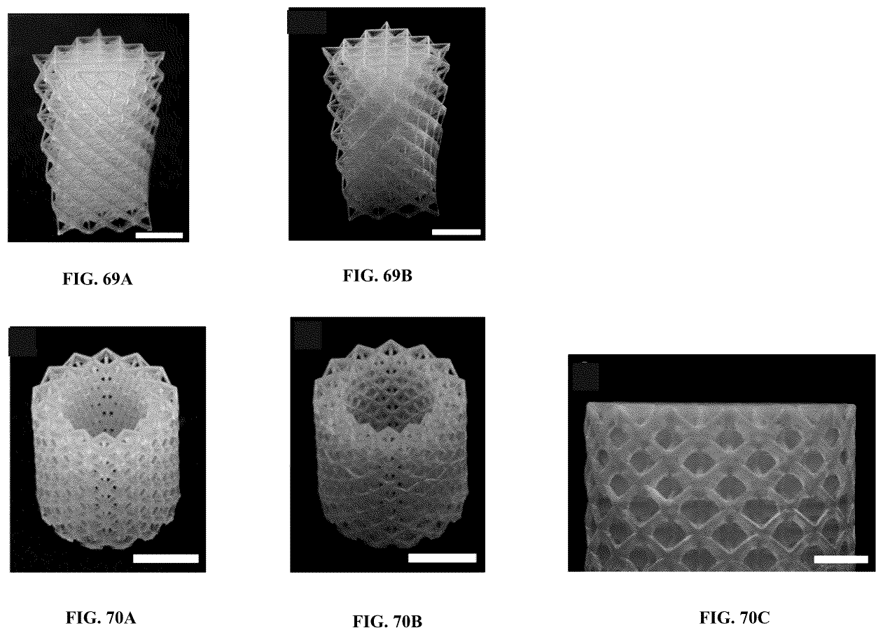

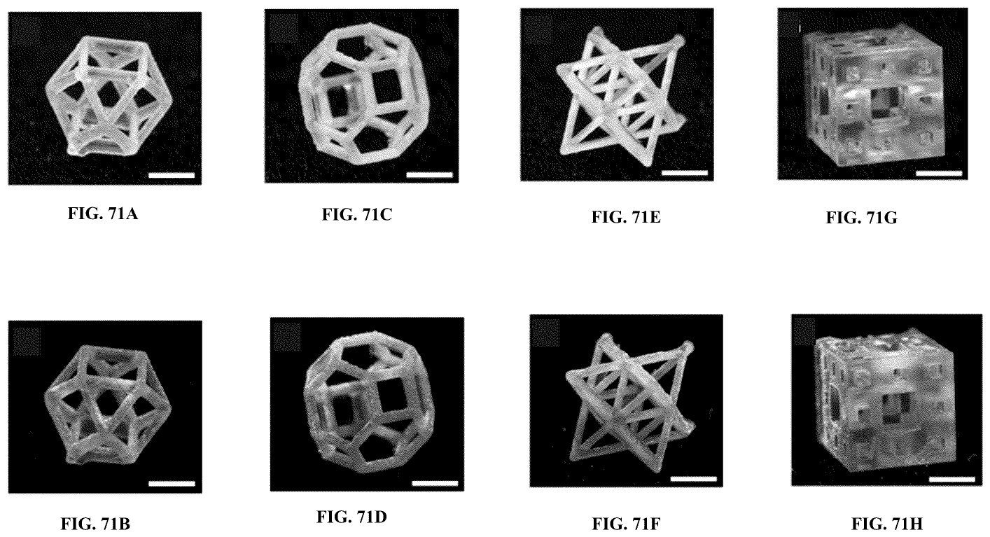

A single 3D-printed structure could also manifest emissions in both blue and green by alternative resins during the printing procedure. An Eiffel Tower design characterized by blue emissions at its upper and lower segments with green emissions in its central region is shown in FIG. 28D, and a second-order hierarchical lattice structure (octet truss) was realized with one half radiating in blue and the other in green (FIG. 28E). Notably, a close-up view of the boundary between these blue- and green emitting regions within the octet truss structure revealed the high precision in color transition without any color crossover on either side. Twisted (FIGS. 28F and 69) and conformal (FIGS. 28G and 70) octet truss architectures with dual emissions were also achieved with bright emissions and high structural accuracy. Other complex topologies, such as cuboctahedron, tetrakaidecahedron, octet truss, and Menger sponge with the blue emitter embedded (FIGS. 28H, 71, and 72), were also obtained to exhibit the variety of structures that could be printed with the light emitting ink. These demonstrations served as a proof of concept for integrating emissive ionic powders with 3D printing technology. The potential applications of 3D-printed light emitting structures are extensive and constantly evolving, ranging from intricate interior ambient-lighting solutions to seamless integration into wearable devices.

### SUMMARY

A supramolecular assembly strategy was demonstrated for achieving halide perovskite blue and green emitters with ultrahigh PLQYs. Specifically, (18C6@K)₂HfBr₆ warranted a blue emission with a near-unity (96.2%) PLQY, and (18C6@K)₂ZrCl4Br₂ showed a green emission with a PLQY of 82.7%. The emission of the supramolecular assembled samples originated from the STE emission, with strong electron phonon coupling and microsecond PL lifetimes. The supramolecular approach is very promising for solution processability. The (18C6@K)₂HfBr₆/PS-DCM ink maintained a high PLQY of >90%. Uniform thin films were fabricated from this ink through a drop-casting technique. The (18C6@K)₂HfBr₆/PS composite had blue emission with a PLQY of >80%, making it favorable for patterning, display, and printing applications. The powders with blue and green emissions were also highly compatible with the 3D printing technology. The supramolecular assembly approach for halide perovskite building block catalyzes further investigation into the synthesis and characterization of supramolecular assembled functional materials, laying the foundation for substantial progress in the field.

### Materials and Methods

Chemicals. 18-crown-6 (18C6, 99%, Sigma Aldrich), KBr (99%, Sigma Aldrich), HfBr₄ (anhydrous, 98% (99.7%-Hf), Strem Chemicals), ZrBr₄ (99%, Alfa Aesar), acetonitrile (ACN, Fisher Chemical), diethyl ether (DEE, Sigma Aldrich), dichloromethane (DCM, Fisher Chemical), polystyrene (PS, average Mw˜192000, Sigma Aldrich), toluene-d8 (99%, Sigma Aldrich), photo monomer poly(ethylene glycol) diacrylate (PEGDA, Mn 250, Millipore Sigma), photo initiator phenylbis(2,4,6-trimethylbenzoyl)phosphine oxide (Millipore Sigma), and inhibitor 4-methoxyphenol (Millipore Sigma) were used as received without further purification or modification. 18C6, KBr, HfBr₄, and ZrBr₄ were stored in an argon glovebox with O₂ and H₂O level below 0.5 ppm.

Synthesis of K₂HfBr₆ and K₂ZrBr₆ powders. KBr and HfBr₄ or ZrBr₄ precursors with molar ratio 1:2 were measured and mixed into a grinder in an argon glovebox. The precursors were vigorously grinded for 10 minutes and then transferred into a 20 ml glass vial. They were heated on a hot plate in the glovebox at 200° C. for 1 h. The powder mixture was grinded again for 10 minutes, and then heated for another 1 h at 200° C. The grinding and heating procedure were repeated for five times until all the KBr had reacted with HfBr₄ or ZrBr₄ according to inert atmosphere x-ray diffraction. Then the powder mixture was heated at 500° C. for 10 minutes to evaporate all the surplus HfBr₄ or ZrBr₄ precursors.

Synthesis of (18C6@K)₂HfBr₆ and (18C6@K)₂ZrBr₆ powders and single crystals. 18C6, KBr, and HfBr₄ or ZrBr₄ precursors with molar ratio 2:2:1 were weighed in the glovebox and transferred out into atmosphere using a 20 ml glass vial. The precursors were completely dissolved under 80° C. with vigorous stirring in ACN within 30 minutes. To obtain (18C6@K)₂HfBr₆ and (18C6@K)₂ZrBr₆ powders, 10 ml precursor solution was added into 30 ml DEE in a 50 ml centrifuge tube. White powders immediately formed upon the mixture of the two solutions. The powders were separated using centrifugation. The centrifugation speed was 5000 rpm, and the duration was 5 minutes. The powders were washed with DEE for three times and dried in vacuum at room temperature overnight. (18C6@K)₂HfBr₆ and (18C6@K)₂ZrBr₆ single crystals were grown using an anti-solvent diffusion method. 1 ml of the abovementioned precursor solution was added into a 4 ml vial, which was placed into a 20 ml vial with 4 ml of DEE. After approximately two days, single crystals were formed on the bottom and the wall of the 4 ml vial. Single crystals were washed 3 times with DEE and dried in vacuum at room temperature overnight. Powders and single crystals were stored in an argon glovebox with O₂ and H₂O level below 0.5 ppm for future use.

Synthesis of (18C6@K)₂ZrClxBr₆₋ₓ powders and single crystals. 18C6, KCl, KBr, ZrCl4 and ZrBr₄ precursors with molar ratio 12:2x:12−2x:x:6−x were weighed in the glovebox and transferred out into atmosphere using a 20 ml glass vial. The precursors were completely dissolved under 80° C. with vigorous stirring in ACN within 30 minutes. To obtain (18C6@K)₂ZrCl₆₋ₓBrₓ powders, 10 ml precursor solution was added into 30 ml DEE in a 50 ml centrifuge tube. White powders immediately formed upon the mixture of the two solutions. The powders were separated using centrifugation. The centrifugation speed was 5000 rpm, and the duration was 5 minutes. The powders were washed with DEE for three times and dried in vacuum at room temperature overnight. (18C6@K)₂ZrCl₄Br₂ single crystal was grown 3 using an anti-solvent diffusion method. 1 ml of the abovementioned precursor solution was added into a 4 ml vial, which was placed into a 20 ml vial with 4 ml of DEE. After approximately two days, single crystals were formed on the bottom and the wall of the 4 ml vial. Single crystals were washed 3 times with DEE and dried in vacuum at room temperature overnight. Powders and single crystals were stored in an argon glovebox with O₂ and H₂O level below 0.5 ppm for future use.

Synthesis of (18C6@K)₂HfBr₆/PS in DCM and (18C6@K)₂ZrCl₄Br₂/PS in DCM inks. 100 mg PS was fully dissolved in 5 ml DCM with a stir bar in a 20 ml vial at room temperature. 50 mg (18C6@K)₂HfBr₆ or (18C6@K)₂ZrCl₄Br₂ powders were added into the abovementioned PS/DCM solution, then alternatively stirred and sonicated for 4 hours at room temperature to achieve a uniform suspension. The inks for PLQY measurements were diluted with DCM to achieve a 0.3 absorbance to guarantee an accurate solution PLQY determination.

Synthesis of (18C6@K)₂HfBr₆/PS and (18C6@K)₂ZrCl₄Br₂/PS composite thin films. The composite thin films were synthesized from direct drying of the inks in a glass petri dish at room temperature in the air. The dried thin films were then peeled off from the petri dish and cut into a round shape.

Scanning electron microscopy (SEM) with standard secondary electron imaging. Prior to imaging, the thin film samples were sputtered with ˜5 nm of Au (Denton Vacuum, Moorestown, NJ). The samples were imaged at 15 kV/high probe current by Benchtop SEM (JCM-7000, Tokyo, Japan).

Scanning electron microscopy with energy dispersive x-ray (SEM/EDX) spectroscopy. Prior to imaging, the single crystal samples were sputtered with ˜5 nm of Au (Denton Vacuum, Moorestown, NJ). A field-emission SEM (FEI Quanta 3D FEG SEM/FIB) and the EDX detector were used to determine elemental ratios at the QB3-Berkeley Biomolecular Nanotechnology Center (BNC).

Inductively coupled plasma atomic emission spectroscopy (ICP-AES). ICP-AES results were collected using a Perkin Elmer ICP Optima 7000 DV Spectrometer at the Microanalytical Facility in College of Chemistry, UC Berkeley.

Single-crystal x-ray diffraction (SCXRD). The SCXRD data were collected at the Small Molecule X-ray Crystallography Facility (CheXray) in College of Chemistry, UC Berkeley. SCXRD were measured with a Rigaku XtaLAB P200 instrument equipped with a MicroMax-007 HF microfocus rotating anode and a Pilatus 200K hybrid pixel array detector using monochromated Cu Kα radiation (λ=1.54184 A) or Mo Kα radiation (λ=0.71073 A). All crystal datasets were collected at room temperature (298 K). CrysAlisPro (61) was used for data collection and data processing, including a multi-scan absorption correction applied using the SCALE3 ABSPACK scaling algorithm within CrysAlisPro. Using Olex2 (62), the structures were solved with the SHELXT (63) structure solution program using Intrinsic Phasing and refined with the SHELXL (64) refinement package using Least Squares minimization. Due to the occupation of disordered solvent molecules in the crystal voids, solvent masks were used during the refinement. All reflections where [error/esd]>5 4 were omitted, as the existence of disordered molecules will result in high error/esd values in low d-spacing diffractions.

Ambient condition powder x-ray diffraction (PXRD). PXRD data of (18C6@K)₂HfBr₆ powders, (18C6@K)₂ZrBr₆ powders, (18C6@K)₂HfBr₆/PS composite, and (18C6@K)₂ZrCl₄Br₂/PS composite were collected using a Bruker D8 laboratory diffractometer with a Cu Kα radiation source in ambient condition.

Inert atmosphere PXRD. PXRD of K2HfBr₆ and K₂ZrBr₆ powders were collected using a Rigaku Miniflex 6G Benchtop Powder XRD with a Cu Kα radiation source and an inert atmosphere sample holder. The powder samples were loaded onto the sample holder inside an argon glovebox with O₂ and H₂O level below 0.5 ppm.

Raman spectroscopy. The Raman spectra of all the samples were measured by a confocal Raman microscope system (Horiba LabRAM HR800 Evolution). The powders were dispersed onto glass microscope slides for measurement. A continuous-wave (cw) 632.8-nm laser was focused onto a crystal facet at a constant power density set by neutral density filters. The Raman signal from the sample was collected using a microscope objective in a backscattering geometry (100×, NA 0.6). High-resolution Raman spectra were measured with a charge-coupled device (CCD) detector equipped with a diffraction grating of 1800 gr/mm and a long pass filter (100 cm⁻¹) to remove the Rayleigh scattering line from the signal.

Photoluminescence spectroscopy (PL) and photoluminescence quantum yield (PLQY). PL and PLQY measurements were collected with the FS5 Spectrofluorometer (Edinburgh Instruments) using the SC-30 integrating sphere. The powders were densely packed onto the sample holder and then the surface was flattened for measurement. A 150 W continuous-wave ozone-free xenon lamp was focused onto the sample. (18C6@K)2HfBr6 and K2HfBr₆ were excited at 275-nm excitation wavelength. (18C6@K)₂ZrBr₆ and K₂ZrBr₆ were excited at 290-nm excitation wavelength. (18C6@K)₂ZrCl₃Br₃, (18C6@K)₂ZrCl₄Br₂, and (18C6@K)₂ZrCl_{4.5}Br_{1.5} were excited at 295-nm excitation wavelength. The PL signal from the sample was collected by a UV-enhanced Si photodiode array equipped with a diffraction grating of 1200 gr/mm. The PLQY values were determined by the PLQY determination wizard of the Fluoracle (version 2.15.2) operating software for the FS5 Spectrofluorometer. PL and PLQY measurements of the PS polymer composite samples were measured with the free-standing composite films. PL and PLQY measurements of the DCM ink samples were measured using a quartz cuvette as the sample holder.

Low-temperature photoluminescence spectroscopy (Low-T PL). The low-T PL measurements were collected with a home-built PL microscope system. Powder samples were dispersed onto mica substrates for measurement. A broadband deuterium lamp (Thorlabs SLS204 Stabilized Deuterium Lamp) was filtered down to a 250 nm excitation line using a bandpass filter (250 nm/10 nm). The 250 nm excitation line was focused obliquely onto the sample with a constant power density. The PL signal from the sample was collected using a microscope objective (50×) coupled to a long pass filter (cut-on wavelength: 325 nm) to remove the excitation line from the signal. PL spectra were collected with a Si charge-coupled device 5 (CCD) detector cooled to −120° C. via liquid nitrogen and equipped with a diffraction grating of 150 gr/mm. The low-T (4 K to 293 K) PL measurements were performed in a Janis ST-500 SuperTran continuous flow cryostat system attached to the home-built PL microscope system. Liquid gallium-indium eutectic (Ga 75.5%/In 24.5%, ≥99.99% trace metals basis) was used to adhere samples to the cryostat stage, and the cryostat chamber was placed under vacuum with a continuous flow of liquid helium (LHe). A temperature controller as used to monitor the cryostat stage temperature and maintain it at the desired temperature.

Photoluminescence excitation spectroscopy (PLE). PLE measurements were collected with the FS5 Spectrofluorometer (Edinburgh Instruments) using the SC-30 integrating sphere. Powders were densely packed onto the sample holder and then the surface was flattened for measurement. A 150 W continuous-wave ozone-free xenon lamp created a wide range of excitation wavelengths that were focused onto the sample.

Chromaticity determination. The CIE 1931 chromaticity diagrams for all the samples were determined using the Fluoracle (version 2.15.2) operating software for the FS5 Spectrofluorometer from the corresponding PL spectra.

UV-visible (UV-vis) absorption spectroscopy. The absorption spectra for all the samples were measured by a UV-vis spectrophotometer (Shimadzu UV-2600). Data was collected in absorption mode over a wavelength range of 200 nm and 900 nm with a medium scanning rate.

Time-resolved photoluminescence spectroscopy (TRPL). Single crystals were placed and pressed onto a double-sided copper tape supported by a quartz slide. The (18C6@K)₂ZrCl₄Br₂ single crystal sample was excited at 310 nm, and the (18C6@K)₂ZrBr₆ single crystal sample was excited at 330 nm. The rep. rate of the excitations was 7.6 kHz (˜135 μs between pulses. ˜250 fs pulse) and the PL was separated from the residual excitations using two color glass filters (CS #: 3-70). A photomultiplier tube (PMT) (Hamamatsu-R9110) biased at 2 kV was used as the detector. The PMT output was read using a 300 MHz oscilloscope, each trace was averaged 512 times.

Photodegradation tests. (18C6@K)₂HfBr₆ and (18C6@K)₂ZrCl₄Br₂ powders were dispersed in toluene-d8 in an argon glovebox with O₂ and H₂O level below 0.5 ppm, and 3 ml of the suspension was transferred into a UV quartz cuvette with a septum screw cap. Parafilm was wrapped around the cuvette cap to create a tight seal. A stir bar was placed inside the cuvette to stir the suspension during the entire irradiation. The suspensions were irradiated with a simulated solar irradiation at 62 mW/cm² and 35° C. The light source used was a 300 W xenon lamp calibrated with a thermopile (MKS Newport 919P-040-50) to make sure 62 mW/cm2 were delivered to the suspensions. The suspensions were placed on a hot plate at 35° C. and under stirring of 1000 rpm. The PL spectra of the samples were measured with the FS5 Spectrofluorometer (Edinburgh Instruments) using the SC-30 integrating sphere. The PL spectra of the (18C6@K)₂HfBr₆ sample were measured at 275-nm excitation under constant excitation power. The PL spectra of the (18C6@K)₂ZrCl₄Br₂ sample were measured at 295-nm excitation under constant excitation power.

2D display on thin film. (18C6@K)₂HfBr₆/PS thin film was illuminated at a 250-nm wavelength (high-power UV LED with ball lens, 250 nm, LED250J, Thorlabs) through structured UV light using a digital light modulator (digital mirror device, pixel resolution 2560×1440). The structured UV light with programmed digital patterns was sequentially patterned through projection optics onto the thin film at a spot size of 6.9 by 3.9 mm at a frame rate of 60 Hz. The thin film instantly displayed patterned images which were recorded through a digital camera.

Printing of light emitting 3D micro-architectures. A photo-absorber-free resin comprised of photo monomer PEGDA, photo initiator phenylbis(2,4,6-trimethylbenzoyl)phosphine oxide (0.5 wt. % of PEGDA), and inhibitor 4-methoxyphenol (1.2 wt. % of PEGDA) was applied. (18C6@K)₂HfBr₆ and (18C6@K)₂ZrCl₄Br₂ powders were blended into the photo-absorber-free resin in a 5 mg/g ratio using vortex and bath sonication for 15 min. The inhibitor in high content is required to control the UV penetration depth and ensure the printing resolutions in the absence of photo absorbers. Upon 405-nm UV exposure (light intensity ˜7 mW/cm²), the photo-absorber-free resin was rapidly converted into solid 3D structures.

Density functional theory (DFT) calculations. The electronic band structures of (18C6@K)₂HfBr₆, K₂HfBr₆, (18C6@K)₂ZrBr₆, and K₂ZrBr₆ were calculated by DFT calculations with the CASTEP (65) code implemented in the Materials Studio 2020. The norm conserving pseudopotential (66) was applied for electron interactions in metal halides. All three structures models were imported from CIF files, and the geometry optimization has been applied with PBE−GGA (67). A fine frame was chosen for energy cutoffs and calculation quality. Electronic band structures and partial density of states (pDOS) were calculated with PBE+GGA without spin-orbital coupling (SOC).

### Example 3: Supramolecular Assembly of Halide Perovskites Having a 1D Chain Structure

Supramolecular Assembled Manganese Halide Green Emitter with Over 80% PLQY and Narrow FWHM

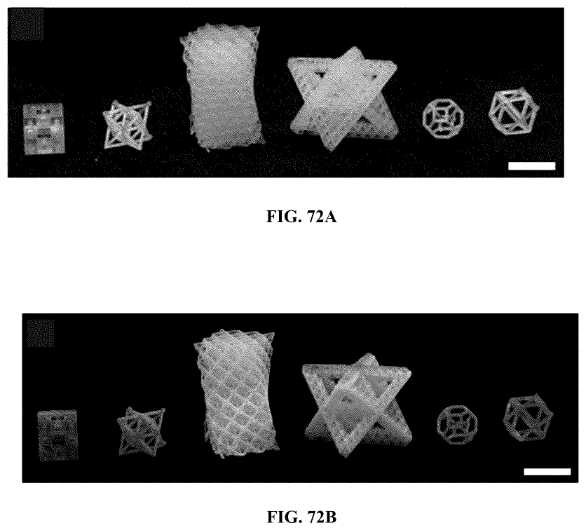

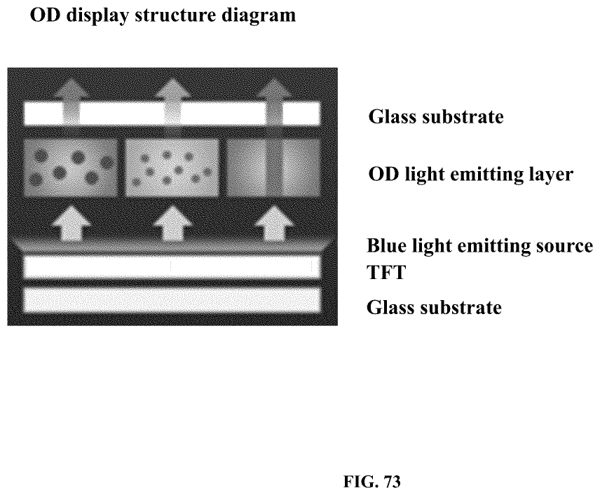

Green emitters play a pivotal role in modern display technologies. Displays harness a blend of red, green, and blue (RGB) emitting materials to achieve the rich spectrum of colors in each pixel. For instance, in quantum dot LED (QLED) displays, a blue light serves as the emitting source, with quantum dots converting this light into both red and green hues (FIG. 73). In identifying the optimal green light-emitting materials, several key criteria are very important: (1) a high photoluminescence quantum yield (PLQY) ensures high brightness and energy efficiency; (2) a narrow full width at half maximum (FWHM) fosters color purity, facilitating the vivid and precise hues; and (3) the material must be readily excitable by blue light, ensuring seamless integration within the display structure.

Crown ether-assisted supramolecular assembly approach provided herein can enable a facile solution-based synthesis of a new green emitter that satisfies all the abovementioned criteria. [MnBr₄]²⁻ complexes are assembled into a new (18C6@Ba)MnBr₄ crystal structure. For the synthesis, a clear precursor solution was obtained with acetonitrile (ACN) at 80° C. with the concentration of 10 mM for 18C6, BaBr₂ and MnBr₂. (18C6@Ba)MnBr₄ powders and single crystals were grown using the similar diethyl ether-assisted anti-solvent crystallization method as before. The crystal structure of (18C6@Ba)MnBr₄ was determined from single-crystal x-ray diffraction (SCXRD). (18C6@Ba)MnBr₄ crystallized in the R3 space group with lattice parameters of a=14.2087 Å and c=9.8911 Å (FIGS. 74A-74D, Table 20).

In the crystal structure, the [MnBr₄]²⁻ complexes and the (18C6@Ba)²⁺ complexes are alternatingly connected into a linear chain, and the chains then packed into a hexagonal crystal structure. One side of the Ba atom is coordinated with one Br atom, and the other side is coordinated with three Br atoms. This configuration enables the strong structural stability of the [MnBr₄]²⁻ complexes, as demonstrated by the near perfect tetrahedral shape of the [MnBr₄]²⁻ complexes. This has great implications on the emission color of the [MnBr₄]²⁻ complexes.

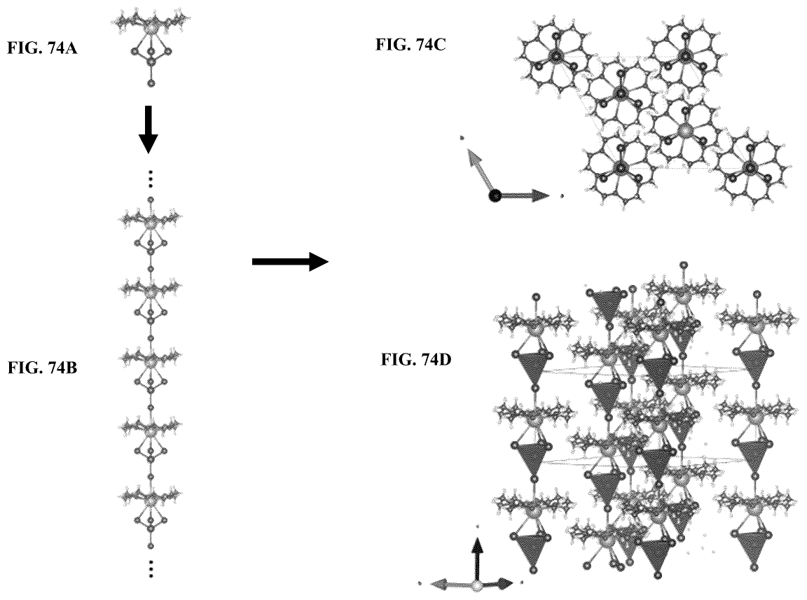

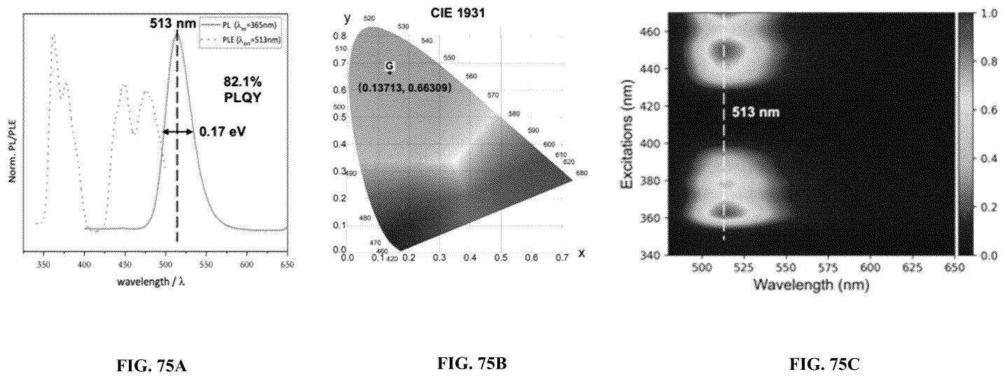

Detailed optical property measurement of this new material was conducted. (18C6@Ba)MnBr₄ has a green emission centered at 513 nm. The emission intensity is very strong, and the PLQY is 82.1%. Due to the high stability of the [MnBr₄]²⁻ complexes in the crystal structure, it has a very narrow emission peak (FWHM=0.17 eV) (FIG. 75A). The PL spectrum and the PLQY value showed in FIG. 75A is measured using 365 nm and 449 nm excitation, respectively. FIG. 75B shows the emission color of (18C6@Ba)MnBr₄ on the CIE 1931 chromaticity diagram. The color is close to the boundary of the diagram, meaning the purity of the green color is high. Furthermore, the green emitter can be readily excited by blue light. The photoluminescence excitation (PLE) spectrum shows that blue light from ˜425 nm to ˜475 nm can excite the material. FIG. 75C illustrates the 2D PLE of (18C6@Ba)MnBr₄. It further confirms that both UV and blue light can excite the material, and the PL peaks generated from both excitations remain the same (centered at 513 nm).

The (18C6@A)MX₄ (A²⁺=alkaline earth metal cation, M²⁺=transition metal cation, X⁻=halide anion) crystal structure can be expanded to a variety of compositions. The X site can be tuned from Br to Cl (Tables 19, 20), and the M site can be changed from Mn to Ni (Tables 19, 21).

### Expansion of the 1D Chain Structure

Expanding along the crown ether/metal halide complex alternating 1D chain structure, a novel structure that also encompasses the 5-halide-coordinated metal halide complex: (18C6@Ba)SbCl₅ has been discovered. The synthetic method of this new compound is very similar to (18C6@Ba)MnBr₄. ACN is applied as the solvent to dissolve a stoichiometric ratio amount of 18C6, BaCl₂, and SbCl₃ precursors, and DEE is used as the anti-solvent. Upon crystallization, [SbCl₅]²⁻ complexes are assembled into a similar linear chain structure facilitated by (18C6@Ba)²⁺ (FIGS. 76A, 76B). The Ba²⁺ in the crown ether is disordered. Half of the cation is located above the crown ether, while the other half is below the crown ether, and the crown ether is the mirror plane for the two parts. The [SbCl₅]²⁻ complexes are also disordered, and the 5 Cl atoms occupy 6 octahedral coordination sites of the Sb atom, each with 5/6 possibility. The alternating linear chains are then assembled into a rhombohedral crystal structure with R-3 space group. This high symmetry space group guarantees the linearity of the 1D chains (FIGS. 76C, 76D, Table 21).

The expansion of the composition leads to the discovery of more emission colors. (18C6@Ba)SbCl₅ has a strong orange emission at 639 nm using 375-nm excitation (FIG. 76E). Under confocal microscope, the belt-shape (18C6@Ba)SbCl₅ single crystal is transparent under white light, and it has a uniform orange emission under 375-nm excitation. This result demonstrates that a family of new materials can be achieved, and the crown ether/metal halide complex linear chain structure have rich optical properties.

TABLE 20
Crystallographic tables for (18C6@Ba)MnBr₄ and (18C6@Ba)MnCl₄

| Crystal | (18C6@Ba)MnBr₄ | | (18C6@Ba)MnCl₄ | |
|---|---|---|---|---|
| ICSD Number | 2363488 | | 2363487 | |
| Empirical formula | C12H24BaBr4MnO6 | | C12H24BaC14MnO6 | |
| Formula weight | 776.20 | | 598.39 | |
| Temperature/K. | 100 | | 100 | |
| Crystal system | trigonal | | trigonal | |
| Space group | R3 | | R3 | |
| a/Å | 14.0618(2) | | 13.9014(8) | |
| b/Å | 14.0618(2) | | 13.9014(8) | |
| c/Å | 9.8513(1) | | 9.4665(5) | |
| α/º | 90 | | 90 | |
| β/° | 90 | | 90 | |
| γ/º | 120 | | 120 | |
| Volume/Å³ | 1686.964800 | | 1584.3(2) | |
| Z | 3 | | 3 | |
| p_{calc}mg/mm³ | 2.292 | | 1.882 | |
| μ/mm⁻¹ | 26.625 | | 2.979 | |
| F(000) | 1095 | | 879 | |
| Crystal size/mm³ | 0.14 × 0.13 × 0.12 | | 0.142 × 0.124 × 0.103 | |
| Radiation | Cu Kα (λ = | 1.54184 Å) | Cu Kα (λ = | 1.54184 Å) |
| 2Θ range for data | 5.7380° to 77.9410° | | 3.9670° to 30.0570° | |
| collection | | | | |
| Index ranges | −17 ≤ h ≤ 16, | | −16 ≤ h ≤ 19, | |
| | −17 ≤ k ≤ 17, | | −18 ≤ k ≤ 19, | |
| | −12 ≤ l ≤ 12 | | −12 ≤ l ≤ 12 | |
| Reflections | 12094 | | 4213 | |
| collected | | | | |
| Independent | 1602[R(int) = | 0.0457] | 1664[R(int) = | 0.0348] |
| reflections | | | | |
| Data/restraints/ | 1602/1/74 | | 1664/1/74 | |
| parameters | | | | |
| Goodness-of-fit | 1.061 | | 0.499 | |
| on F² | | | | |
| Final R indexes | R₁ = | 0.0191, | R₁ = | 0.0203, |
| [ I >= 2σ (I)] | wR₂ = | 0.0512 | wR₂ = | 0.0572 |
| Final R indexes | R₁ = | 0.0191, | R₁ = | 0.0204, |
| [all data] | wR₂ = | 0.0512 | wR₂ = | 0.0576 |

| | | |
|---|---|---|
| Largest diff. | 0.439/−4.95 | 0.518/−0.500 |
| peak/hole/e Å⁻³ | | |

TABLE 21
Crystallographic tables for (18C6@Ba)NiBr₄ and (18C6@Ba)SbCl₅

| Crystal | (18C6@Ba)NiBr₄ | | (18C6@Ba)SbCl₅ | |
|---|---|---|---|---|
| ICSD Number | 2363409 | | 2363486 | |
| Empirical formula | C12H22BaBr4NiO6 | | C1206BaSbC15 | |
| Formula weight | 777.939 | | 700.670 | |
| Temperature/K. | 100 | | 100 | |
| Crystal system | trigonal | | trigonal | |
| Space group | P3 | | R-3 | |
| a/Å | 14.1069(8) | | 13.721(4) | |
| b/Å | 14.1069(8) | | 13.721(4) | |
| c/Å | 9.6236(8) | | 10.276(5) | |
| α/º | 90 | | 90 | |
| β/° | 90 | | 90 | |
| γ/º | 120 | | 120 | |
| Volume/Å³ | 1658.56(19) | | 1675.4(11) | |
| Z | 3 | | 3 | |
| p_{calc}mg/mm³ | 2.337 | | 2.083 | |
| μ/mm⁻¹ | 9.869 | | 3.804 | |
| F(000) | 1096.882 | | 1006.512 | |
| Crystal size/mm³ | 0.35× 0.32 × 0.2 | | 0.02× 0.01 × 0.001 | |
| Radiation | Cu Kα (λ = | 1.54184 Å) | Cu Kα (λ = | 1.54184 Å) |
| 2Θ range for data | 3.2830° to 29.7570° | | 2.69° to 24.75° | |
| collection | | | | |
| Index ranges | −19 ≤ h ≤ 17, | | −16 ≤ h ≤ 16, | |
| | −17 ≤ k ≤ 18, | | −16 ≤ k ≤ 16, | |
| | −12 ≤ l ≤ 12 | | −13 ≤ l ≤ 12 | |
| Reflections | 13268 | | 5363 | |
| collected | | | | |
| Independent | 5197[R(int) = | 0.0527] | 754[R(int) = | 0.0971] |
| reflections | | | | |
| Data/restraints/ | 5197/1/218 | | 754/6/42 | |
| parameters | | | | |
| Goodness-of-fit | 0.7291 | | 1.0373 | |
| on F² | | | | |
| Final R indexes | R₁ = | 0.0362, | R₁ = | 0.0656, |
| [ I >= 2σ (I)] | wR₂ = | 0.0949 | wR₂ = | 0.1898 |
| Final R indexes | R₁ = | 0.0506, | R₁ = | 0.1320, |
| [all data] | wR₂ = | 0.1056 | wR₂ = | 0.2201 |

| | | |
|---|---|---|
| Largest diff. | 1.5931/−1.5709 | 1.3997/−1.8505 |
| peak/hole/e Å⁻³ | | |

The section headings used herein are for organizational purposes only and are not to be construed as limiting the subject matter described in any way.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

What is claimed is:

1. A halide perovskite compound according to the formula: (crown ether@A)₂M(IV)X₆, wherein
the M(IV) is at least one tetravalent metal cation,
the X is at least one halide anion, and
the crown ether@A is at least one alkali metal-bound crown ether formed between an alkali metal cation A and oxygen atoms of a crown ether.

2. The halide perovskite compound of claim 1, wherein
the M(IV) is one or more of; Te⁴⁺, Sn⁴⁺, Pt²⁺, Se³⁺, Ir⁴⁺, Zr⁴⁺, Hf⁴⁺, and Ce⁴⁺;
the X is one or more of Cl⁻, Br⁻, and I⁻;
the crown ether is one or more of 18-Crown-6 (18C6) and 21-Crown-7 (21C7); and
the A is one or more of Cs⁺, Rb⁺, and K⁺.

3. The halide perovskite compound of claim 1, wherein the halide perovskite compound is (18-Crown-6@K)₂HfBr₆ or (18C6@K)₂ZrCl₄Br₂.

4. The halide perovskite compound of claim 1, comprising at least one of (i) a dumbbell-shaped structural unit formed by two [crown ether@A]⁺s and one [M(IV)X₆]²⁻, and (ii) a rhombohedral crystal structure comprising a plurality of the dumbbell-shaped structural units, wherein the [crown ether@A]⁺ is a free charged form of the crown ether@A, and the [M(IV)X₆]²⁻ is a free charged form of the M(IV)X₆.

5. The halide perovskite compound of claim 1, comprising greater photoluminescence quantum yield (PLQY) as compared to a control compound A₂M(IV)X₆ without the crown ether and comprising the same A, M(IV), and X as the halide perovskite compound.

6. The halide perovskite compound of claim 5, wherein the PLQY of the halide perovskite compound is greater than 90% under excitation at 275 nm, measured at 445 nm, or greater than 80% under excitation at 295 nm, measured at 530 nm.

7. The halide perovskite compound of claim 1, comprising increased air stability as compared to a control compound A₂M(IV)X₆ without the crown ether and comprising the same A, M, and X as the halide perovskite compound.

8. The halide perovskite compound of claim 7, wherein the air stability of the halide perovskite compound is increased by about 1 hour to about 3 days as compared to the control compound.

9. A halide perovskite compound according to the formula: (crown ether@A)M(II)X₄ or (crown ether@A)M(III)X₅, wherein
the M(II) is at least one divalent metal cation,
the M(III) is at least one trivalent metal cation,
the X is at least one halide anion, and
the crown ether@A is at least one alkali metal-bound crown ether formed between an alkali metal cation A and oxygen atoms of a crown ether.

10. The halide perovskite compound of claim 9, wherein
the M(II) is one or more of Mn²⁺ and Ni²⁺;
the M(III) is Sb³⁺;
the X is one or more of Cl⁻ and Br⁻;
the crown ether is 18-Crown-6 (18C6); and
the A is Ba²⁺.

11. The halide perovskite compound of claim 9, wherein the halide perovskite compound is (18C6@Ba)MnBr₄ or (18C6@Ba)SbCl₅.

12. The halide perovskite compound of claim 9, comprising at least one of (i) a structural unit formed by one [crown ether@A]²⁺ and one [M(II)X₄]²⁻ or [M(III)X₅]²⁻, (ii) a linear chain structure comprising a plurality of the structural unit, and (iii) a hexagonal or rhombohedral crystal structure comprising the plurality of the structural unit, wherein the [crown ether@A]²⁺ is a free charged form of the crown ether@A, the [M(II)X₄]²⁻ is a free charged form of the M(II)X₄, and the [M(III)X₅]²⁻ is a free charged form of the M(III)X₅.

13. The halide perovskite compound of claim 9, comprising greater photoluminescence quantum yield (PLQY) as compared to a control compound AM(II)X₄ or AM(III)X₅ without the crown ether and comprising the same A, M(II) or M(III), and X as the halide perovskite compound.

14. The halide perovskite compound of claim 13, wherein the PLQY of the halide perovskite compound is greater than 80% under excitation at 449 nm, measured at 513 nm.

15. The halide perovskite compound of claim 9, comprising increased air stability as compared to a control compound AM(II)X₄ or AM(III)X₅ without the crown ether and comprising the same A, M(II) or M(III), and X as the halide perovskite compound.

16. A method of generating a halide perovskite compound, the method comprising:
dissolving (i) a metal halide and (ii) an alkali metal halide and a crown ether, or an alkali metal-bound crown ether, in an organic solvent to provide a precursor solution, wherein the metal halide makes contact with at least one of the alkali metal, the crown ether, and the alkali metal-bound crown ether in the precursor solution; and
contacting the organic solvent with an anti-solvent, wherein the halide perovskite compound crystalizes from the precursor solution.

17. The method of claim 16, comprising at least one of
wherein the organic solvent comprises N, N-Dimethylformamide (DMF) or acetonitrile (ACN), and
wherein the anti-solvent comprises diethyl ether (DEE).

18. The method of claim 16, wherein (i) the metal halide and (ii) the alkali metal and the crown ether, or the alkali metal-bound crown ether, are dissolved in the organic solvent at about 60-100° C.

19. The method of claim 16, wherein the generated halide perovskite compound is free of impurities.

20. A halide perovskite compound or a color luminescent composition comprising the halide perovskite compound generated by the method of claim 16.
